(19) United States
(12) Patent Application Publication
(10) Pub. No.: US 2005/0170282 A1
(43) Pub. Date: Aug. 4, 2005

(54) Lithographic printing plate precursor and lithographic printing method

(75) Inventors: Toshifumi Inno, Haibara-gun (JP); Yasuhito Oshima, Haibara-gun (JP); Ryuki Kakino, Haibara-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/038,139

(22) Filed: Jan. 21, 2005

(30) Foreign Application Priority Data
Jan. 23, 2004 (JP) P.2004-015723
Jan. 23, 2004 (JP) P.2004-015766
Mar. 24, 2004 (JP) P.2004-086566

(51) Int. Cl. G03C 1/76

(52) U.S. Cl. 430/270.1

(57) ABSTRACT

An on-press development or non-processing (non-development) type lithographic printing plate precursor capable of giving a printout image having a large lightness difference, and a lithographic printing method using this lithographic printing plate precursor are provided, a lithographic printing plate precursor comprising a support and a photosensitive-thermosensitive layer capable of recording an image by infrared laser exposure, the lithographic printing plate precursor being capable of performing a printing by loading on a printing press without passing through a development processing step after recording an image, or by recording an image after loading on a printing press, wherein said photosensitive-thermosensitive layer comprises (1) an infrared absorbent and (2) a discoloring agent or discoloration system capable of generating a color change upon exposure; and the lithographic printing method performing a printing using the above-described lithographic printing plate precursor.

### BACKGROUND OF THE INVENTION

1. Field of the Invention

The present invention relates to a lithographic printing plate precursor and a lithographic printing method using the same. More specifically, the present invention relates to a lithographic printing plate precursor capable of directly producing a printing plate by scanning an infrared laser based on digital signals of a computer or the like, which allows for printing without passing through a development processing step after exposure, and a lithographic printing method of performing printing by using this lithographic printing plate precursor.

2. Background Art

The lithographic printing plate in general consists of a lipophilic image area of receiving an ink in the printing process and a hydrophilic non-image area of receiving a fountain solution. The lithographic printing is a printing method utilizing the repellency between water and oily ink from each other, where the lipophilic image area of the lithographic printing plate and the hydrophilic non-image area are formed as an ink-receiving part and a fountain solution-receiving part (ink non-receiving part), respectively, to cause difference in the ink adhesion on the surface of the lithographic printing plate, an ink is attached only to the image area and thereafter, the ink is transferred to a material on which an image is printed, such as paper, thereby performing printing.

For producing this lithographic printing plate, a lithographic printing plate precursor (PS plate) comprising a hydrophilic support having provided thereon a lipophilic photosensitive resin layer (image-recording layer) has been heretofore widely used. Usually, a lithographic printing plate is obtained by a plate-making method where the lithographic printing plate precursor is exposed through an original image such as lith film and while leaving the image-recording layer in the image area, the image-recording layer in the non-image area is dissolved and removed with an alkaline developer or an organic solvent to expose the hydrophilic support to the surface.

In the plate-making process using a conventional lithographic printing plate precursor, a step of dissolving and removing the non-image area with a developer or the like according to the image-recording layer must be provided after exposure and as one problem to be solved, it is demanded to dispense with or simplify such an additive wet processing. In particular, the treatment of waste solutions discharged accompanying the wet processing is recently a great concern to the entire industry in view of consideration for global environment and the demand for solving the above-described problem is becoming stronger.

With respect to the non-processing (non-development) type capable of dispensing with a wet processing, a lithographic printing plate precursor having a photosensitive-thermosensitive layer of undergoing change in the affinity for fountain solution or ink on the surface upon exposure, which allows for printing without involving the removal of the photosensitive-thermosensitive layer, has been proposed.

Also, as one of simple plate-making methods, a method called on-press development has been proposed, where an image-recording layer enabling the removal of the non-image area of a lithographic printing plate precursor in a normal printing process is used and after exposure, the non-image area is removed on a printing press to obtain a lithographic printing plate.

The on-press development method specifically includes, for example, a method using a lithographic printing plate precursor having an image-recording layer dissolvable or dispersible in a fountain solution, an ink solvent or an emulsified product of fountain solution and ink, a method of mechanically removing the image-recording layer by the contact with rollers or a blanket cylinder of a printing press, and a method of weakening the cohesion of the image-recording layer or adhesion between the image-recording layer and the support by the impregnation of a fountain solution, an ink solvent or the like and then mechanically removing the image-recording layer by the contact with rollers or a blanket cylinder.

In the present invention, unless otherwise indicated, the “development processing step” indicates a step where by using an apparatus (usually an automatic developing machine) except for a printing press, the infrared laser unexposed portion of a lithographic printing plate precursor is removed through contact with a liquid (usually an alkaline developer) to expose the hydrophilic support to the surface, and the “on-press development” indicates a method or step where by using a printing press, the infrared laser unexposed portion of a lithographic printing plate precursor is removed through contact with a liquid (usually a printing ink and/or a fountain solution) to expose the hydrophilic support to the surface.

However, when an image-recording layer in a conventional image-recording system using ultraviolet ray or visible light is used, the image-recording layer is not fixed after exposure and therefore, a complicated method of storing the exposed lithographic printing plate precursor in a completely light-shielded state or under constant temperature conditions until loading it on a printing press must be employed.

On the other hand, a digitization technique of electronically processing, storing and outputting image information by using a computer has been recently widespread and various new image-outputting systems coping with such a digitization technique have been put into practical use. Along with tis, a computer-to-plate technique is attracting attention, where digitized image information is carried on a highly converging radiant ray such as laser ray and a lithographic printing plate precursor is scan-exposed by this ray with no intervention of a lith film to directly produce a lithographic printing plate. Accordingly, one of important technical problems to be solved is to obtain a lithographic printing plate precursor suitable for such a technique.

As described above, the demand for a simplified, dry-system and non-processing plate-making work is ever-stronger in recent years from both aspects of consideration for global environment and adaptation for digitization.

Recently, high-output lasers such as YAG laser and semiconductor laser of radiating an infrared ray at a wavelength of 760 to 1,200 nm are inexpensively available and a method using these high-output lasers as image-recording means is promising as a method for producing a lithographic printing plate by scanning exposure which is easy to incorporate into a digitization technique.

In conventional plate-making methods, the image recording is performed by imagewise exposing a photo-sensitive lithographic printing plate precursor with low to middle intensity illuminance to bring about a photochemical reaction in the image-recording layer and thereby cause imagewise change in the physical properties. On the other hand, in the above-described method using a high-output laser, a large quantity of light energy is irradiated on the exposure region within an extremely short time to efficiently convert the light energy into heat energy. By virtue of this heat, the image-recording layer undergoes chemical change, phase change or thermal change such as change of mode or structure, and this change is utilized in the image recording. Accordingly, the image information is inputted by light energy such as laser light, but the image recording is performed through a reaction by heat energy in addition to light energy. This recording system making use of heat generation by high-power density exposure is generally called heat-mode recording and the conversion of light energy into heat energy is called light-to-heat conversion. In the present invention, such an image-recording layer is called a photosensitive-thermosensitive layer.

The plate-making method using heat-mode recording is greatly advantageous in that the image-recording layer is not sensitive to light of normal illuminance level, such as room illumination, and fixing is not essential to the image recorded by high-intensity exposure. That is, the lithographic printing plate precursor for use in the heat-mode recording is safe to room light before exposure and fixing of the image after exposure is not essential. Accordingly, for example, when an image-recording layer which can be insolubilized or solubilized by exposure using a high-output laser is used and a plate-making process of imagewise removing the exposed image-recording layer to obtain a printing plate is performed by on-press development, this can realize a printing system of causing no effect on the image even if the image is subjected to ambient light in a room after exposure. It is expected that when the heat-mode recording is utilized, a lithographic printing plate precursor suitable for on-press development can be obtained.

For example, Patent Document 1 (Japanese Patent No. 2,938,397) describes a lithographic printing plate precursor where an image-forming layer comprising a hydrophilic binder having dispersed therein hydrophobic thermoplastic polymer particles is provided on a hydrophilic support. In Patent Document 1, it is stated that this lithographic printing plate precursor can be exposed by an infrared laser to cause coalescence of hydrophobic thermoplastic polymer particles due to heat and thereby form an image, then loaded on a cylinder of a printing press, and on-press developed by supplying a fountain solution and/or an ink.

However, in such a method of forming an image through coalescence by mere heat fusion of fine particles, the image strength is extremely low and the press life is not satisfied, despite good on-press developability.

For solving these problems, a technique of improving the press life by utilizing a polymerization reaction has been proposed. For example, Patent Document 2 (JP-A-2001-277740 (the term “JP-A” as used herein means an “unexamined published Japanese patent application”)) describes a lithographic printing plate precursor comprising a hydrophilic support having thereon an image-recording layer (thermosensitive layer) containing a polymerizable compound-enclosing microcapsule. Also, Patent Document 3. (JP-A-2002-287334) describes a lithographic printing plate precursor comprising a support having provided thereon an image-recording layer (photosensitive layer) containing an infrared absorbent, a radical polymerization initiator and a polymerizable compound.

In general, an operation of inspecting or identifying the image on a printing plate to check, for example, whether the intended image recording is achieved on the printing plate or what color ink is assigned to the plate is performed as a prestep before loading the printing plate on a printing press. In the case of a normal lithographic printing plate precursor requiring a development processing step, the image can be easily confirmed after plate-making (after development processing) and before printing (before loading the printing plate on a printing press) by coloring the image-recording layer.

However, in the case of an on-press development or non-processing (non-development) type lithographic printing plate precursor not requiring a development processing step, an image is not present on the printing plate at the stage of loading the printing plate on a printing press and the plate cannot be identified. Therefore, an operation error sometimes occurs. Particularly, it is important in the printing operation whether registry guides (register marks) as marks for registration in multicolor printing are clearly imprinted or not and whether this imprinting can be recognized or not. The present invention has been made to solve this problem.

### SUMMARY OF THE INVENTION

That is, an object of the present invention is to provide an on-press development or non-processing (non-development) type lithographic printing plate precursor capable of giving a printout image having a lightness difference large enough to facilitate the identification of the plate after exposure. Another object of the present invention is to provide a lithographic printing method using such an on-press development type lithographic printing plate precursor.

1. A lithographic printing plate precursor comprising a support and a photosensitive-thermosensitive layer capable of recording an image by infrared laser exposure, the lithographic printing plate precursor being capable of performing a printing by loading on a printing press without passing through a development processing step after recording an image, or by recording an image after loading on a printing press, wherein said photosensitive-thermosensitive layer comprises (1) an infrared absorbent and (2) a discoloring agent or discoloration system capable of generating a color change upon exposure.

2. The lithographic printing plate precursor as described in the item 1, wherein (2) said discoloration system capable of generating a color change upon exposure comprises (3) a radical initiator and (4) a compound capable of generating a color change under the action of a radical.

3. The lithographic printing plate precursor as described in the item 1 or 2, wherein the lightness difference ΔL between exposed area and unexposed area after image-recording is 4.0 or more.

4. The lithographic printing plate precursor as described in any one of the items 1 to 3, wherein said photosensitive-thermosensitive layer further comprises (5) a radical polymerizable compound and (6) a radical polymerization initiator.

5. The lithographic printing plate precursor as described in any one of the items 1 to 4, wherein at least one component of the components contained in said photosensitive-thermosensitive layer is encapsulated in a microcapsule.

6. The lithographic printing plate precursor as described in the item 4, wherein (2) said discoloring agent or discoloration system capable of generating a color change upon exposure is encapsulated in a microcapsule and isolated from (5) said radical polymerizable compound.

7. A lithographic printing plate precursor comprising a support and a photosensitive-thermosensitive layer capable of recording an image by infrared laser exposure, the lithographic printing plate precursor being capable of performing a printing by loading on a printing press without passing through a development processing step after recording an image, or by recording an image after loading on a printing press, wherein a layer different from the photosensitive-thermosensitive layer comprises (1) an infrared absorbent, (3) a radical initiator and (4) a compound capable of generating a color change under the action of a radical.

8. The lithographic printing plate precursor as described in the item 2, wherein said radical initiator is a compound represented by the following formula (I): 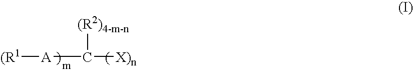
wherein X represents a halogen atom, A represents a divalent linking group selected from the group consisting of —CO—, —SO—, —SO₂—, —PO— and —PO₂—, R¹ and R² each independently represents a hydrogen atom or a monovalent hydrocarbon group having from 1 to 20 carbon atoms, and m and n each represents an integer of 1 to 3, provided that m+n is from 2 to 4.

9. The lithographic printing plate precursor as described in the item 7, wherein said radical initiator is a compound represented by the following formula (I): 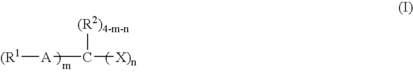
wherein X represents a halogen atom, A represents a divalent linking group selected from the group consisting of —CO—, —SO—, —SO₂—, —PO— and —PO₂—, R¹ and R² each independently represents a hydrogen atom or a monovalent hydrocarbon group having from 1 to 20 carbon atoms, and m and n each represents an integer of 1 to 3, provided that m+n is from 2 to 4.

10. The lithographic printing plate precursor as described in the item 1, wherein the surface of said support comprises a hydrophilic film having a thermal conductivity of 0.05 to 0.5 W/mK in the film thickness direction.

11. The lithographic printing plate precursor as described in the item 7, wherein the surface of said support comprises a hydrophilic film having a thermal conductivity of 0.05 to 0.5 W/mK in the film thickness direction.

12. The lithographic printing plate precursor as described in the item 1, wherein the surface of said support is hydrophilic and said photosensitive-thermosensitive layer is removable by a printing ink and/or a fountain solution.

13. The lithographic printing plate precursor as described in the item 7, wherein the surface of said support is hydrophilic and said photosensitive-thermosensitive layer is removable by a printing ink and/or a fountain solution.

14. A lithographic printing method comprising:
loading the lithographic printing plate precursor described in the item 1 on a printing press and then imagewise exposing the lithographic printing plate precursor with an infrared laser, or
imagewise exposing the lithographic printing plate precursor described in the item 1 with an infrared laser and then loading the lithographic printing plate precursor on a printing press;
supplying a printing ink and a fountain solution to said lithographic printing plate precursor; and
removing the infrared laser unexposed portion of the photosensitive-thermosensitive layer to perform a printing.

15. A lithographic printing method comprising:
loading the lithographic printing plate precursor described in the item 7 on a printing press and then imagewise exposing the lithographic printing plate precursor with an infrared laser, or
imagewise exposing the lithographic printing plate precursor described in the item 7 with an infrared laser and then loading the lithographic printing plate precursor on a printing press;
supplying a printing ink and a fountain solution to said lithographic printing plate precursor; and
removing the infrared laser unexposed portion of the photosensitive-thermosensitive layer to perform a printing.

According to the present invention, an on-press development or non-processing (non-development) type lithographic printing plate precursor not requiring a development processing step and being capable of giving a printout image having a lightness difference large enough to facilitate the identification of the plate after exposure can be provided. Furthermore, according to the present invention, a lithographic printing method using such an on-press development type lithographic printing plate precursor can be provided.

### DETAILED DESCRIPTION OF THE INVENTION

The present invention is characterized in that a photosensitive-thermosensitive layer capable of recording an image by infrared laser exposure is provided on a support and a printout image having a large lightness difference is imparted to a lithographic printing plate precursor (on-press development or non-processing (non-development) type lithographic printing plate precursor) which allows for printing by loading it on a printing press without passing through a development processing step after recording an image or by recording an image after loading it on a printing press.

The lightness difference ΔL as used in the present invention indicates an absolute value of the difference in L* value between exposed area and unexposed area, which is measured by using a general color-difference meter (for example, Color and Color-Difference Meter CR-221, manufactured by Minolta Co., Ltd.) capable of measuring the color space coordinates (L*,a*,b*).

In order to identify the exposed plate material and smoothly perform the printing preparation work, ΔL is preferably 4.0 or more, more preferably 6.0 or more, still more preferably 8.0 or more.

Furthermore, the lightness difference ΔL in the above-described range is preferably obtained with an infrared laser exposure energy of 100 mJ/cm² or more, more preferably 70 mJ/cm² or more.

The lithographic printing plate precursor of the present invention, which allows for printing by loading it on a printing press without passing through a development processing step after recording an image or by recording an image after loading it on a printing press, include the following (1) on-press development type lithographic printing plate precursor and (2) non-processing (non-development) type lithographic printing plate precursor.

(1) On-Press Development Type Lithographic Printing Plate Precursor:

A lithographic printing plate precursor which has a photosensitive-thermosensitive layer of undergoing change of solubility or dispersibility in fountain solution and/or ink upon exposure or change of adhesion to an adjacent layer differing in the affinity for fountain solution or ink upon exposure and which can be developed by supplying fountain solution and/or ink to the plate surface on a printing press after image exposure.

(2) Non-Processing (Non-Development) Type Lithographic Printing Plate Precursor

A lithographic printing plate precursor which has a photosensitive-thermosensitive layer of undergoing change of affinity for fountain solution or ink on the surface upon exposure and which allows for printing without requiring removal of the photosensitive-thermosensitive layer after image exposure.

The lithographic printing plate precursor of the present invention, which allows for printing by loading it on a printing press without passing through a development processing step after recording an image or by recording an image after loading it on a printing press, is not particularly limited as long as it is the above-described lithographic printing plate precursor of (1) or (2). However, as described later, in the on-press development type lithographic printing plate precursor, the photosensitive-thermosensitive layer does not necessarily have a crosslinked structure and therefore, the discoloring agent or discoloration system capable of generating a color change upon exposure has higher mobility in the photosensitive-thermosensitive layer to readily enhance the color change reactivity. Accordingly, an on-press development type lithographic printing plate is more preferred than the non-processing (non-development) type in which the photosensitive-thermosensitive layer has a crosslinked structure.

Specific examples of these lithographic printing plate precursors include the plate materials described in Japanese Patent No. 2,938,397, JP-A-2001-277740, JP-A-2001-277742, JP-A-2002-287334, JP-A-2001-96936, JP-A-2001-96938, JP-A-2001-180141, JP-A-2001-162960, International Publication Nos. WO00/16987 and WO01/39985 (each pamphlet), EP-A-990517, EP-A-1225041, U.S. Pat. No. 6,465,152, JP-A-6-317899, International Publication No. WO96/35143 (pamphlet), EP-A-652483, JP-A-10-10737, JP-A-11-309952, and U.S. Pat. Nos. 6,017,677 and 6,413,694.

The constituent elements of the lithographic printing plate precursor and the lithographic printing method of the present invention are described in detail below.

[Photosensitive-Thermosensitive Layer]

(Discoloring Agent or Discoloration System of Causing Color Change upon Exposure)

The discoloring agent or discoloration system capable of generating a color change upon exposure for use in the present invention includes (a) those which themselves are colorless or pale-colored but undergo discoloration when received some energy by heating, pressurization, light irradiation or the like, and (b) those which themselves are not discolored even when an energy is added, but undergo discoloration when brought into contact with other components.

Examples of (a) above include thermochromic compounds, piezochromic compounds, photochromic compounds and leuco forms of triarylmethane dyes, quinoline dyes, indigoid dyes, azine dyes and the like. These all undergo discoloration when heated, pressurized, irradiated with light, or air-oxidized.

Examples of (b) above include various systems (discoloration systems) which undergo discoloration resulting from an acid-base reaction, an oxidation-reduction reaction, a coupling reaction, a chelate-forming reaction or the like occurred among two or more components. For example, a coloring system using, as the discoloration component, a color former having a partial structure of lactone, lactam, spiropyran or the like and comprising an acidic substance (developer) such as acid clay or phenols, which is used for pressure-sensitive paper or the like; a system utilizing an azo-coupling reaction of an aromatic diazonium salt, diazotate or diazosulfonate with a naphthol, an aniline, an active methylene or the like; a chelate-forming reaction such as reaction of hexamethylenetetramine with ferric ion and gallic acid or reaction of phenolphthalein-Complexon acid with alkaline earth metal ion; and an oxidation-reduction reaction such as reaction of ferric stearate with pyrogallol or reaction of silver behenate with 4-methoxy-1-naphthol, can be used.

Examples of the color former in the color former/developer system include (i) triarylmethane-based compounds, (ii) diphenylmethane-based compounds, (iii) xanthene-based compounds, (iv) thiazine-based compounds and (v) spiropyran-based compounds, and specific examples thereof include those described in JP-A-58-27253. In particular, (i) triarylmethane-based color formers and (iii) xanthene-based color formers are preferred, because fogging less occurs and high color density is obtained.

Specific examples thereof include Crystal Violet Lactone, Malachite Green Lactone, Benzoyl Leuco Methylene Blue, 3-(N,N-diethylamino)-6-chloro-7-(β-ethoxyethylamino)fluoran, 3-(N,N,N-triethylamino)-6-methyl-7-anilinofluoran, 3-(N,N-diethylamino)-7-chloro-7-o-chlorofluoran, 2-(N-phenyl-N-methylamino)-6-(N-p-tolyl-N-ethyl)aminofluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyrrolidino-6-methyl-7-anilinofluoran 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide. These compounds are used individually or as a mixture.

As for the developer, phenol-based compounds, organic acids or metal salts thereof, oxybenzoic acid esters, acid clay and the like are used.

Specific examples of the phenol-based compound include 4,4′-isopropylidene-diphenol (bisphenol A), p-tert-butylphenol, 2,4-dinitrophenol, 3,4-dichlorophenol, 4,4′-methylene-bis(2,6′-di-tert-butylphenol), p-phenylphenol, 1,1-bis(4-hydroxyphenyl)cyclohexane, 1,1-bis(4-hydroxyphenyl)-2-ethylhexane, 2,2-bis(4-hydroxyphenyl)butane, 2,2′-methylenebis(4-tert-butylphenol), 2,2′-methylenebis(α-phenyl-p-cresol)thiodiphenol, 4,4′-thiobis(6-tert-butyl-m-cresol)sulfonyldiphenol, p-tert-butylphenol-formalin condensate and p-phenylphenol-formalin condensate.

Examples of the organic acid or a metal salt thereof include phthalic acid, phthalic anhydride, maleic acid, benzoic acid, gallic acid, o-toluic acid, p-toluic acid, salicylic acid, 3-tert-butylsalicylic acid, 3,5-di-3-tert-butylsalicylic acid, 5-α-methylbenzylsalicylic acid, 3,5-bis(α-methylbenzyl)salicylic acid, 3-tert-octylsalicylic acid and their zinc, lead, aluminum, magnesium and nickel salts. Among these, salicylic acid derivatives and zinc or aluminum salts thereof are excellent in the developability.

Examples of the oxybenzoic acid ester include ethyl p-oxybenzoate, butyl p-oxybenzoate, heptyl p-oxybenzoate and benzyl p-oxybenzoate.

Other examples of the color former in the color former/developer include phenolphthalein, fluorescein, 2,4,5,7-tetrabromo-3,4,5,6-tetrachlorofluorescein, tetrabromophenol blue, 4,5,6,7-tetrabromophenolphthalein, eosine, aurincresol red and 2-naphtholphenolphthalein.

Examples of the developer include nitrogen-containing compounds such as inorganic or organic ammonium salts, organic amines, amides, ureas, thioureas, derivatives of urea and thiourea, thiazoles, pyrroles, pyrimidines, piperazines, guanidines, indoles, imidazoles, imidazolines, triazoles, morpholines, piperidines, amidines, formamidines and pyridines.

Specific examples thereof include ammonium acetate, tricyclohexylamine, tribenzylamine, octadecylbenzylamine, stearylamine, allylurea, thiourea, methylthiourea, allylthiourea, ethylenethiourea, 2-benzylimidazole, 4-phenylimidazole, 2-phenyl-4-methylimidazole, 2-undecyl-imidazoline, 2,4,5-trifuryl-2-imidazoline, 1,2-diphenyl-4,4-dimethyl-2-imidazoline, 2-phenyl-2-imidazoline, 1,2,3-triphenylguanidine, 1,2-ditolylguanidine, 1,2-dicyclohexylguanidine, 1,2-dicyclohexyl-3-phenylguanidine, 1,2,3-tricyclohexylguanidine, guanidine trichloroacetate, N,N′-dibenzylpiperazine, 4,4′-dithiomorpholine, morpholinium trichloroacetate, 2-amino-benzothiazole and 2-benzoylhydrazino-benzothiazole.

Other than those described above, the component of causing discoloration of the discoloring agent of (2) above includes an acid, a base or a radical generated upon application of an energy by light irradiation, heating, pressurization or the like. For this purpose, the photosensitive-thermosensitive layer preferably contains an acid generator, a base generator or a radical generator of generating an acid, a base or a radical as a result of heat generation from an infrared absorbent after absorbing laser light upon infrared laser exposure, or electron or energy transfer from the infrared absorbent.

The discoloration system for use in the present invention is more preferably a discoloration system comprising a radical generator (also called a radical initiator) and a compound of undergoing discoloration due to a radical.

As for the discoloring agent of undergoing discoloration by interacting with at least one of an acid, a base and a radical, various dyes such as diphenylmethane-based dye, triphenylmethane-based dye, thiazine-based dye, oxazine-based dye, xanthene-based dye, anthraquinone-based dye, iminonaphthoquinone-based dye and azomethine-based dye can be effectively used.

Specific examples thereof include Brilliant Green, eosin, Ethyl Violet, Erythrosine B, Methyl Green, Crystal Violet, Basic Fuchsine, phenolphthalein, 1,3-diphenyltriazine, Alizarin Red S, Thymolphthalein, Methyl Violet 2B, Quinaldine Red, Rose Bengale, Methanyl Yellow, Thymolsulfophthalein, Xylenol Blue, Methyl Orange, Orange IV, diphenyl thiocarbazone, 2,7-dichlorofluorescein, Paramethyl Red, Congo Red, Benzopurpurine 4B, α-Naphthyl Red, Nile Blue 2B, Nile Blue A, phenacetarin, Methyl Violet, Malachite Green, Parafuchsine, Victoria Pure Blue BOH [produced by Hodogaya Chemical Industries, Ltd.], Oil Blue #603 [produced by Orient Chemical Industries, Ltd.], Oil Pink #312 [produced by Orient Chemical Industries, Ltd.], Oil Red 5B [produced by Orient Chemical Industries, Ltd.], Oil Scarlet #308 [produced by Orient Chemical Industries, Ltd.], Oil Red OG [produced by Orient Chemical Industries, Ltd.], Oil Red RR (Orient Chemical Industries, Ltd.], Oil Green #502 [produced by Orient Chemical Industries, Ltd.], Spiron Red BEH Special [produced by Hodogaya Chemical Industries, Ltd.], m-cresol Purple, Cresol Red, Rhodamine B, Rhodamine 6G, Fast Acid Violet R, Sulforhodamine B, auramine, 4-p-diethylaminophenyliminonaphthoquinone, 2-carboxyanilino-4-p-diethylaminophenyliminonaphthoquinone, 2-carbostearylamino-4-p-dihydroxyethylaminophenyliminonaphthoquinone, p-methoxybenzoyl-p′-diethylamino-o′-methylphenyliminoacetanilide, cyano-p-diethylaminophenyliminoacetanilide, 1-phenyl-3-methyl-4-p-diethylaminophenylimino-5-pyrazolone and 1-β-naphthyl-4-p-diethylaminophenylimino-5-pyrazolone.

Other than those described above, the compounds exemplified above as the color former in the color former/developer system can also be effectively used.

As for the compound of undergoing color formation under the action of a radical, arylamines which are an organic dye can be used. The arylamines suitable for this purpose include not only simple arylamines such as primary or secondary aromatic amines but also leuco dyes. These compounds come into contact with a free radical generated from a radical generator activated in the exposed area and produce a colored image in contrast with the non-contacted background. Examples of these compounds include the followings.

Examples of the simple amines include diphenylamine, dibenzylaniline, triphenylamine, diethylaniline, diphenyl-p-phenylenediamine, p-toluidine, 4,4′-biphenyldiamine, o-chloroaniline, o-bromoaniline, 4-chloro-o-phenylenediamine, o-bromo-N,N-dimethylaniline, 1,2,3-triphenylguanidine, naphthylamine, diaminodiphenylmethane, aniline, 2,5-dichloroaniline, N-methyldiphenylamine and o-toluidine.

Examples of the leuco dye include leuco dyes described in U.S. Pat. No. 3,445,234, that is, aminotriarylmethanes, aminoxanthenes, aminothioxanthenes, amino-9,10-dihydroacridines, aminophenoxazines, aminophenothiazines, aminodihydrophenazines, aminodiphenylmethanes, leuco indamines, aminohydrocinnamic acids (cyanoethanes, leuco methines), hydrazines, leuco indigoid dyes, amino-2,3-dihydroanthraquinones, tetrahalo-p,p′-biphenols, 2-(p-hydroxyphenyl)-4,5-diphenylimidazoles and phenethylanilines.

Specific preferred examples of the leuco dye include aminotriarylmethanes such as bis(4-dimethylaminophenyl)phenylmethane (also called leuco Malachite Green), bis(4-diethylamino-o-tolyl)(o-chlorophenyl)methane, tris(4-diethylamino-o-tolyl)methane, tris(p-dimethylaminophenyl)methane (also called leuco Crystal Violet), tris(p-dihexylaminophenyl)methane, bis(4-diethylamino-o-tolyl)(3,4-dimethoxyphenyl)methane, bis(4-diethylamino-o-tolyl)(p-benzylthiophenyl)methane and bis(p-dimethylamino-o-tolyl)(p-α-methoxyacetamide)methane; aminoxanthenes such as 3,6-bis(diethylamino)-9-phenylxanthene and 3-amino-6-dimethylamino-2-methyl-9-(o-chlorophenyl)xanthene; aminothioxanthenes such as 3,6-bis(diethylamino)-9-(o-ethoxycarbonylphenyl)thioxanthene and 3,6-bis(dimethylamino)thioxanthene; amino-9,10-dihydroacridines such as 3,6-bis(diethylamino)-9,10-dihydro-9-phenylacridine, 3,6-bis-(benzylamino)-9,10-dihydro-9-methylacridine; aminophenoxazine such as 3,7-bis(diethylamino)phenoxazine; aminophenothiazines such as 3,7-bis(ethylamino)phenothiazine; aminodihydrophenazines such as 3,7-bis(diethylamino)-5-hexyl-5,10-dihydrophenazine; aminophenylmethanes such as bis(p-dimethylaminophenyl)anilinomethane; leuco indamines such as 4-amino-4′-dimethylaminodiphenylamine; aminohydrocinnamic acids such as methyl 4-amino-α,β-dicyanohydrocinnamate; hydrazines such as 1-(2-naphthyl)-2-phenylhydrazine; amino-2,3-dihydroanthraquinones such as 1,4-bis(ethylamino)-2,3-dihydroanthraquinone; and phenethylanilines such as N,N-diethyl-p-phenethylaniline.

Among these leuco dyes, preferred are aminotriarylmethanes, more preferred are those where at least two aryl groups have an amino group at the para-position with respect to the bond to the methane carbon atom, still more preferred are those where three aryl groups all have an amino group at the para-position. Also, aminotriarylmethanes having an alkyl group, an alkoxy group or a halogeno group at the ortho-position of the aryl group are preferred because of excellent storage stability.

Examples of the photoacid generator which can be used in the discoloration system of (2) include organohalogen compounds described in JP-A-59-180543, JP-A-59-148784, JP-A-60-138539, JP-B-60-27673 (the term “JP-B” as used herein means an “examined Japanese patent publication”), JP-B-49-21601, JP-A-63-58440, JP-B-57-1819, JP-A-53-133428 and JP-A-55-32070; and diazonium salts, iodonium salts and sulfonium salts described in JP-B-54-14277, JP-B-54-14278, JP-A-51-56885, and U.S. Pat. Nos. 3,708,296 and 3,835,002.

Among these photoacid generators, preferred are trihaloallyl compounds and halomethyltriazine compounds described in JP-A-59-180543, JP-A-59-148784, JP-A-60-138539, JP-B-60-27673, JP-A-63-58440, JP-B-57-1819, JP-A-53-133428 and JP-A-55-32070.

Specific preferred examples of the photoacid generator are set forth below, but the present invention is not limited thereto.

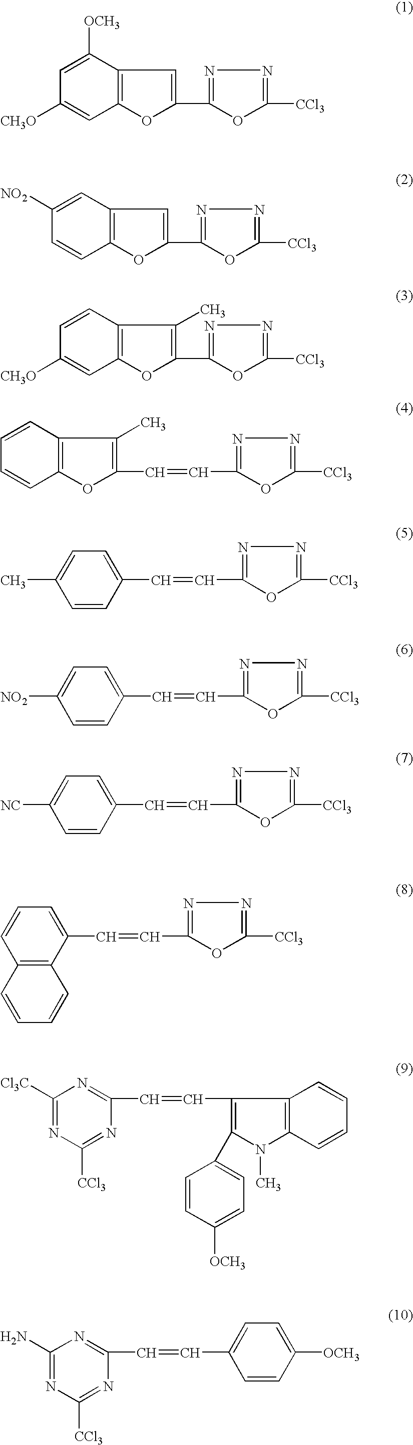

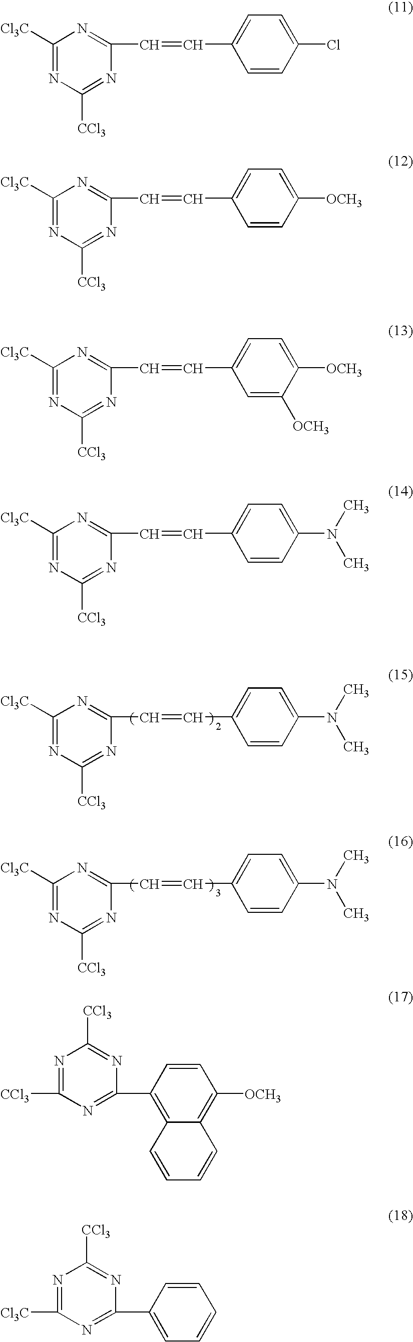

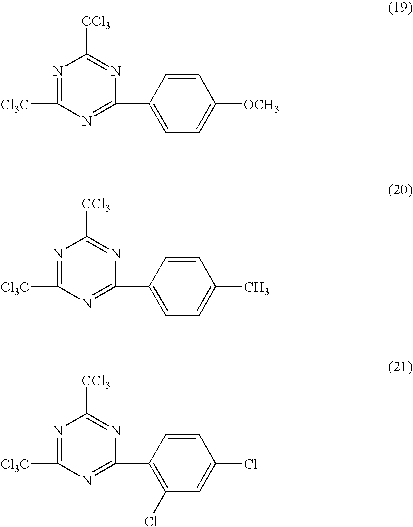

Examples of the compound of generating a base under light or heat, which can be used in the discoloration system of (2), include salts of a carboxylic acid with an organic base. As for the base precursor comprising a salt of a carboxylic acid with an organic base, those described in U.S. Pat. No. 3,493,374, British Patent 998,949, JP-A-59-180537, JP-A-61-51139 and U.S. Pat. No. 4,060,420 can be used. These base precursors are constituted to release the organic base on use (on heating).

Examples of the compound of generating a base under light or heat (radical initiator), which can be used in the discoloration system of (2), include known thermopolymerization initiators, compounds having a bond small in the bond-dissociation energy, photopolymerization initiators. Among these, the radical initiator suitably used in the present invention is a compound of generating a radical due to heat energy.

The radical initiator for use in the present invention is described in more detail below and these radical initiators can be used individually or in combination of two or more thereof.

These radical initiators can be used individually or in combination of two or more thereof. Specific examples of these radical initiators and preferred examples of the combination include those described in Kiyomi Kato (compiler), UV/EB-Koka Handbook—Genryo Hen—(UV/EB Curing Handbook—Raw Materials—), pp. 67-73, Kobunshi Kanko Kai, Beiho Tabata (supervisor), UV/EB Koka Gijutsu no Oyo to Shijo (Application and Market of UV/EB Curing Technology), pp. 64-82, compiled by Radotech Kenkyu Kai, CMC, JP-B-6-42074, JP-A-62-61044, JP-A-60-35725 and JP-A-2-287547.

For example, organohalogen compounds, carbonyl compounds, organic peroxides, azo-based compounds, azide compounds, metallocene compounds, hexaarylbiimidazole compounds, organic boron compounds, disulfone compounds, oxime ester compounds and onium salt compounds can be used.

Specific examples of the organohalogen compound include the compounds described in Wakabayashi et al., Bull. Chem. Soc. Japan, 42, 2924 (1969), U.S. Pat. No. 3,905,815, JP-B-46-4605, JP-A-48-36281, JP-A-53-133428, JP-A-55-32070, JP-A-60-239736, JP-A-61-169835, JP-A-61-169837, JP-A-62-58241, JP-A-62-212401, JP-A-63-70243, JP-A-63-298339, M. P. Hutt, Journal of Heterocyclic Chemistry, 1, No. 3 (1970). In particular, oxazole compounds substituted with a trihalomethyl group and s-triazine compounds are preferred.

Furthermore, s-triazine derivatives having at least one mono-, di- or tri-halogenated methyl group bonded to the s-triazine ring are more preferred and specific examples thereof include 2,4,6-tris(monochloromethyl)-s-triazine, 2,4,6-tris(dichloromethyl)-s-triazine, 2,4,6-tris(trichloromethyl)-s-triazine, 2-methyl-4,6-bis(tri-chloromethyl)-s-triazine, 2-n-propyl-4,6-bis(trichloromethyl)-s-triazine, 2-(α,α,β-trichloroethyl)-4,6-bis(tri-chloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-i-propyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine and 2-methoxy-4,6-bis(tribromomethyl)-s-triazine.

Examples of the carbonyl compound include benzophenone derivatives such as benzophenone, Michler's ketone, 2-methylbenzophenone, 3-methylbenzophenone, 4-methylbenzophenone, 2-chlorobenzophenone, 4-bromobenzophenone and 2-carboxybenzophenone; acetophenone derivatives such as 2,2-dimethoxy-2-phenylacetophenone, 2,2-diethoxyacetophenone, 1-hydroxycyclohenxylphenylketone, α-hydroxy-2-methylphenylpropanone, 1-hydroxy-1-methylethyl-(p-isopropylphenyl)ketone, 1-hydroxy-1-(p-dodecylphenyl)ketone, 2-methyl-(4′-(methylthio)phenyl)-2-morpholino-1-propanone and 1,1,1-trichloromethyl-(p-butylphenyl)ketone; thioxantone derivatives such as thioxantone, 2-ethylthioxanthone, 2-isopropylthioxanthone, 2-chlorothioxanthone, 2,4-dimethylthioxanthone, 2,4-diethylthioxanthone and 2,4-diisopropylthioxanthone; benzoic acid ester derivatives such as ethyl p-dimethylaminobenzoate and ethyl p-diethylaminobenzoate.

As for the azo-based compound, azo compounds described, for example, in JP-A-8-108621 can be used.

Examples of the organic peroxide include trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic peroxide, benzoyl peroxide, 2,4-dichlorobenzoyl peroxide, diisopropylperoxydicarbonate, di-2-ethylhexylperoxydicarbonate, di-2-ethoxyethylperoxydicarbonate, dimethoxyisopropylperoxycarbonate, di(3-methyl-3-methoxybutyl)peroxydicarbonate, tert-butylperoxyacetate, tert-butylperoxypivalate, tert-butylperoxyneodecanoate, tert-butylperoxyoctanoate, tert-butylperoxylaurate, tert-carbonate, 3,3′,4,4′-tetra(tert-butylperoxycarbonyl)benzophenone, 3,3′,4,4′-tetra(tert-hexylperoxycarbonyl)benzophenone, 3,3′,4′-tetra(p-isopropyl-cumylperoxycarbonyl)benzophenone, carbonyl di(tert-butylperoxydihydrogendiphthalate) and carbonyl di(tert-hexylperoxydihydrogendiphthalate).

Examples of the metallocene compound include various titanocene compounds described in JP-A-59-152396, JP-A-61-151197, JP-A-63-41484, JP-A-2-249, JP-A-24705 and JP-A-5-83588, such as dicyclopentadienyl-Ti-bis-phenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl and dimethylcyclopentadienyl-Ti-bis-2,3,4,5,6-pentafluorophen-1-yl, and iron-allene complexes described in JP-A-1-304453 and JP-A-1-152109.

Examples of the hexaarylbiimidazole compound include various compounds described in JP-B-6-29285 and U.S. Pat. Nos. 3,479,185, 4,311,783 and 4,622,286, such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)4,4′,5,5′-tetraphenylbiimidazole and 2,2′-bis(o-trifluorophenyl)4,4′,5,5′-tetraphenylbiimidazole.

Examples of the organic boron compound include organic borates described in JP-A-62-143044, JP-A-62-150242, JP-A-9-188685, JP-A-9-188686, JP-A-9-188710, JP-A-2000-131837, JP-A-2002-107916, Japanese Patent No. 2764769, JP-A-2002-116539, and Martin Kunz, Rad Tech. 98. Proceeding Apr. 19-22, 1998, Chicago; organic boron sulfonium complexes and organic boron oxosulfonium complexes described in JP-A-6-157623, JP-A-6-175564 and JP-A-6-175561; organic boron iodonium complexes described in JP-A-6-175554 and JP-A-6-175553; organic boron phosphonium complexes described in JP-A-9-188710; and organic boron transition metal coordination complexes described in JP-A-6-348011, JP-A-7-128785, JP-A-7-140589, JP-A-7-306527 and JP-A-7-292014.

Examples of the disulfone compound include compounds described in JP-A-61-166544 and JP-A-2002-328465.

Examples of the oxime ester compound include compounds described in J. C. S. Perkin II, 1653-1660 (1979), J. C. S. Perkin II, 156-162 (1979), Journal of Photopolymer Science and Technology, 202-232 (1995), JP-A-2000-66385 and JP-A-2000-80068. Specific examples thereof include the compounds represented by the following structural formulae.

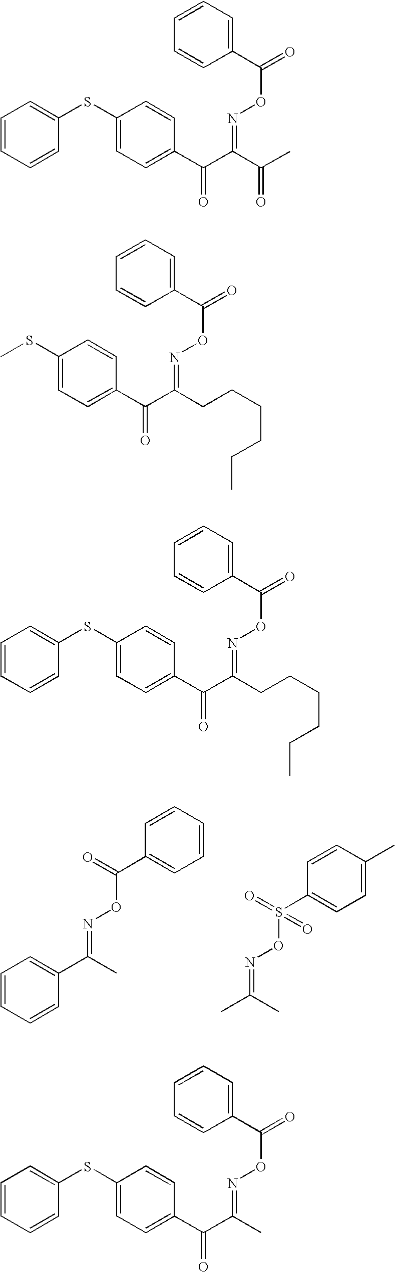

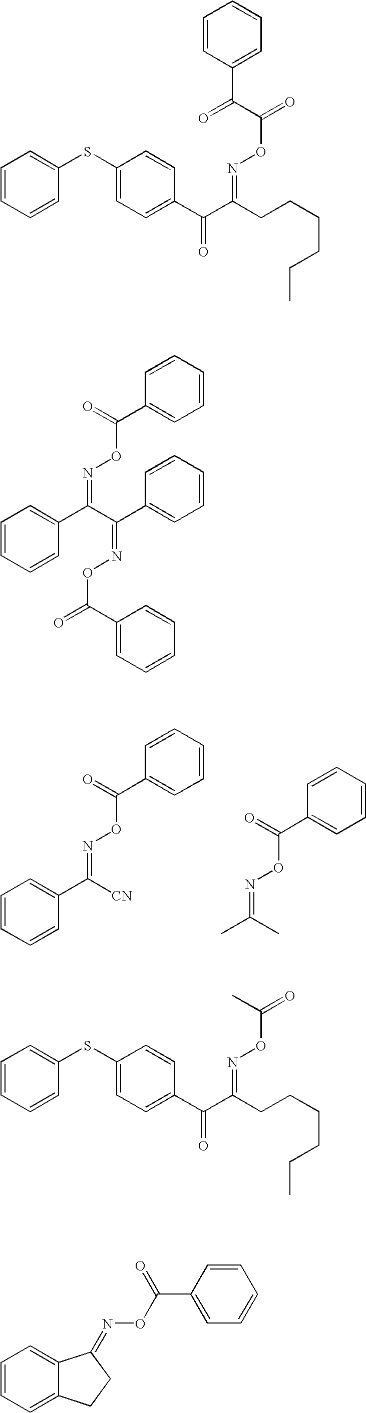

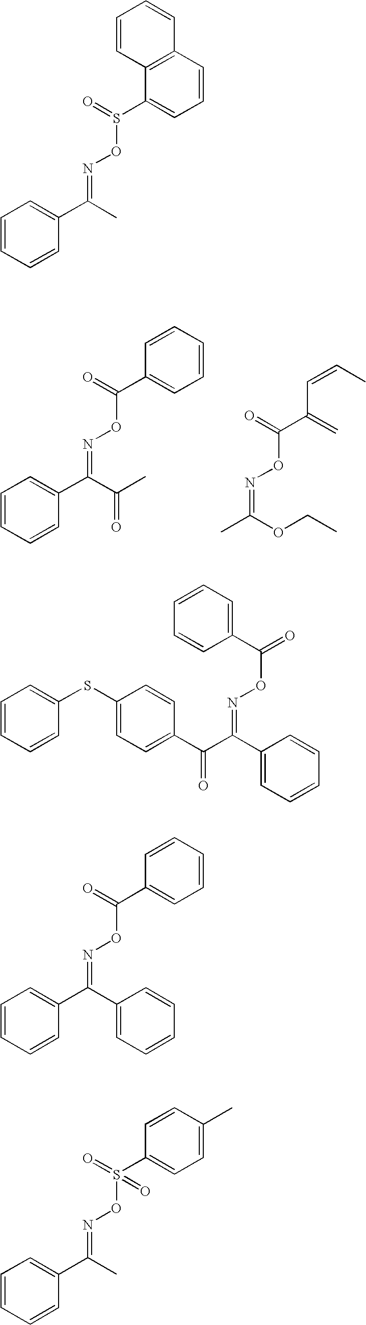

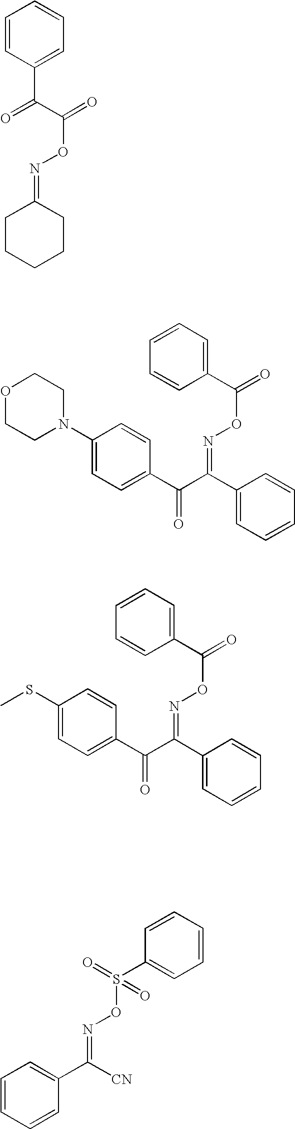

Examples of the onium salt compound include onium salts such as diazonium salts described in S. I. Schlesinger, Photogr. Sci. Enz., 18, 387 (1974) and T. S. Bal et al., Polymer, 21, 423 (1980); ammonium salts described in U.S. Pat. No. 4,069,055 and JP-A-4-365049; phosphonium salts described in U.S. Pat. Nos. 4,069,055 and 4,069,056; iodonium salts described in European Patent 104,143, U.S. Pat. Nos. 339,049 and 410,201, JP-A-2-150848, and JP-A-2-296514; sulfonium salts described in European Patents 370,693, 3,902,114, 233,567, 297,443 and 297,442, U.S. Pat. Nos. 4,933,377, 161,811, 410,201, 339,049, 4,760,013, 4,734,444 and 2,833,827, and German Patents 2,904,626, 3,604,580 and 3,604,581; selenonium salts described in J. V. Crivello et al., Macromolecules, 10 (6), 1307 (1977) and J. V. Crivello et al., J. Polymer Sci., Polymer Chem. Ed., 17, 1047 (1979); and arsonium salts described in C. S. Wen et al., Teh. Proc. Conf. Rad. Curing ASIA, p. 478, Tokyo, October (1988).

In view of reactivity and stability, the radical initiator is preferably an oxime ester compound or an onium salt (e.g., diazonium salt, iodonium salt, sulfonium salt).

The onium salt suitably used in the present invention is an onium salt represented by any one of the following formulae (RI-I) to (RI-III):

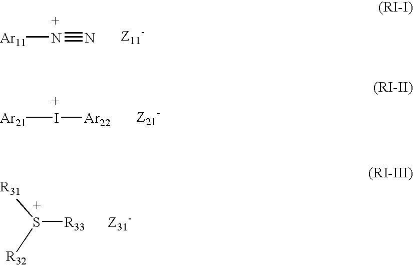

In formula (RI-I), Ar₁₁ represents an aryl group having 20 or less carbon atoms, which may have from 1 to 6 substituent(s), and preferred examples of the substituent include an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamide or alkylamide group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms. Z₁₁⁻ represents a monovalent anion and specific examples thereof include halogen ion, perchlorate ion, hexafluorophosphate ion, tetrafluoroborate ion, sulfonate ion, sulfinate ion, thiosulfonate ion and sulfate ion. Among these, preferred in view of stability are perchlorate ion, hexafluorophosphate ion, tetrafluoroborate ion, sulfonate ion and sulfinate ion.

In formula (RI-II), Ar₂₁ and Ar₂₂ each independently represents an aryl group having 20 or less carbon atoms, which may have from 1 to 6 substituent(s), and preferred examples of the substituent include an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamide or arylamide group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms. Z₂₁⁻ represents a monovalent anion and examples thereof include halogen ion, perchlorate ion, hexafluorophosphate ion, tetrafluoroborate ion, sulfonate ion, sulfinate ion, thiosulfonate ion and sulfate ion. Among these, preferred in view of stability and reactivity are perchlorate ion, hexafluorophosphate ion, tetrafluoroborate ion, sulfonate ion, sulfinate ion and carboxylate ion.

In formula (RI-III), R₃₁, R₃₂ and R₃₃ each independently represents an aryl, alkyl, alkenyl or alkynyl group having 20 or less carbon atoms, which may have from 1 to 6 substituent(s), and in view of reactivity and stability, preferably an aryl group. Examples of the substituent include an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylamino group having from 1 to 12 carbon atoms, an alkylamide or arylamide group having from 1 to 12 carbon atoms, a carbonyl group, a carboxyl group, a cyano group, a sulfonyl group, a thioalkyl group having from 1 to 12 carbon atoms, and a thioaryl group having from 1 to 12 carbon atoms. Z₃₁⁻ represents a monovalent anion and specific examples thereof include halogen ion, perchlorate ion, hexafluorophosphate ion, tetrafluoroborate ion, sulfonate ion, sulfinate ion, thiosulfonate ion and sulfate ion. Among these, preferred in view of stability and reactivity are perchlorate ion, hexafluorophosphate ion, tetrafluoroborate ion, sulfonate ion, sulfinate ion and carboxylate ion. The monovalent anion is more preferably carboxylate ion described in JP-A-2001-343742, more preferably carboxylate ion described in JP-A-2002-148790.

Specific examples of the onium salts represented by formulae (RI-I) to (RI-III) are set forth below, but the present invention is not limited thereto.

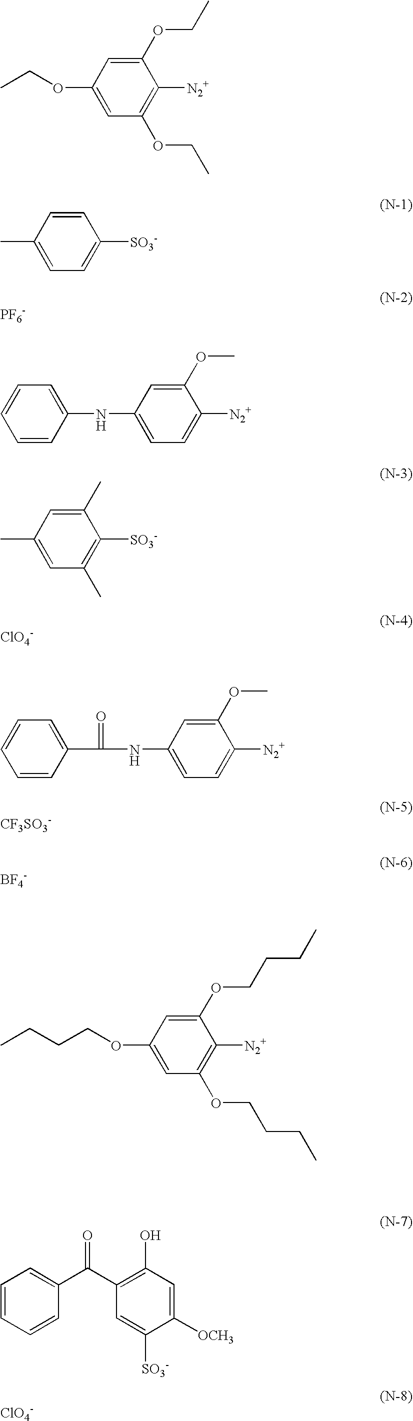

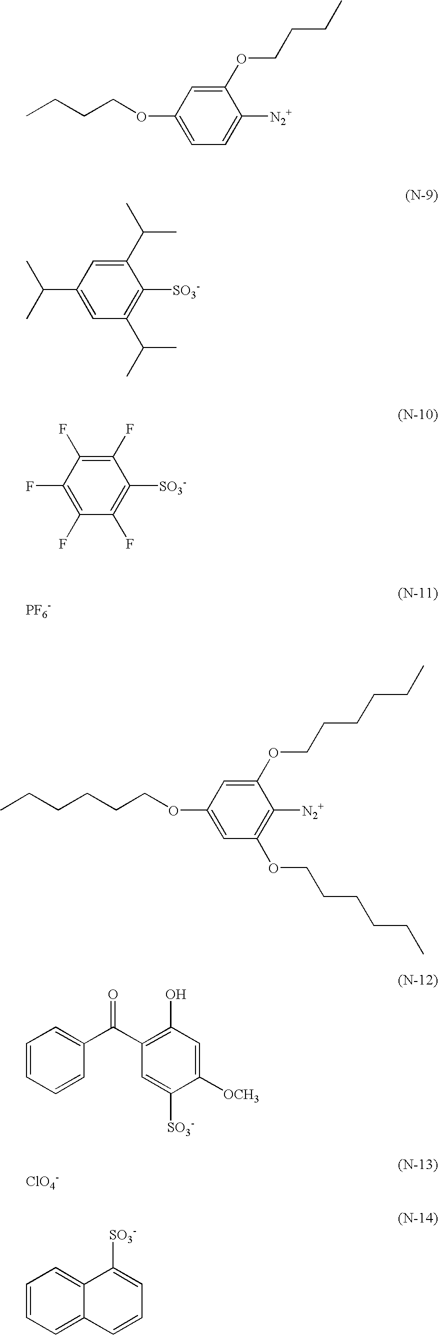

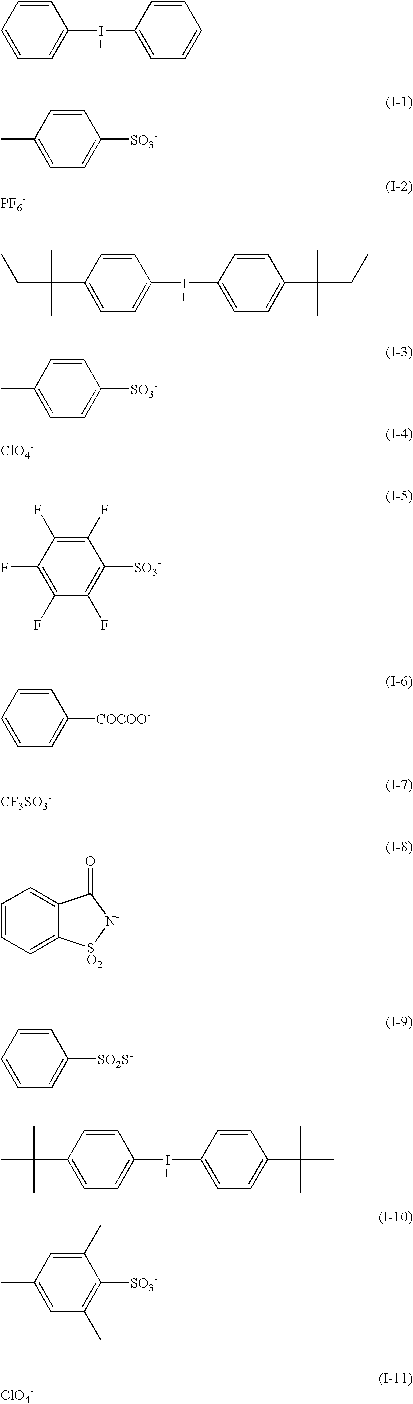

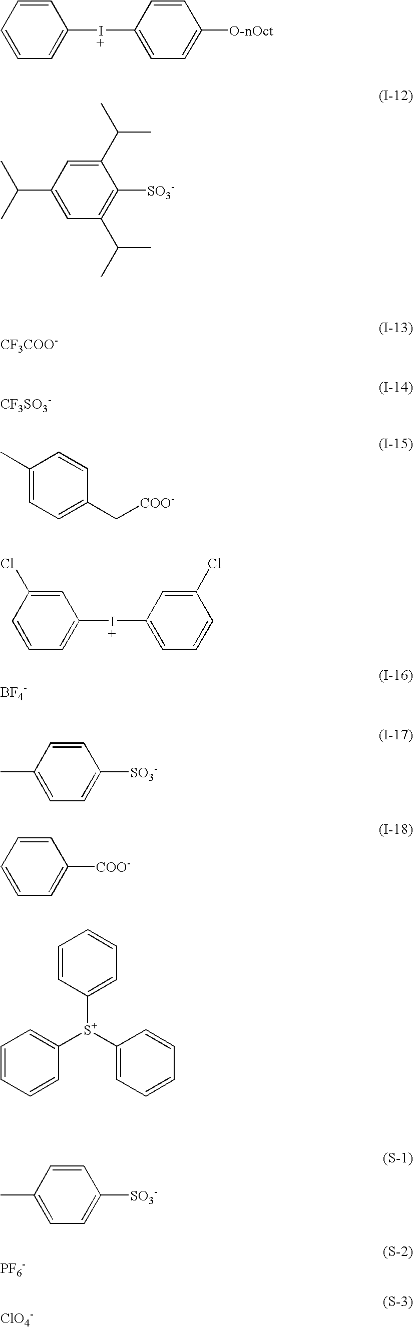

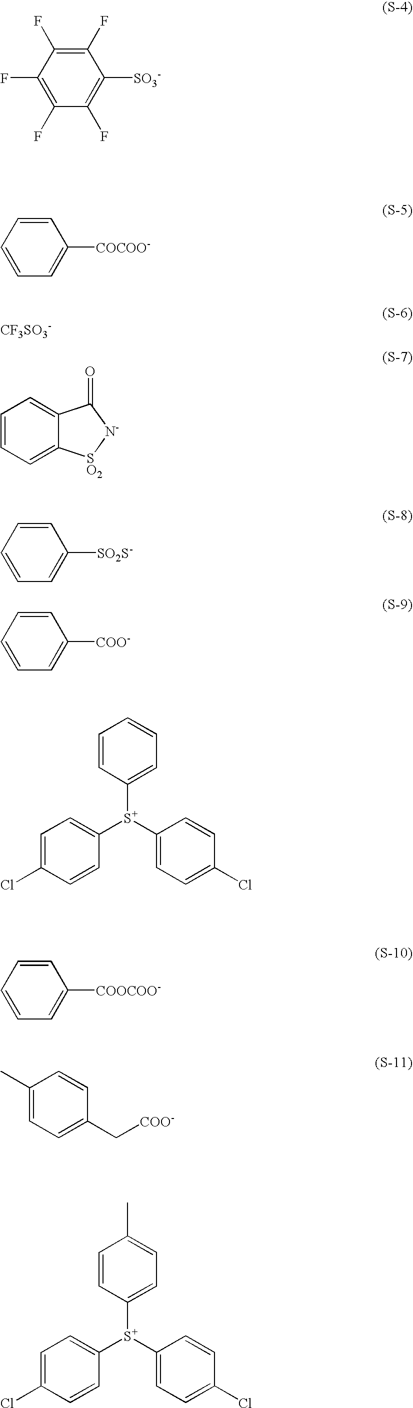

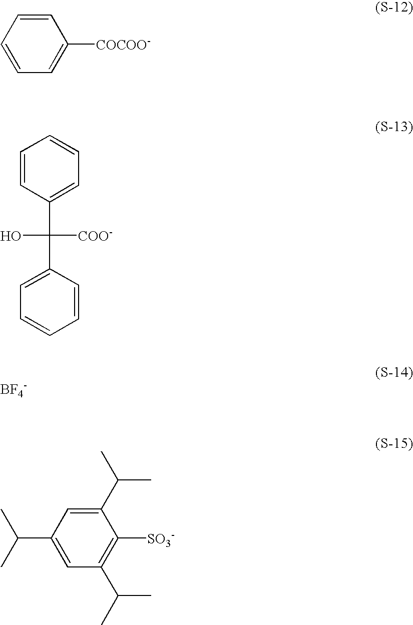

Particularly, the radical initiator for use in the present invention is preferably a compound represented by the following formula (I) because of excellent sensitivity.

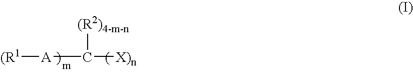

In formula (I), X represents a halogen atom and specific examples thereof include a fluorine atom, a chlorine atom, a bromine atom and an iodine atom. Among these, preferred are a chlorine atom and a bromine atom because of excellent sensitivity, more preferred is a bromine atom.

A represents a divalent linking group selected from the group consisting of —CO—, —SO—, —SO₂—, —PO— and —PO₂—. Among these, preferred are —CO—, —SO— and —SO₂—, more preferred are —CO— and —SO₂.

R¹ and R² each independently represents a hydrogen atom or a monovalent hydrocarbon group having from 1 to 20 carbon atoms.

Examples of the hydrocarbon constituting the hydrocarbon group include hydrocarbons described in paragraphs [0013] and [0014] of JP-A-2002-162741. Specific examples of the hydrocarbon include aliphatic hydrocarbons having from 1 to 30 carbon atoms, such as methane, ethane, propane, butane, hexane, nonane, decane, octadecane, cyclopentane, cyclohexane, adamantane, norbornane, decahydronaphthalene, tricyclo[5.2.1.0^{2,6}]decane, ethylene, propylene, 1-butene, 1-hexene, 1-heptadecene, 2-butene, 2-hexene, 4-nonene, 7-tetradecene, butadiene, piperylene, 1,9-decadiene, cyclopentene, cyclohexene, cyclooctene, 1,4-cyclohexadiene, 1,5-cyclooctadiene, 1,5,9-cyclododecatriene, norbornylene, octahydronaphthalene, bicyclo[2.2.1]hepta-2,5-diene, acetylene, 1-propyne, and 2-hexyne; and aromatic hydrocarbons such as benzene, naphthalene, anthracene, indene and fluorene.

The carbon atom constituting such a hydrocarbon group may be substituted by one or more heteroatom(s) selected from an oxygen atom, a nitrogen atom and a sulfur atom.

Examples of the substituent include a monovalent nonmetallic atom group excluding hydrogen, such as halogen atom (e.g., —F, —Br, —Cl, —I), hydroxyl group, alkoxy group, aryloxy group, mercapto group, alkylthio group, arylthio group, alkyldithio group, aryldithio group, amino group, N-alkylamino group, N,N-dialkylamino group, N-arylamino group, N,N-diarylamino group, N-alkyl-N-arylamino group, acyloxy group, carbamoyloxy group, N-alkylcarbamoyloxy group, N-arylcarbamoyloxy group, N,N-dialkylcarbamoyloxy group, N,N-diarylcarbamoyloxy group, N-alkyl-N-arylcarbamoyloxy group, alkylsulfoxy group, arylsulfoxy group, acylthio group, acylamino group, N-alkylacylamino group, N-arylacylamino group, ureido group, N′-alkylureido group, N′,N′-dialkylureido group, N′-arylureido group, N′,N′-diarylureido group, N′-alkyl-N′-arylureido group, N-alkylureido group, N-arylureido group, N′-alkyl-N-alkylureido group, N′-alkyl-N-arylureido group, N′,N′-dialkyl-N-alkylureido group, N′,N′-dialkyl-N-arylureido group, N′-aryl-N-alkylureido group, N′-aryl-N-arylureido group, N′,N′-diaryl-N-alkylureido group, N′,N′-diaryl-N-arylureido group, N′-alkyl-N′-aryl-N-alkylureido group, N′-alkyl-N′-aryl-N-arylureido group, alkoxycarbonylamino group, aryloxycarbonylamino group, N-alkyl-N-alkoxycarbonylamino group, N-alkyl-N-aryloxycarbonylamino group, N-aryl-N-alkoxycarbonylamino group, N-aryl-N-aryloxycarbonylamino group, formyl group, acyl group, carboxyl group and its conjugate base group, alkoxycarbonyl group, aryloxycarbonyl group, carbamoyl group, N-alkylcarbamoyl group, N,N-dialkylcarbamoyl group, N-arylcarbamoyl group, N,N-diarylcarbamoyl group, N-alkyl-N-arylcarbamoyl group, alkylsulfinyl group, arylsulfinyl group, alkylsulfonyl group, arylsulfonyl group, sulfo group (—SO₃H) and its conjugate base group, alkoxysulfonyl group, aryloxysulfonyl group, sulfinamoyl group, N-alkylsulfinamoyl group, N,N-dialkylsulfinamoyl group, N-arylsulfinamoyl group, N,N-diarylsulfinamoyl group, N-alkyl-N-arylsulfinamoyl group, sulfamoyl group, N-alkylsulfamoyl group, N,N-dialkylsulfamoyl group, N-arylsulfamoyl group, N,N-diarylsulfamoyl group, N-alkyl-N-arylsulfamoyl group, N-acylsulfamoyl group and its conjugate base group, N-alkylsulfonylsulfamoyl group (—SO₂NHSO₂(alkyl)) and its conjugate base group, N-arylsulfonylsulfamoyl group (—SO₂NHSO₂(aryl)) and its conjugate base group, N-alkylsulfonylcarbamoyl group (—CONHSO₂(alkyl)) and its conjugate base group, N-arylsulfonylcarbamoyl group (—CONHSO₂(aryl)) and its conjugate base group, alkoxysilyl group (—Si(O-alkyl)₃), aryloxysilyl group (—Si(O-aryl)₃), hydroxysilyl (—Si(OH)₃) and its conjugate base group, phosphono group (—PO₃H₂) and its conjugate base group, dialkylphosphono group (—PO₃(alkyl)₂), diarylphosphono group (—PO₃(aryl)₂), alkylarylphosphono group (—PO₃(alkyl)(aryl)), monoalkylphosphono group (—PO₃H(alkyl)) and its conjugate base group, monoarylphosphono group (—PO₃H(aryl)) and its conjugate base group, phosphonooxy group (—OPO₃H₂) and its conjugate base group, dialkylphosphonooxy group (—OPO₃(alkyl)₂), diarylphosphonooxy group (—OPO₃(aryl)₂), alkylarylphosphonooxy group (—OPO₃(alkyl)(aryl)), monoalkylphosphonooxy group (—OPO₃H(alkyl)) and its conjugate base group, monoarylphosphonooxy group (—OPO₃H(aryl)) and its conjugate base group, cyano group, nitro group, dialkylboryl group (—B(alkyl)₂), diarylboryl group (—B(aryl)₂), alkylarylboryl group (—B(alkyl)(aryl)), dihydroxyboryl group (—B(OH)₂) and its conjugate base group, alkylhydroxyboryl group (—B(alkyl)(OH)) and its conjugatebase group, arylhydroxyboryl group (—B(aryl)(OH)) and its conjugate base group, aryl group, alkyl group, alkenyl group and alkynyl group. The substituents may combine, if possible, with each other to form a ring or the substituent may combine with the hydrocarbon group to which such a group is substituted, and the substituent may be further substituted. Preferred examples of the substituent include a halogen atom, an alkoxy group, an aryloxy group, an alkyl group, an alkenyl group, an alkynyl group and an aryl group.

m and n each represents an integer of 1 to 3, provided that m+n is from 2 to 4. In view of sensitivity, it is preferred that m is 1 and n is 3, or m is 2 and n is 2.

When m and n each is an integer of 2 or more, multiple (R¹-A) or multiple X may be the same or different. Also, when m is 1 and n is 1, multiple R² may be the same or different.

Among the compounds represented by formula (I), compounds represented by the following formulae (II) and (III) are preferred because of excellent visibility. 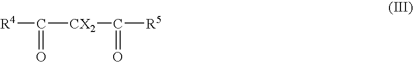
(wherein X has the same meaning as in formula (I), and R³, R⁴ and R⁵ each independently represents a monovalent hydrocarbon group having from 1 to 20 carbon atoms).

R³, R⁴ and R⁵ each is preferably an aryl group, more preferably an aryl group substituted by an amido group, because of excellent balance between sensitivity and storability. Among these, more preferred is a compound represented by formula (IV). 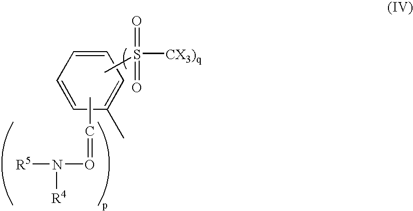
(wherein R⁴ and R⁵ each independently represents a hydrogen atom or a monovalent hydrocarbon group having from 1 to 20 carbon atoms, and p and q each represents an integer of 1 to 5, provided that p+q is from 2 to 6).

Specific examples of the radical initiator represented by formula (I) include the compounds having a chemical formula shown below and Compound I-3 shown later in Example.

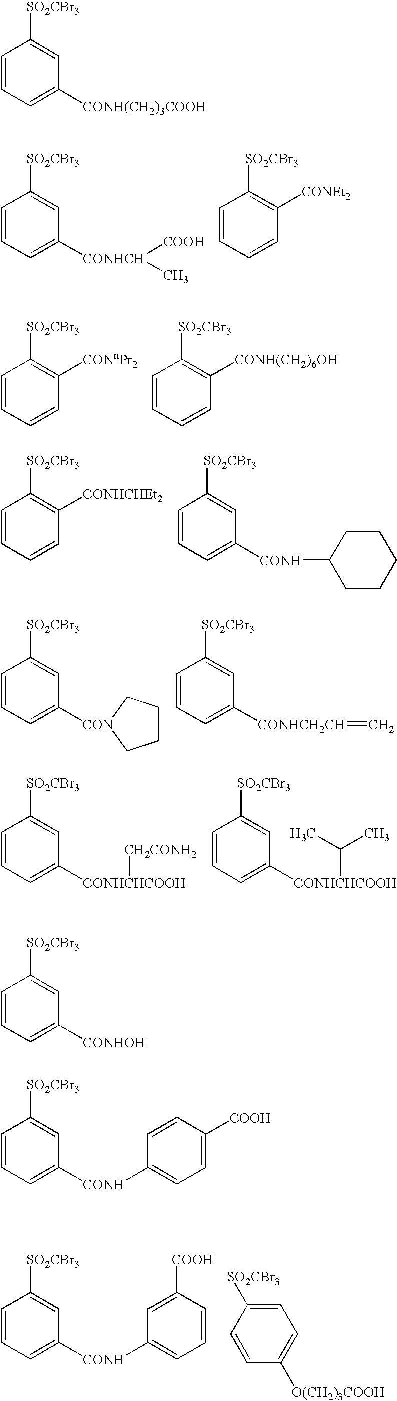

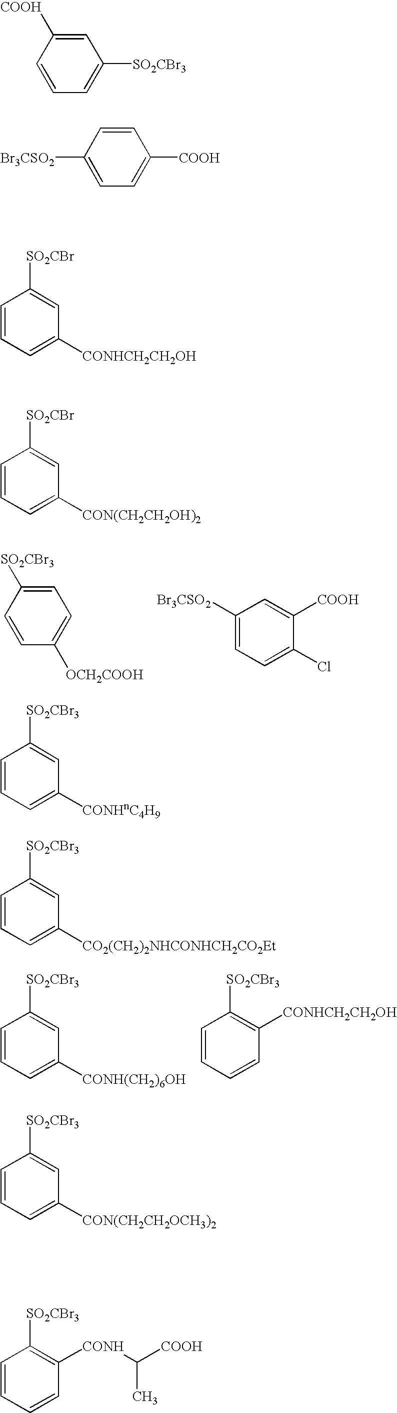

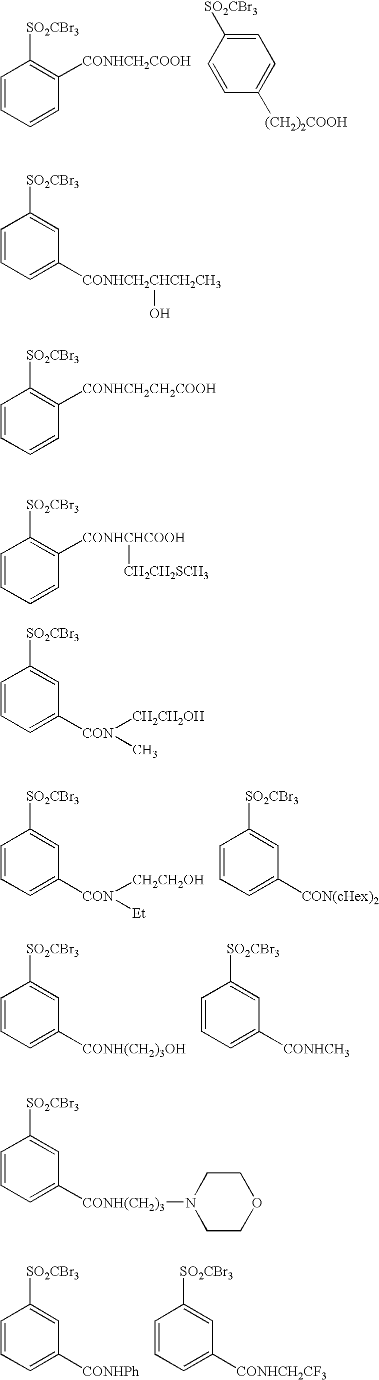

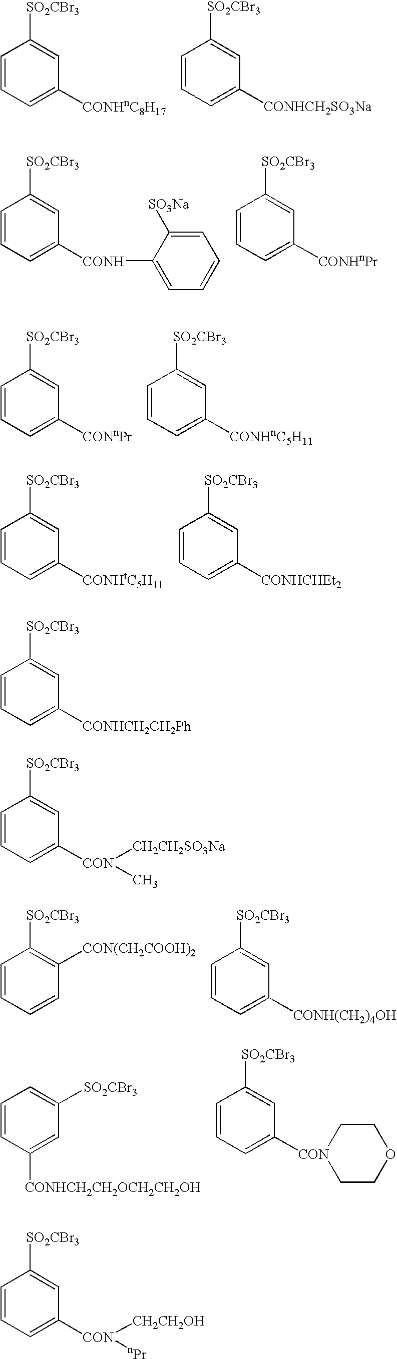

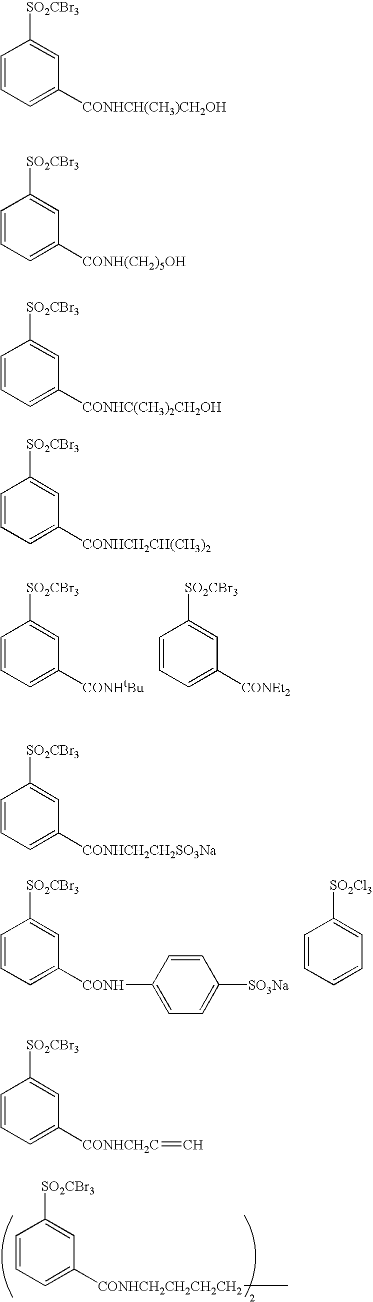

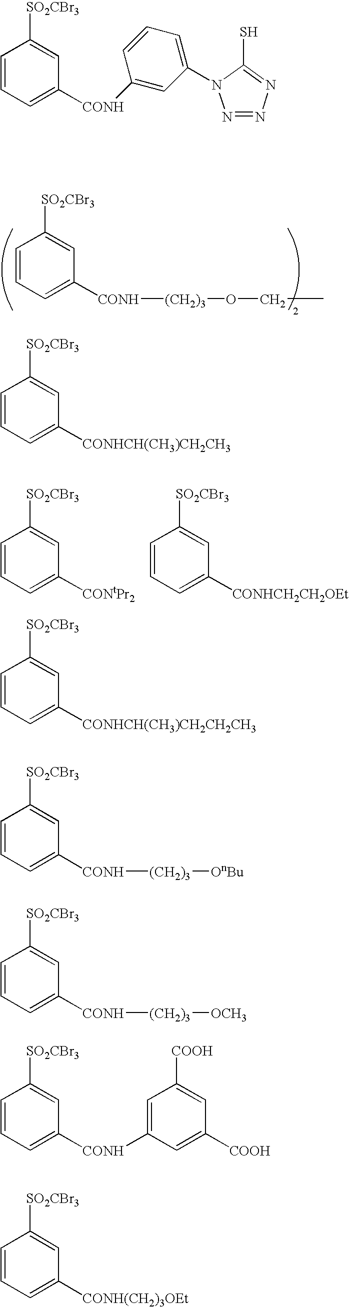

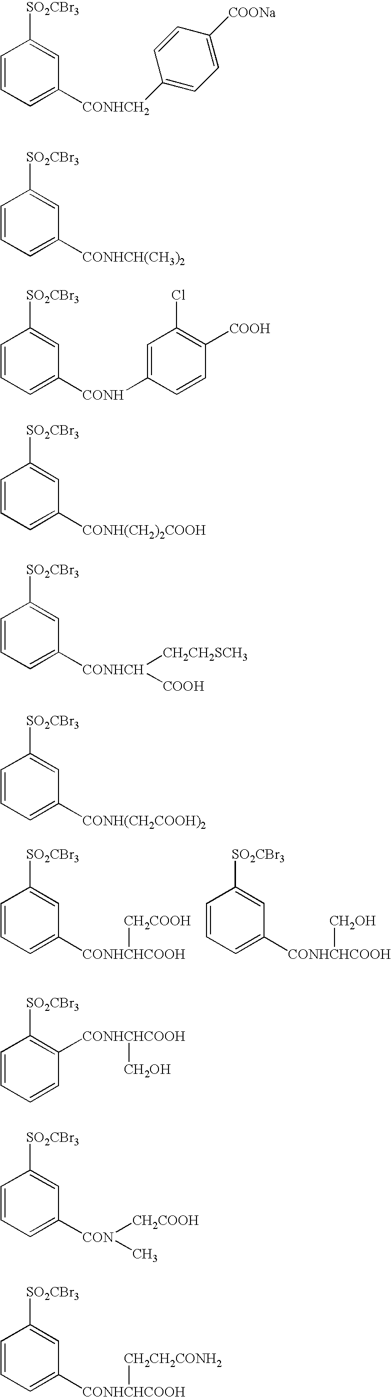

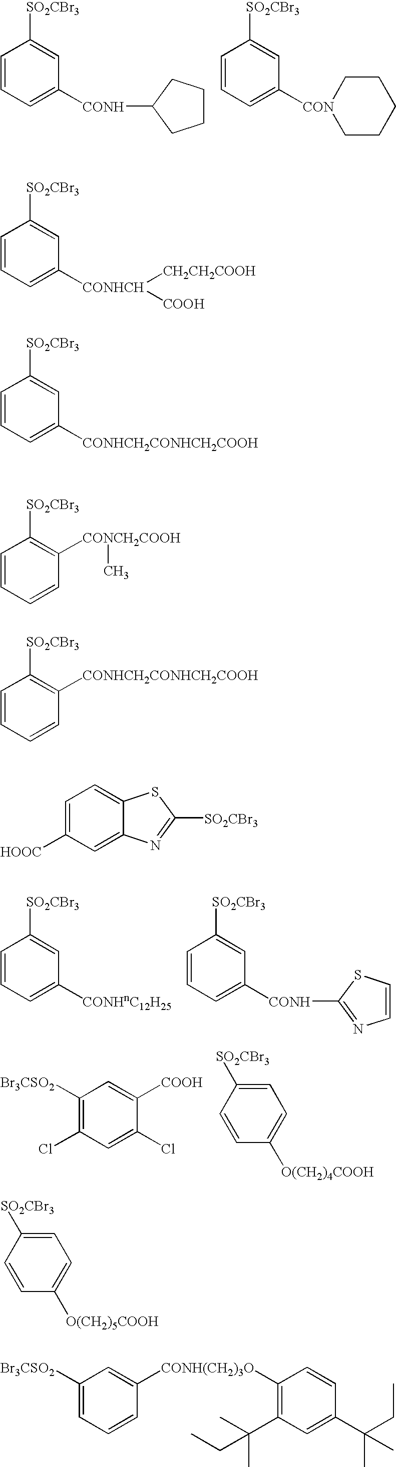

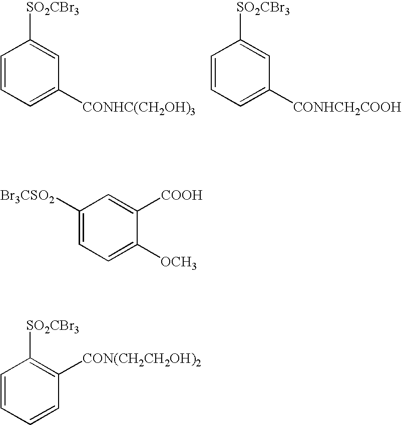

The method for incorporating the discoloring agent or discoloration system of the present invention into the photosensitive-thermosensitive layer includes a method of dissolving the discoloring agent or discoloration system component in an appropriate solvent and coating the solution, and a method of enclosing the discoloring agent or discoloration system component in a microcapsule and incorporating the microcapsule into the photosensitive-thermosensitive layer. The latter method is a preferred embodiment for obtaining a printout image having a large lightness difference, because the discoloring agent or discoloration system component is microencapsulated and separated from the reaction system for forming a printed image and respective reactions can be prevented from being inhibited. The microencapsulation can be performed by a known method described later.

The discoloring agent or discoloration system may be incorporated into a layer different from the photosensitive-thermosensitive layer. In this case, an infrared absorbent is preferably present together in the different layer. Examples of the different layer include a protective layer and an undercoat layer which are described later.

The amount added of the discoloring agent per unit area of the lithographic printing plate precursor is preferably from 0.001 to 1 g/m², more preferably from 0.005 to 0.5 g/m², and most preferably from 0.01 to 0.3 g/m².

The amount added of the substance (developer or acid, base or radical generator) of causing discoloration, contained in the discoloration system, per unit area of the lithographic printing plate precursor is preferably from 0.001 to 1 g/m², more preferably from 0.005 to 0.5 g/m², and most preferably from 0.01 to 0.3 g/m².

Within these ranges, a lightness difference ΔL of 4.0 or more between exposed area and unexposed area can be obtained.

(Infrared Absorbent)

In the photosensitive-thermosensitive layer of the present invention, an infrared absorbent is used so as to elevate the sensitivity to infrared laser. The infrared absorbent has a function of converting the absorbed infrared ray into heat. The infrared absorbent for use in the present invention is a dye or pigment having an absorption maximum at a wavelength of 760 to 1,200 nm.

As for the dye, commercially available dyes and known dyes described in publications, for example, Senryo Binran (Handbook of Dyes), compiled by Yuki Gosei Kagaku Kyokai (1970), may be used. Specific examples thereof include dyes such as azo dye, metal complex salt azo dye, pyrazolone azo dye, naphthoquinone dye, anthraquinone dye, phthalocyanine dye, carbonium dye, quinoneimine dye, methine dye, cyanine dye, squarylium dye, pyrylium salt and metal thiolate complex.

Preferred examples of the dye include cyanine dyes described in JP-A-58-125246, JP-A-59-84356 and JP-A-60-78787, methine dyes described in JP-A-58-173696, JP-A-58-181690 and JP-A-58-194595, naphthoquinone dyes described in JP-A-58-112793, JP-A-58-224793, JP-A-59-48187, JP-A-59-73996, JP-A-60-52940 and JP-A-60-63744, squarylium dyes described in JP-A-58-112792, and cyanine dyes described in British Patent 434,875.

Also, near infrared absorbing sensitizers described in U.S. Pat. No. 5,156,938 may be suitably used. Furthermore, substituted arylbenzo(thio)pyrylium salts described in U.S. Pat. No. 3,881,924, trimethinethiapyrylium salts described in JP-A-57-142645 (corresponding to U.S. Pat. No. 4,327,169), pyrylium-based compounds described in JP-A-58-181051, JP-A-58-220143, JP-A-59-41363, JP-A-59-84248, JP-59-84249, JP-A-59-146063 and-JP-A-59-146061, cyanine dyes described in JP-A-59-216146, pentamethinethiapyrylium salts described in U.S. Pat. No. 4,283,475, and pyrylium compounds described in JP-B-5-13514 and JP-B-5-19702 may also be preferably used. Other preferred examples of the dye include near infrared absorbing dyes represented by formulae (I) and (II) of U.S. Pat. No. 4,756,993.

Other preferred examples of the infrared absorbent for use in the present invention include specific indolenine cyanine dyes described in JP-A-2002-278057, such as those set forth below.

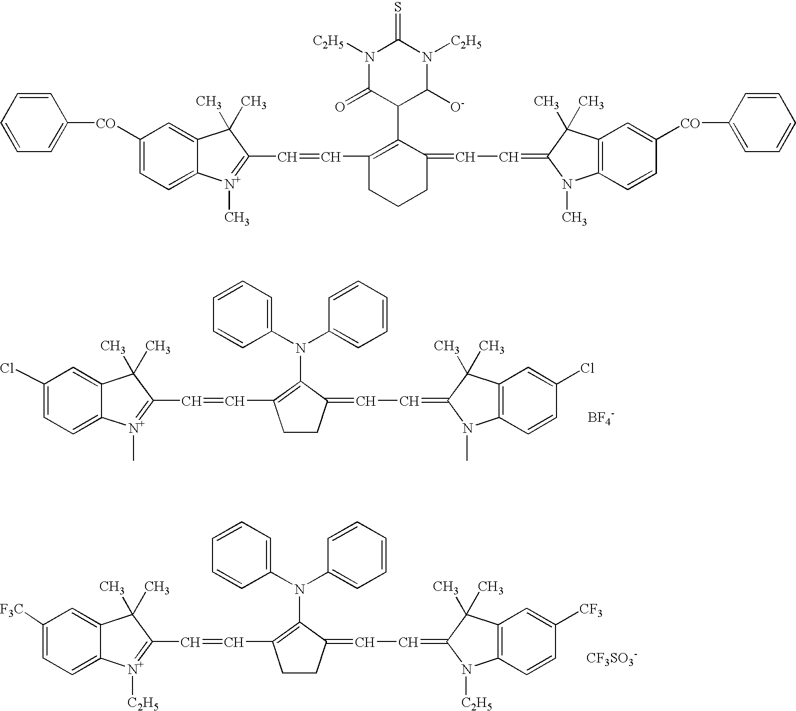

Among these dyes, particularly preferred are cyanine dye, squarylium dye, pyrylium salt, nickel thiolate complex and indolenine cyanine dye, more preferred are cyanine dye and indoleninie cyanine dye, still more preferred is a cyanine dye represented by the following formula (V):

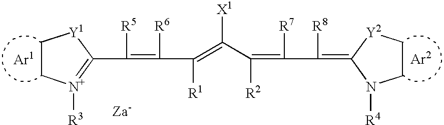

In formula (V), X¹ represents a hydrogen atom, a halogen atom, —NPh₂, X²—L¹ or a group shown below: 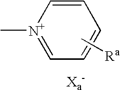
wherein Xₐ⁻ has the same definition as Za⁻ described later, and R^{a} represents a substituent selected from a hydrogen atom, an alkyl group, an aryl group, a substituted or unsubstituted ammo group and a halogen atom.

X² represents an oxygen atom, a nitrogen atom or a sulfur atom and L¹ represents a hydrocarbon group having from 1 to 12 carbon atoms, an aromatic ring having a heteroatom, or a hydrocarbon group having from 1 to 12 carbon atoms and containing a heteroatom. The heteroatom as used herein indicates N, S, O, a halogen atom or Se.

R¹ and R² each independently represents a hydrocarbon group having from 1 to 12 carbon atoms. In view of storage stability of the coating solution for the recording layer, R¹ and R² each is preferably a hydrocarbon group having 2 to more carbon atoms and R¹ and R² are more preferably combined with each other to form a 5- or 6-membered ring.

Ar¹ and Ar² may be the same or different and each represents an aromatic hydrocarbon group which may have a substituent. Preferred examples of the aromatic hydrocarbon group include a benzene ring and a naphthalene ring. Preferred examples of the substituent include a hydrocarbon group having 12 or less carbon atoms, a halogen atom and an alkoxy group having 12 or less carbon atoms. Y¹ and Y² may be the same or different and each represents a sulfur atom or a dialkylmethylene group having 12 or less carbon atoms. R³ and R⁴ may be the same or different and each represents a hydrocarbon group having 20 or less carbon atoms, which may have a substituent. Preferred examples of the substituent include an alkoxy group having 12 or less carbon atoms, a carboxyl group and a sulfo group. R⁵, R⁶, R⁷ and R⁸ may be the same or different and each represents a hydrogen atom or a hydrocarbon group having 12 or less carbon atoms, and in view of availability of the raw material, preferably a hydrogen atom. Za⁻ represents a counter anion, but when the cyanine dye represented by formula (V) has an anionic substituent in its structure and neutralization of electric charge is not necessary, Za⁻ is not present. In view of storage stability of the coating solution for the recording layer, Za⁻ is preferably halide ion, perchlorate ion, tetrafluoroborate ion, hexafluorophosphate ion or sulfonate ion, more preferably perchlorate ion, hexafluorophosphate ion or arylsulfonate ion.

Specific examples of the cyanine dye represented by formula (V), which can be suitably used in the present invention, include those described in paragraphs [0017] to [0019] of JP-A-2001-133969.

Other particularly preferred examples include specific indolenine cyanine dyes described in JP-A-2002-278057.

As for the pigment used in the present invention, commercially available pigments and pigments described in Color Index (C.I.) Binran (C.I. Handbook), Saishin Ganryo Binran (Handbook of Newest Pigments), compiled by Nippon Ganryo Gijutsu Kyokai (1977), Saishin Ganryo Oyo Gijutsu (Newest Pigment Application Technology), CMC Shuppan (1986), and Insatsu Ink Gijutsu (Printing Ink Technology), CMC Shuppan (1984) can be used.

The kind of pigment includes black pigment, yellow pigment, orange pigment, brown pigment, red pigment, violet pigment, blue pigment, green pigment, fluorescent pigment, metal powder pigment and polymer bond pigment. Specific examples of the pigment which can be used include insoluble azo pigments, azo lake pigments, condensed azo pigments, chelate azo pigments, phthalocyanine-based pigments, anthraquinone-based pigments, perylene- and perynone-based pigments, thioindigo-based pigments, quinacridone-based pigments, dioxazine-based pigments, isoindolinone-based pigments, quinophthalone-based pigments, dyed lake pigments, azine pigments, nitro pigments, nitro pigments, natural pigments, fluorescent pigments, inorganic pigments and carbon black. Among these pigments, carbon black is preferred.

These pigments may or may not be surface-treated before use. Examples of the method for surface treatment include a method of coating the surface with resin or wax, a method of attaching a surfactant, and a method of bonding a reactive substance (for example, silane coupling agent, epoxy compound or isocyanate) to the pigment surface. These surface-treatment methods are described in Kinzoku Sekken no Seishitsu to Oyo (Properties and Application of Metal Soap), Saiwai Shobo, Insatsu Ink Gijutsu (Printing Ink Technology), CMC Shuppan (1984), and Saishin Ganryo Oyo Gijutsu (Newest Pigment Application Technology), CMC Shuppan (1986).

The particle size of the pigment is preferably from 0.01 to 10 μm, more preferably from 0.05 to 1 μm, still more preferably from 0.1 to 1 μm. Within this range, good stability of the pigment dispersion in the coating solution for the photosensitive-thermosensitive layer and good uniformity of the photosensitive-thermosensitive layer can be obtained.

For dispersing the pigment, a known dispersion technique used in the production of ink or toner may be used. Examples of the dispersing machine include ultrasonic disperser, sand mill, attritor, pearl mill, super-mill, ball mill, impeller, disperser, KD mill, colloid mill, dynatron, three-roll mill and pressure kneader. These are described in detail in Saishin Ganryo Oyo Gijutsu (Newest Pigment Application Technology), CMC Shuppan (1986).

The infrared absorbent may be added together with other components in the same layer or may be added to a layer provided separately. Also, the infrared absorbent may be encapsulated in a microcapsule and then added.

As for the amount added, the infrared absorbent is preferably added such that when a negative lithographic printing plate precursor is produced, the absorbancy of the photosensitive-thermosensitive layer at a maximum absorption wavelength in the wavelength range of 760 to 1,200 nm is from 0.3 to 1.2, more preferably from 0.4 to 1.1, as measured by a reflection measuring method. Within this range, a uniform polymerization reaction proceeds in the depth direction of the photosensitive-thermosensitive layer and the image area can have good film strength and good adhesion to the support.

The absorbancy of the photosensitive-thermosensitive layer can be adjusted by the amount of the infrared absorbent added to the photosensitive-thermosensitive layer and the thickness of the photosensitive-thermosensitive layer. The absorbancy can be measured by an ordinary method. Examples of the measuring method include a method where a photosensitive-thermosensitive layer having a thickness appropriately decided within the range of the dry coated amount necessary as a lithographic printing plate is formed on a reflective support such as aluminum and the reflection density is measured by an optical densitometer, and a method of measuring the absorbancy by a spectrophotometer according to a reflection method using an integrating sphere.

(Element for Forming Printed Image)

As for the element which can be preferably used for forming a printed image in the photosensitive-thermosensitive layer of the present invention, (A) an image-forming element utilizing radical polymerization and (B) an image-forming element utilizing heat fusion or thermal reaction of a hydrophobization precursor both can be used. These elements are described below.

(A) Image-Forming Element Utilizing Radical Polymerization

In the image-forming element utilizing radical polymerization, the photosensitive-thermosensitive layer of the present invention contains, in addition to the above-described discoloring agent or discoloration system, a radical polymerizable compound and a radical polymerization initiator.

The radical polymerization-type element has high sensitivity of image formation and can effectively distribute the exposure energy to the formation of a printout image and therefore, this element is more preferred for obtaining a printout image having a large lightness difference.

<Radical Polymerizable Compound>

The photosensitive-thermosensitive layer of the present invention preferably contains a radical polymerizable compound (hereinafter sometimes simply referred to as a “polymerizable compound”) so as to efficiently perform the curing reaction. The radical polymerizable compound which can be used in the present invention is an addition-polymerizable compound having at least one ethylenically unsaturated double bond and is selected from compounds having at least one, preferably two or more, ethylenically unsaturated bond(s). Such compounds are widely known in this industrial field and these known compounds can be used in the present invention without any particular limitation. These compounds have a chemical mode such as monomer, prepolymer (that is, dimer, trimer or oligomer) or a mixture or copolymer thereof Examples of the monomer and its copolymer include unsaturated carboxylic acids (e.g., acrylic acid, methacrylic acid, itaconic acid, crotonic acid, isocrotonic acid, maleic acid), and esters and amides thereof. Among these, preferred are esters of an unsaturated carboxylic acid with an aliphatic polyhydric alcohol compound, and amides of an unsaturated carboxylic acid with an aliphatic polyvalent amine compound. Also, addition reaction products of an unsaturated carboxylic acid ester or amide having a nucleophilic substituent such as hydroxyl group, amino group or mercapto group with a monofunctional or polyfunctional isocyanate or epoxy, and dehydrating condensation reaction products with a monofunctional or polyfunctional carboxylic acid may be suitably used. Furthermore, addition reaction products of an unsaturated carboxylic acid ester or amide having an electrophilic substituent such as isocyanate group or epoxy group with a monofunctional or polyfunctional alcohol, amine or thiol, and displacement reaction products of an unsaturated carboxylic acid ester or amide having a disorptive substituent such as halogen group or tosyloxy group with a monofunctional or polyfunctional alcohol, amine or thiol may also be suitably used. Also, compounds where the unsaturated carboxylic acid of the above-described compounds is replaced by an unsaturated phosphonic acid, styrene, vinyl ether or the like, may be used.

Specific examples of the ester monomer of an aliphatic polyhydric alcohol compound with an unsaturated carboxylic acid include the followings. Examples of the acrylic acid ester include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, polyester acrylate oligomer and isocyanuric acid EO-modified triacrylate.

Examples of the methacrylic acid ester include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane and bis[p-(methacryloxyethoxy)phenyl]dimethylmethane.

Examples of the itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate and sorbitol tetraitaconate. Examples of the crotonic acid ester include ethylene glycol dicrotonate, tetramethylene glycol dicrotonate, pentaerythritol dicrotonate and sorbitol tetradicrotonate. Examples of the isocrotonic acid ester include ethylene glycol diisocrotonate, pentaerythritol diisocrotonate and sorbitol tetraisocrotonate. Examples of the maleic acid ester include ethylene glycol dimaleate, triethylene glycol dimaleate, pentaerythritol dimaleate and sorbitol tetramaleate.

Other examples of the ester include aliphatic alcohol-based esters described in JP-B-51-47334 and JP-A-57-196231, those having an aromatic skeleton described in JP-A-59-5240, JP-A-59-5241 and JP-A-2-226149, and those containing an amino group described in JP-A-1-165613. These ester monomers may also be used as a mixture.

Specific examples of the amide monomer of an aliphatic polyvalent amine compound with an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide and xylylenebis-methacrylamide. Other preferred examples of the amide-type monomer include those having a cyclohexylene structure described in JP-B-54-21726.

A urethane-based addition-polymerizable compounds produced by using an addition reaction of isocyanate with a hydroxyl group is also preferred and specific examples thereof include vinyl urethane compounds having two or more polymerizable vinyl groups within one molecule described in JP-B-48-41708, which are obtained by adding a vinyl monomer having a hydroxyl group represented by the following formula (a) to a polyisocyanate compound having two or more isocyanate groups within one molecule:
CH₂═C(R₄)COOCH₂CH(R₅)OH (a)
(wherein R₄ and R₅ each represents H or CH₃).

Also, urethane acrylates described in JP-A-51-37193, JP-B-2-32293 and JP-B-2-16765, and urethane compounds having an ethylene oxide-type skeleton described in JP-B-58-49860, JP-B-56-17654, JP-B-62-39417 and JP-B-62-39418 are also suitably used. Furthermore, when addition-polymerizable compounds having an amino or sulfide structure within the molecule described in JP-A-63-277653, JP-A-63-260909 and JP-A-1-105238 are used, a photopolymerizable composition having very excellent photosensitization speed can be obtained.

Other examples include polyfunctional acrylates and methacrylates such as polyester acrylates described in JP-A-48-64183, JP-B-49-43191 and JP-B-52-30490 and epoxy acrylates obtained by reacting an epoxy resin with a (meth)acrylic acid. In addition, specific unsaturated compounds described in JP-B-46-43946, JP-B-1-40337 and JP-B-1-40336, and vinyl phosphonic acid-based compounds described in JP-A-2-25493 may be used. In some cases, structures containing a perfluoroalkyl group described in JP-A-61-22048 are suitably used. Furthermore, those described as a photocurable monomer or oligomer in Adhesion, Vol. 20, No. 7, pp. 300-308 (1984) may also be used.

Details of the use method of these polymerizable compounds, such as structure of the compound, sole or combination use and amount added, can be freely selected in accordance with the designed performance of final lithographic printing plate precursor. For example, these are selected from the following standpoints.

In view of sensitivity, a structure having a large unsaturated group content per one molecule is preferred and in most cases, a bifunctional or greater functional compound is preferred. For increasing the strength of image area, namely, cured layer, a trifunctional or greater functional compound is preferred. Also, a method of controlling both sensitivity and strength by using a combination of compounds differing in the functional number and in the polymerizable group (for example, an acrylic acid ester, a methacrylic acid ester, a styrene-based compound or a vinyl ether-based compound) is effective.

The selection and use method of the polymerizable compound are important factors also for the compatibility and dispersibility with other components (e.g., binder polymer, initiator, colorant) in the photosensitive-thermosensitive layer. For example, the compatibility may be improved in some cases by using a low purity compound or using two or more compounds in combination. Also, a specific structure may be selected for the purpose of improving the adhesion to the support, overcoat layer which is described later, or the like.

In the photosensitive-thermosensitive layer, the polymerizable compound is preferably used in an amount of 5 to 80 mass %, more preferably from 25 to 75 mass, based on the nonvolatile components. Also, these polymerizable compounds may be used individually or in combination of two or more thereof. As for the use method of the addition polymerizable compound, appropriate structure, formulation and amount added can be freely selected by taking account of the degree of polymerization inhibition due to oxygen, resolution, fogging, change in refractive index, surface tackiness and the like. Depending on the case, layer construction-coating method such as undercoat and overcoat can also be employed.

<Radical Polymerization Initiator>

As for the radical polymerization initiator of the radical polymerization-type element, the above-described radical initiators can be used. In particular, onium salts represented by formulae (RI-I) to (RI-III) are preferred.

Within the content range specified in regard of the radical initiator, good sensitivity and press life can be obtained.

<Other Components of Photosensitive-Thermosensitive Layer>

The radical polymerization-type photosensitive-thermosensitive layer of the present invention may further contain, if desired, additives such as binder polymer, surfactant, polymerization inhibitor, higher fatty acid derivative, plasticizer, inorganic fine particle and low molecular hydrophilic compound. These components are described below.

<Binder Polymer>

The photosensitive-thermosensitive layer of the present invention may contain a binder polymer. As for the binder polymer which can be used in the present invention, conventionally known binder polymers can be used without limitation and a linear organic polymer having a film property is preferred. Examples of such a binder polymer include acrylic resin, polyvinyl acetal resin, polyurethane resin, polyurea resin, polyimide resin, polyamide resin, epoxy resin, methacrylic resin, polystyrene-based resin, novolak-type phenol-based resin, polyester resin, synthetic rubber and natural rubber.

The binder polymer preferably has crosslinking property so as to enhance the film strength in the image area. The crosslinking property may be imparted to the binder polymer by introducing a crosslinkable functional group such as ethylenically unsaturated bond into the main or side chain of the polymer. The crosslinkable functional group may be introduced by copolymerization.

Examples of the polymer having an ethylenically unsaturated bond in the main chain of the molecule include poly-1,4-butadiene and poly-1,4-isoprene.

Examples of the polymer having an ethylenically unsaturated bond in the side chain of the molecule include polymers which are a polymer of acrylic or methacrylic acid ester or amide and in which the ester or amide residue (R in —COOR or CONHR) has an ethylenically unsaturated bond.

Examples of the residue (R above) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and (CH₂CH₂O)₂—X (wherein R¹ to R³ each represents a hydrogen atom, a halogen atom or an alkyl, aryl, alkoxy or aryloxy group having from 1 to 20 carbon atoms, R¹ and R² or R³ may combine with each other to form a ring, n represents an integer of 1 to 10, and X represents a dicyclopentadienyl residue).

Specific examples of the ester residue include —CH₂CH═CH₂ (described in JP-B-7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and CH₂CH₂O—X (wherein X represents a dicyclopentadienyl residue).

Specific examples of the amide residue include —CH₂CH═CH₂, —CH₂CH₂—Y (wherein Y represents a cyclohexene residue) and —CH₂CH₂—OCO—CH═CH₂.

In the binder polymer having crosslinking property, for example, a free radical (a polymerization initiating radical or a radical grown in the process of polymerization of a polymerizable compound) is added to the crosslinkable functional group to cause addition-polymerization between polymers directly or through a polymerization chain of the polymerizable compound, as a result, crosslinking is formed between polymer molecules and thereby curing is effected. Alternately, an atom (for example, a hydrogen atom on the carbon atom adjacent to the functional crosslinkable group) in the polymer is withdrawn by a free radical to produce a polymer radical and the polymer radicals combine with each other to form crosslinking between polymer molecules, thereby effecting curing.

The content of the crosslinkable group (content of radical-polymerizable unsaturated double bond determined by iodine titration) in the binder polymer is preferably from 0.1 to 10.0 mmol, more preferably from 1.0 to 7.0 mmol, most preferably from 2.0 to 5.5 mmol, per g of the binder polymer. Within this range, good sensitivity and good storage stability can be obtained.

The binder polymer may be a random polymer, a block polymer or a graft polymer but is preferably a random polymer. Also, the binder polymers may be used individually or in combination of two or more thereof.

The binder polymer can be synthesized by a conventionally known method. Examples of the solvent used in the synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethylacetate, diethylene glycol dimethyl ether, 1-methoxy-2-propanol, 1-methoxy-2-propylacetate, N,N-dimethylformamide, N,N-dimethylacetamide, toluene, ethyl acetate, methyl lactate, ethyl lactate, dimethyl sulfoxide and water. These solvents are used individually or in combination of two or more thereof.

The radical polymerization initiator used in the synthesis of the binder polymer may be a known compound such as azo-type initiator and peroxide initiator.

From the standpoint of enhancing the on-press developability, the binder polymer preferably has high solubility or dispersibility in the ink and/or fountain solution.

In order to enhance the solubility or dispersibility in the ink, the binder polymer is preferably lipophilic and in order to enhance the solubility or dispersibility in the fountain solution, the binder polymer is preferably hydrophilic. Therefore, a combination use of a lipophilic binder polymer and a hydrophilic binder polymer is also effective in the present invention.

Examples of the hydrophilic binder polymer which can be suitably used include those having a hydrophilic group such as hydroxy group, carboxyl group, carboxylate group, hydroxyethyl group, polyoxyethyl group, hydroxypropyl group, polyoxypropyl group, amino group, aminoethyl group, aminopropyl group, ammonium group, amide group, carboxymethyl group, sulfonic acid group and phosphoric acid group.

Specific examples thereof include gum arabic, casein, gelatin, starch derivatives, carboxymethyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a hydrolysis degree of 60 mol % or more, preferably 80 mol % or more, polyvinyl formal, polyvinyl butyral, polyvinylpyrrolidone, homopolymers and polymers of acrylamide, homopolymers and copolymers of methacrylamide, homopolymers and copolymers of N-methylolacrylamide, polyvinylpyrrolidone, alcohol-soluble nylons, and polyethers of 2,2-bis-(4-hydroxyphenyl)-propane with epichlorohydrin.

The weight average molecular weight of the binder polymer is preferably 5,000 or more, more preferably from 10,000 to 300,000. The number average molecular weight is preferably 1,000 or more, more preferably from 2,000 to 250,000. The polydispersion degree (weight average molecular weight/number average molecular weight) is preferably from 1.1 to 10.

The binder polymer content if from 10 to 90 mass %, preferably from 20 to 80 mass %, more preferably from 30 to 70 mass %, based on the entire solid content of the photosensitive-thermosensitive layer. Within this range, good strength of image area and good image-forming property can be obtained.

The polymerizable compound and the binder polymer are preferably used in amounts of giving a mass ratio of 1/9 to 7/3.

<Surfactant>

In the present invention, a surfactant is preferably used in the photosensitive-thermosensitive layer so as to accelerate the on-press development at the initiation of printing and enhance the coated surface state. The surfactant includes a nonionic surfactant, an anionic surfactant, a cationic surfactant, an amphoteric surfactant, a fluorine-containing surfactant and the like. The surfactants may be used individually or in combination of two or more thereof.

The nonionic surfactant for use in the present invention is not particularly limited and a conventionally known nonionic surfactant can be used. Examples thereof include polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylene alkylamines, triethanolamine fatty acid esters, trialkylamine oxides, polyethylene glycol, and copolymers of polyethylene glycol and polypropylene glycol.

The anionic surfactant for use in the present invention is not particularly limited and a conventionally known anionic surfactant can be used. Examples thereof include fatty acid salts, abietates, hydroxyalkanesulfonates, alkanesulfonates, dialkylsulfosuccinic ester salts, linear alkylbenzenesulfonates, branched alkylbenzenesulfonates, alkylnaphthalenesulfonates, alkylphenoxypolyoxyethylenepropylsulfonates, polyoxyethylenealkylsulfophenyl ether salts, N-methyl-N-oleyltaurine sodium salts, monoamide disodium N-alkylsulfosuccinates, petroleum sulfonates, sulfated beef tallow oils, sulfuric ester salts of fatty acid alkyl ester, alkylsulfuric ester salts, polyoxyethylene alkyl ether sulfuric ester salts, fatty acid monoglyceride sulfuric ester salts, polyoxyethylene alkylphenyl ether sulfuric ester salts, polyoxyethylene styrylphenyl ether sulfuric ester salts, alkylphosphoric ester salts, polyoxyethylene alkyl ether phosphoric ester salts, polyoxyethylene alkylphenyl ether phosphoric ester salts, partially saponified products of styrene/maleic anhydride copolymer, partially saponified products of olefin/maleic anhydride copolymer, and naphthalenesulfonate formalin condensates.

The cationic surfactant for use in the present invention is not particularly limited and a conventionally known cationic surfactant can be used. Examples thereof include alkylamine salts, quaternary ammonium salts, polyoxyethylenealkylamine salts and polyethylene polyamine derivatives.

The amphoteric surfactant for use in the present invention is not particularly limited and a conventionally known amphoteric surfactant can be used. Examples thereof include carboxybetaines, aminocarboxylic acids, sulfobetaines, aminosulfuric esters and imidazolines.

The term “polyoxyethylene” in the above-described surfactants can be instead read as “polyoxyalkylene” such as polyoxymethylene, polyoxypropylene and polyoxybutylene, and these surfactants can also be used in the present invention.

The surfactant is more preferably a fluorine-containing surfactant containing a perfluoroalkyl group within the molecule. This fluorine-containing surfactant includes an anionic type such as perfluoroalkylcarboxylate, perfluoroalkylsulfonate and perfluoroalkylphosphoric ester; an amphoteric type such as perfluoroalkylbetaine; a cationic type such as perfluoroalkyltrimethylammonium salt; and a nonionic type such as perfluoroalkylamine oxide, perfluoroalkyl ethylene oxide adduct, oligomer containing a perfluoroalkyl group and a hydrophilic group, oligomer containing a perfluoroalkyl group and a lipophilic group, oligomer containing a perfluoroalkyl group, a hydrophilic group and a lipophilic group, and urethane containing a perfluoroalkyl group and a lipophilic group. In addition, fluorine-containing surfactants described in JP-A-62-170950, JP-A-62-226143 and JP-A-60-168144 may also be suitably used.

The surfactants can be used individually or in combination of two or more thereof.

The surfactant content is preferably from 0.001 to 10 mass %, more preferably from 0.01 to 7 mass %, based on the entire solid content of the photosensitive-thermosensitive layer.

<Polymerization Inhibitor>

In the photosensitive-thermosensitive layer of the present invention, a thermopolymerization inhibitor is preferably added in a small amount so as to prevent the radical polymerizable compound (C) from undergoing unnecessary thermopolymerization during the preparation or storage of the photosensitive-thermosensitive layer.

Suitable examples of the thermopolymerization inhibitor include hydroquinone, p-methoxyphenol, di-tert-butyl-p-cresol, pyrogallol, tert-butyl catechol, benzoquinone, 4,4′-thiobis(3-methyl-6-tert-butylphenol), 2,2′-methylenebis(4-methyl-6-tert-butylphenol) and N-nitroso-N-phenylhydroxylamine aluminum salt.

The amount added of the thermopolymerization inhibitor is preferably from about 0.01 to about 5 mass % based on the entire solid content of the photosensitive-thermosensitive layer.

<Higher Fatty Acid Derivative, Etc.>

In the photosensitive-thermosensitive layer of the present invention, a higher fatty acid derivative such as behenic acid or behenic acid amide may be added to localize on the surface of the photosensitive-thermosensitive layer during drying after coating so as to prevent polymerization inhibition by oxygen. The amount added of the higher fatty acid derivative is preferably from about 0.1 to about 10 mass % based on the entire solid content of the photosensitive-thermosensitive layer.

<Plasticizer>

The photosensitive-thermosensitive layer of the present invention may contain a plasticizer for enhancing the on-press developability.

Suitable examples of the plasticizer include phthalate acid esters such as dimethyl phthalate, diethyl phthalate, dibutyl phthalate, diisobutyl phthalate, diocyl phthalate, octyl capryl phthalate, dicyclohexyl phthalate, ditridecyl phthalate, butyl benzyl phthalate, diisodecyl phthalate and diallyl phthalate; glycol esters such as dimethyl glycol phthalate, ethyl phthalylethyl glycolate, methyl phthalylethyl glycolate, butyl phthalylbutyl glycolate and triethylene glycol dicaprylic acid ester; phosphoric acid esters such as tricresyl phosphate and triphenyl phosphate; aliphatic dibasic acid esters such as diisobutyl adipate, dioctyl adipate, dimethyl sebacate, dibutyl sebacate, dioctyl azelate and dibutyl maleate; polyglycidyl methacrylate, triethyl citrate, glycerin triacetyl ester and butyl laurate.

The plasticizer content is preferably about 30 mass % or less based on the entire solid content of the photosensitive-thermosensitive layer.

<Inorganic Fine Particle>

The photosensitive-thermosensitive layer of the present invention may contain an inorganic fine particle so as to improve the cured film strength of the image area and enhance the on-press developability of the non-image area.

Suitable examples of the inorganic fine particle include silica, alumina, magnesium oxide, titanium oxide, magnesium carbonate, calcium alginate and a mixture thereof These can be used, even if not having light-to-heat converting property, for example, to increase the film strength or strengthen the interface adhesion by the surface roughening. The average particle size of the inorganic fine particle is preferably from 5 nm to 10 μm, more preferably from 0.5 to 3 μm. Within this range, the inorganic particles are stably dispersed in the photosensitive-thermosensitive layer to maintain sufficiently high film strength of the photosensitive-thermosensitive layer and allow for formation of a non-image area with excellent hydrophilicity, which is less scummed at printing.

Such an inorganic fine particle is easily available on the market as a colloidal silica dispersion or the like.

The inorganic fine particle content is preferably 20 mass % or less, more preferably 10 mass % or less, based on the entire solid content of the photosensitive-thermosensitive layer.

<Low-Molecular Hydrophilic Compound>

The photosensitive-thermosensitive layer of the present invention may contain a hydrophilic low-molecular compound so as to enhance the on-press developability. Examples of the hydrophilic low-molecular compound include, as the water-soluble organic compound, glycols and ether or ester derivatives thereof, such as ethylene glycol, diethylene glycol, triethylene glycol, propylene glycol, dipropylene glycol and tripropylene glycol; polyhydroxys such as glycerin and pentaerythritol; organic amines and salts thereof, such as triethanolamine diethanolamine and monoethanolamine; organic sulfonic acids and salts thereof, such as toluenesulfonic acid and benzenesulfonic acid; organic phosphonic acids and salts thereof, such as phenylphosphonic acid; and organic carboxylic acids and salts thereof, such as tartaric acid, oxalic acid, citric acid, malic acid, lactic acid, gluconic acid and amino acids.

<Formation of Radical Polymerization-Type Photosensitive-Thermosensitive Layer>

As for the method of incorporating the above-described photosensitive-thermosensitive layer constituent components into the photosensitive-thermosensitive layer, several embodiments can be used in the present invention. One is an embodiment of dissolving the constituent components in an appropriate solvent and coating the obtained solution as described, for example, in JP-A-2002-287334, and another is an embodiment of enclosing the photosensitive-thermosensitive constituent components in a microcapsule and incorporating the microcapsule into the photosensitive-thermosensitive layer (microcapsule-type photosensitive-thermosensitive layer) as described, for example, in JP-A-2001-277740 and JP-A-2001-277742. In the microcapsule-type photosensitive-thermosensitive layer, the constituent components may be incorporated also outside the microcapsule. In a preferred embodiment of the microcapsule-type photosensitive-thermosensitive layer, hydrophobic constituent components are encapsulated in a microcapsule and hydrophilic constituent components are incorporated outside the microcapsule.

For microencapsulating those constituent components of the photosensitive-thermosensitive layer, conventionally known methods can be used. Examples of the method for producing a microcapsule include, but are not limited to, a method utilizing coacervation described in U.S. Pat. Nos. 2,800,457 and 2,800,458, a method utilizing interfacial polymerization described in U.S. Pat. No. 3,287,154, JP-B-38-19574 and JP-B-42-446, a method utilizing polymer precipitation described in U.S. Pat. Nos. 3,418,250 and 3,660,304, a method using an isocyanate polyol wall material described in U.S. Pat. No. 3,796,669, a method using an isocyanate wall material described in U.S. Pat. No. 3,914,511, a method using a urea-formaldehyde or urea-formaldehyde-resorcinol wall material described in U.S. Pat. Nos. 4,001,140, 4,087,376 and 4,089,802, a method using a wall material such as melamine-formaldehyde resin or hydroxy cellulose described in U.S. Pat. No. 4,025,445, an in situ method utilizing monomer polymerization described in JP-B-36-9163 and JP-A-51-9079, a spray drying method described in British Patent 930,422 and U.S. Pat. No. 3,111,407, and an electrolytic dispersion cooling method described in British Patents 952,807 and 967,074.

The microcapsule wall for use in the present invention preferably has a three-dimensionally crosslinked structure and has a property of swelling with a solvent. From this standpoint, the wall material of microcapsule is preferably polyurea, polyurethane, polyester, polycarbonate, polyamide or a mixture thereof, more preferably polyurea or polyurethane. Also, the above-described compound having a crosslinkable functional group such as ethylenically unsaturated bond, which can be introduced into the binder polymer, may be introduced into the microcapsule wall.

The average particle size of the microcapsule is preferably from 0.01 to 3.0 μm, more preferably from 0.05 to 2.0 μm, still more preferably from 0.10 to 1.0 μm. Within this range, good resolution and good aging stability can be obtained.

The photosensitive-thermosensitive layer of the present invention is formed by dispersing or dissolving the above-described necessary components in a solvent to prepare a coating solution and coating the obtained coating solution. Examples of the solvent used here include, but are not limited to, ethylene dichloride, cyclohexanone, methyl ethyl ketone, methanol, ethanol, propanol, ethylene glycol monomethyl ether, 1-methoxy-2-propanol, 2-methoxyethylacetate, 1-methoxy-2-propylacetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, toluene and water. These solvents are used individually or in combination. The concentration of the solid contents in the coating solution is preferably from 1 to 50 mass %.

The photosensitive-thermosensitive layer of the present invention may also be formed by dispersing or dissolving the same or different components described above in the same or different solvents to prepare a plurality of coating solutions and repeating the coating and drying multiple times.

The amount (solid content) coated of the photosensitive-thermosensitive layer obtained on the support after the coating and drying varies depending on the use but, in general, is preferably from 0.3 to 3.0 g/m². Within this range, good sensitivity and good film properties of the photosensitive-thermosensitive layer can be obtained.

For the coating, various methods may be used and examples thereof include bar coater coating, rotary coating, spray coating, curtain coating, dip coating, air knife coating, blade coating and roll coating.

(B) Hydrophobization Precursor-Type Image-Forming Element

<Hydrophobization Precursor>

The hydrophobization precursor used in the present invention is a fine particle capable of converting the hydrophilic photosensitive-thermosensitive layer into a hydrophobic layer when heat is applied. This fine particle is preferably at least one fine particle selected from a thermoplastic polymer fine particle and a thermal reactive polymer fine particle. The fine particle may also be a microcapsule enclosing a compound having a thermal reactive group.

Suitable examples of the thermoplastic polymer fine particle for use in the photosensitive-thermosensitive layer of the present invention include the thermoplastic polymer fine particles described in Research Disclosure, No. 33303 (January, 1992), JP-A-9-123387, JP-A-9-131850, JP-A-9-171249, JP-A-9-171250 and European Patent 931,647. Specific examples of the polymer constituting the polymer fine particle include homopolymers or copolymers of a monomer such as ethylene, styrene, vinyl chloride, methyl acrylate, ethyl acrylate, methyl methacrylate, ethyl methacrylate, vinylidene chloride, acrylonitrile and vinyl carbazole, and a mixture thereof. Among these, preferred are polystyrene and polymethyl methacrylate.

The average particle size of the thermoplastic polymer fine particle for use in the present invention is preferably from 0.01 to 2.0 μm. Examples of the method for synthesizing such a thermoplastic polymer fine particle include an emulsion polymerization method, a suspension polymerization method, a method of dissolving the compound in a water-insoluble organic solvent, mixing and emulsifying the obtained solution with an aqueous solution containing a dispersant, and solidifying the emulsification product into fine particles while dissipating the organic solvent under heat (dissolution dispersion method).

Examples of the thermal reactive polymer fine particle for use in the present invention includes a thermosetting polymer fine particle and a polymer fine particle having a thermal reactive group.

Examples of the thermosetting polymer include resins having a phenol skeleton, urea-based resins (for example, a resin obtained by resinifying urea or a urea derivative such as methoxymethylated urea with an aldehyde such as formaldehyde), melamine-based resins (for example, a resin obtained by resinifying melamine or a derivative thereof with an aldehyde such as formaldehyde), alkyd resin, unsaturated polyester resin, polyurethane resin and epoxy resin. Among these, preferred are resins having a phenol skeleton, melamine resin, urea resin and epoxy resin.

Suitable examples of the resin having a phenol skeleton include phenol, phenol resin obtained by resinifying cresol or the like with an aldehyde such as formaldehyde, hydroxystyrene resin, and methacrylamide or acrylamide polymer or copolymer or methacrylate or acrylate polymer or copolymer having a phenol skeleton, such as N-(p-hydroxyphenyl)methacrylamide and p-hydroxyphenyl methacrylate.

The average particle size of the thermosetting polymer fine particle for use in the present invention is preferably from 0.01 to 2.0 μm. Such a thermosetting polymer fine particle can be easily obtained by the dissolution dispersion method, but the thermosetting polymer may be formed into fine particles at its synthesis. However, the present invention is not limited to these methods.

The thermal reactive group of the polymer fine particle having a thermal reactive group for use in the present invention may be a functional group of undergoing any reaction as long as chemical bonding is formed, but examples thereof include an ethylenically unsaturated group of undergoing a radical polymerization reaction (such as acryloyl group, methacryloyl group, vinyl group and allyl group), a cationic polymerizable group (e.g., vinyl group, vinyloxy group), a functional group of undergoing an addition reaction, having an isocyanate group or its block form, an epoxy group or a vinyloxy group and an active hydrogen atom as the other party of the reaction (such as amino group, hydroxyl group and carboxyl group), a carboxyl group of undergoing a condensation reaction and a hydroxyl or amino group as the other party of the reaction, and an acid anhydride of undergoing a ring-opening addition reaction and an amino or hydroxyl group as the other party of the reaction.

Such a functional group may be introduced into the polymer fine particle at the polymerization or may be introduced utilizing a polymer reaction after the polymerization.

In the case of introducing the functional group at the polymerization, a monomer having the functional group is preferably emulsion polymerized or suspension polymerized. Specific examples of the monomer having the functional group include, but are not limited to, allyl methacrylate, allyl acrylate, vinyl methacrylate, vinyl acrylate, 2-(vinyloxy)ethyl methacrylate, p-vinyloxystyrene, p-{2-(vinyloxy)ethyl}styrene, glycidyl methacrylate, glycidyl acrylate, 2-isocyanatoethyl methacrylate or its block isocyanate with an alcohol or the like, 2-isocyanatoethyl acrylate or its block isocyanate with an alcohol or the like, 2-aminoethyl methacrylate, 2-aminoethyl acrylate, 2-hydroxyethyl methacrylate, 2-hydroxyethyl acrylate, acrylic acid, methacrylic acid, maleic anhydride, bifunctional acrylate and bifunctional methacrylate.

In the present invention, a copolymer of such a monomer and a monomer having no thermal reactive group, which is copolymerizable with such a monomer, may also be used. Examples of the monomer having no thermal reactive group include styrene, alkyl acrylate, alkyl methacrylate, acrylonitrile and vinyl acetate, but as long as it is a monomer having no thermal reactive group, the monomer is not limited thereto.

Examples of the polymer reaction used in the case of introducing the thermal reactive group after the polymerization include the polymer reaction described in International Publication WO96/34316, pamphlet.

Among the above-described polymer fine particles having a thermal reactive group, preferred are those of undergoing coalescence of polymer fine particles with each other under heat, more preferred are those having a hydrophilic surface and dispersible in water. The film formed by coating only the polymer fine particle and drying it at a temperature lower than the coagulation temperature preferably has a contact angle (aerial water droplet) lower than the contact angle (aerial water droplet) of a film formed by drying the polymer fine particle at a temperature higher than the coagulation temperature. The polymer fine particle surface can be made hydrophilic as above by adsorbing a hydrophilic polymer such as polyvinyl alcohol or polyethylene glycol, or an oligomer or hydrophilic low-molecular compound to the polymer fine particle surface, but the surface-hydrophilization method is not limited thereto.

The coagulation temperature of the polymer fine particle having a thermal reactive group is preferably 70° C. or more in view of aging stability, more preferably 100° C. or more. The average particle size of the polymer fine particle is preferably from 0.01 to 2.0 μm, more preferably from 0.05 to 2.0 μm, and most preferably from 0.1 to 1.0 μm. Within this range, good resolution and good aging stability can be obtained.

Suitable examples of the thermal reactive group in the microcapsule enclosing a compound having a thermal reactive group for use in the present invention include the same thermal reactive groups as used in the above-described polymer fine particle having a thermal reactive group. The compound having a thermal reactive group is described below.

As for the compound having a radical polymerizable unsaturated group, the same compounds as those described for the radical polymerization-type microcapsule can be suitably used.

Suitable examples of the compound having a vinyloxy group for use in the present invention include compounds described in JP-A-2002-029162. Specific examples thereof include, but are not limited to, tetramethylene glycol divinyl ether, trimethylolpropane trivinyl ether, tetraethylene glycol divinyl ether, pentaerythritol divinyl ether, pentaerythritol trivinyl ether, pentaerythritol tetravinyl ether, 1,4-bis{2-(vinyloxy)ethyloxy}benzene, 1,2-bis{2-(vinyloxy)ethyloxy}benzene, 1,3-bis{2-(vinyloxy)ethyloxy)benzene, 1,3,5-tris{2-(vinyloxy)ethyloxy}benzene, 4,4′-bis{2-(vinyloxy)ethyloxy}biphenyl, 4,4′-bis{2-(vinyloxy)ethyloxy}diphenylether, 4,4′-bis(2-(vinyloxy)ethyloxy}diphenylmethane, 1,4-bis{2-(vinyloxy)ethyloxy}-naphthalene, 2,5-bis{2-(vinyloxy)ethyloxy}furan, 2,5-bis{2-(vinyloxy)ethyloxy}thiophene, 2,5-bis{2-(vinyloxy)-ethyloxy}imidazole, 2,2-bis[4-{2-(vinyloxy)ethyloxy}phenyl]propane {bis(vinyloxyethyl)ether of bisphenol A}, 2,2-bis{4-(vinyloxymethyloxy)phenyl}propane and 2,2-bis{4-(vinyloxy)phenyl}propane.

The compound having an epoxy group suitably used in the present invention is preferably a compound having two or more epoxy groups and examples thereof include glycidyl ether compounds and prepolymers thereof, obtained by a reaction of polyhydric alcohol or polyvalent phenol with epichlorohydrin, and polymers and copolymers of glycidyl acrylate or glycidyl methacrylate.

Specific examples thereof include propylene glycol diglycidyl ether, tripropylene glycol diglycidyl ether, polypropylene glycol diglycidyl ether, neopentyl glycol diglycidyl ether, trimethylolpropane triglycidyl ether, diglycidyl ether of hydrogenated bisphenol A, hydroquinone diglycidyl ether, resorcinol diglycidyl ether, diglycidyl ether or epichlorohydrin adduct of bisphenol A, diglycidyl ether or epichlorohydrin adduct of bisphenol F, diglycidyl ether or epichlorohydrin adduct of halogenated bisphenol A, diglycidyl ether or epichlorohydrin adduct of biphenyl-type bisphenol, glycidyl etherified product of novolak resin, methyl methacrylate/glycidyl methacrylate copolymer, and ethyl methacrylate/glycidyl methacrylate copolymer.

Examples of the commercially available product of this compound include Epikote 1001 (molecular weight: about 900, epoxy equivalent: from 450 to 500), Epikote 1002 (molecular weight: about 1,600, epoxy equivalent: from 600 to 700), Epikote 1004 (molecular weight: about 1,060, epoxy equivalent: from 875 to 975), Epikote 1007 (molecular weight: about 2,900, epoxy equivalent: 2,000), Epikote 1009 (molecular weight: about 3,750, epoxy equivalent: 3,000), Epikote 1010 (molecular weight: about 5,500, epoxy equivalent: 4,000), Epikote 1100L (epoxy equivalent: 4,000), Epikote YX31575 (epoxy equivalent: 1,200) (all produced by Japan Epoxy Resin), Sumiepoxy ESCN-195XHN, ESCN-195XL and ESCN-195XF (produced by Sumitomo Chemical Co., Ltd.).

Suitable examples of the isocyanate compound for use in the present invention include tolylene diisocyanate, diphenylmethane diisocyanate, polymethylene polyphenyl polyisocyanate, xylylene diisocyanate, naphthalene diisocyanate, cyclohexanephenylene diisocyanate, isophorone diisocyanate, hexamethylene diisocyanate, cyclohexyl diisocyanate, and compounds resulting from blocking these isocyanate compounds with an alcohol or an amine.

Suitable examples of the amine compound for use in the present invention include ethylenediamine, diethylenetriamine, triethylenetetramine, hexamethylenediamine, propylenediamine and polyethyleneimine.

Suitable examples of the compound having a hydroxy group for use in the present invention include compounds having a terminal methylol group, polyhydric alcohols such as pentaerythritol, and bisphenol.polyphenols.

Suitable examples of the compound having a carboxy group for use in the present invention include aromatic polyvalent carboxylic acids such as pyromellitic acid, trimellitic acid and phthalic acid, and aliphatic polyvalent carboxylic acids such as adipic acid. Suitable examples of the acid anhydride for use in the present invention include pyromellitic anhydride and benzophenonetetracarboxylic anhydride.

The microencapsulation of the compound having a thermal reactive group can be performed by the known method described above in regard of the radical polymerization type.

<Other Components of Photosensitive-Thermosensitive Layer>

The photosensitive-thermosensitive layer of the present invention may contain a hydrophilic resin so as to enhance the on-press developing property and the film strength of the photosensitive-thermosensitive layer itself. The hydrophilic resin is preferably a resin having a hydrophilic group such as hydroxyl group, amino group, carboxyl group, phosphoric acid group, sulfonic acid group and amido group. The hydrophilic resin is crosslinked by reacting with the thermal reactive group of the hydrophobization precursor, as a result, the image strength is elevated and the impression capacity is enhanced. Therefore, the hydrophilic resin preferably has a group which reacts with the thermal reactive group. For example, in the case where the hydrophobization precursor has a vinyloxy group or an epoxy group, hydrophilic resins having a hydroxyl group, a carboxyl group, a phosphoric acid group, a sulfonic acid group or the like are preferred. Among these, hydrophilic resins having hydroxyl group or a carboxyl group are more preferred.

Specific examples of the hydrophilic resin include gum arabic, casein, gelatin, starch derivatives, soybean glue, hydroxypropyl cellulose, methyl cellulose, carboxymethyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate having a hydrolysis degree of at least 60 mol %, preferably at least 80 mol %, polyvinyl formal, polyvinylpyrrolidone, homopolymers and copolymers of acrylamide, homopolymers and copolymers of methacrylamide, homopolymers and copolymers of N-methyloacrylamide, homopolymers and copolymers of 2-acrylamide-2-methyl-1-propanesulfonic acid, and homopolymers and copolymers of 2-methacryloyloxyethylphosphonic acid.

The amount of the hydrophilic resin added to the photosensitive-thermosensitive layer is preferably 20 mass % or less, more preferably 10 mass % or less.

The hydrophilic resin may be crosslinked to such a degree that the unexposed area can be on-press developed on a printing press. Examples of the crosslinking agent include aldehydes such as glyoxal, melamine formaldehyde resin and urea formaldehyde resin; methylol compounds such as N-methylolurea, N-methylolmelamine and methylolated polyamide resin; active vinyl compounds such as divinylsulfone and bis(β-hydroxyethylsulfonic acid); epoxy compounds such as epichlorohydrin, polyethylene glycol diglycidyl ether, polyamide, polyamine, epichlorohydrin adduct and polyamide epichlorohydrin resin; ester compounds such as monochloroacetic acid ester and thioglycolic acid ester; polycarboxylic acids such as polyacrylic acid and methyl vinyl ether/maleic acid copolymer; inorganic crosslinking agents such as boric acid, titanyl sulfate, Cu, Al, Sn, V and Cr salt; and modified polyamideimide resins. In addition, a crosslinking catalyst such as ammonium chloride, silane coupling agent and titanate coupling agent can be used in combination.

The photosensitive-thermosensitive layer of the present invention may contain a reaction accelerator of initiating or accelerating the reaction of the thermal reactive group. Suitable examples of the reaction accelerator include the photoacid generators and radical generators described above for the discoloration system, and the radical polymerization initiators described above for the polymerization system.

The reaction accelerators can be used in combination of two or more thereof. The addition of the reaction accelerator to the photosensitive-thermosensitive layer may be direct addition to the coating solution for the photosensitive-thermosensitive layer, or addition in the form of being contained in the polymer fine particle. The content of the reaction accelerator in the photosensitive-thermosensitive layer is preferably from 0.01 to 20 mass %, more preferably from 0.1 to 10 mass %, based on the entire solid content of the photosensitive-thermosensitive layer. Within this range, good reaction initiating or accelerating effect can be obtained without impairing the on-press developability.

In the case of the hydrophobization precursor-type photosensitive-thermosensitive layer of the present invention, a polyfunctional monomer may be added to the photosensitive-thermosensitive layer matrix so as to more enhance the impression capacity. Examples of the polyfunctional monomer include those described above as polymerizable compounds. Among these monomers, preferred are trimethylolpropane triacrylate and pentaerythritol triacrylate.

In addition, the hydrophobization precursor-type photosensitive-thermosensitive layer of the present invention may contain, if desired, additives such as surfactant, polymerization inhibitor, higher fatty acid derivative, plasticizer, inorganic fine particle and low-molecular hydrophilic compound which are described above in <Other Components of Photosensitive-Thermosensitive Layer>of the polymerization-type photosensitive-thermosensitive layer.

<Formation of Hydrophobization Precursor-Type Photosensitive-Thermosensitive Layer>

The hydrophobization precursor-type photosensitive-thermosensitive layer of the present invention is formed, similarly to the above-described radical polymerization-type photosensitive-thermosensitive layer, by dispersing or dissolving necessary components in a solvent to prepare a coating solution and drying it on a support.

The amount (solid content) coated of the photosensitive-thermosensitive layer obtained on the support after coating and drying varies depending on use but in general, is preferably from 0.5 to 5.0 g/m².

When the hydrophobization precursor-type photosensitive-thermosensitive layer is used, a on-press developable lithographic printing plate precursor can be produced.

On the other hand, when the hydrophobization precursor-type photosensitive-thermosensitive layer is formed as a “hydrophilic layer having a crosslinked structure” ensuring satisfactory impression capacity even when unexposed, the lithographic printing plate precursor of the present invention can be applied to the non-processing (non-development) type lithographic printing plate precursor.

It is a preferred embodiment that the hydrophilic layer having a crosslinked structure contains at lest one resin selected from a hydrophilic resin having formed therein a crosslinked structure and an inorganic hydrophilic binding resin formed by so-gel conversion. Of these, the hydrophilic resin is first described below. The addition of the hydrophilic resin is advantageous in that the affinity for hydrophilic components in the emulsion ink is enhanced and the film strength of the photosensitive-thermosensitive layer itself is elevated. Preferred examples of the hydrophilic resin include those having a hydrophilic group such as hydroxyl, carboxyl, hydroxyethyl, hydroxypropyl, amino, aminoethyl, aminopropyl and carboxymethyl.

Specific examples of the hydrophilic resin include gum arabic, casein, gelatin, starch derivatives, carboxymethyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a hydrolysis degree of at least 60 mol %, preferably at least 80 mol %, polyvinyl formal, polyvinyl butyral, polyvinylpyrrolidone, homopolymers and copolymers of acrylamide, homopolymers and polymers of methacrylamide, and homopolymers and copolymers of N-methylolacrylamide.

In the case of using this hydrophilic resin for the photosensitive-thermosensitive layer of the present invention, the hydrophilic resin may be used by crosslinking it. As for the crosslinking agent used for forming the crosslinking structure, those described above as the crosslinking agent can be used.

In another preferred embodiment, the non-processing (non-development) type photosensitive-thermosensitive layer contains an inorganic hydrophilic binding resin formed by so-gel conversion. The sol-gel conversion-type binding resin is suitably a polymer body where the bonding groups from polyvalent elements form a network structure via oxygen atoms, that is, a three-dimensional crosslinked structure, and at the same time, polyvalent metals also have non-bonded hydroxyl groups and alkoxyl groups which are present randomly to form a resinous structure. In a stage where many alkoxy groups and hydroxyl groups are present, a sol state is presented. As the dehydration condensation proceeds, the network resin structure is stiffened. The polyvalent bonding element of the compound having a hydroxyl group and an alkoxy group and undergoing sol-gel conversion is aluminum, silicon, titanium, zirconium or the like. These elements all can be used in the present invention. In particular, a sol-gel conversion system using silicon is preferred, and a system containing a silane compound capable of undergoing sol-gel conversion and having at least one silanol group is more preferred. The sol-gel conversion system using silicon is described below, but the sol-gel conversion system using aluminum, titanium or zirconium can be effected by replacing silicon described below with respective metals.

The sol-gel conversion-type binding resin is a resin preferably having a siloxane bond and a silanol group. When a coating solution as a sol system containing a compound having at least one silanol group is used, gelling occurs with the progress of condensation of the silanol group during coating and drying and a siloxane skeleton structure is formed. Through this process, the binding resin is incorporated into the photosensitive-thermosensitive layer of the present invention.

In the photosensitive-thermosensitive layer containing the sol-gel conversion-type binding resin, the above-described hydrophilic resin and crosslinking agent may be used in combination for the purpose of improving physical properties such as film strength and flexibility of film, or coating property.

The siloxane resin having a gel structure is represented by the following formula (VI), and the silane compound having at least one silanol group is represented by the following formula (VII). The substance system added to the photosensitive-thermosensitive layer is not necessarily the silane compound represented by formula (VII) alone but in general, may be an oligomer resulting from partial condensation of the silane compound or a mixture of the silane compound of formula (VII) and the oligomer.

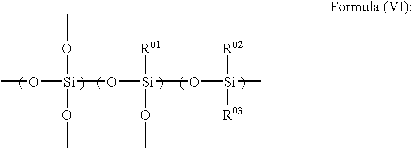

The siloxane resin represented by formula (VI) is formed by sol-gel conversion from a liquid dispersion containing at least one silane compound represented by formula (VII). In formula (VI), at least one of R⁰¹ to R⁰³ represents a hydroxyl group, and the remaining represents an organic residue selected from R⁰ and Y in formula (VII).

Formula (VII):
(R⁰)ₙSi(Y)₄₋ₙ
wherein R⁰ represents a hydroxyl group, a hydrocarbon group or a heterocyclic group, Y represents a hydrogen atom, a halogen atom, —OR¹, —OCOR² or —N(R³)(R⁴), R¹ and R² each represents a hydrocarbon group, R³ and R⁴ may be the same or different and each represents a hydrocarbon group or a hydrogen atom, and n represents 0, 1, 2 or 3.

The hydrocarbon group or heterocyclic group of R⁰ represents, for example, a linear or branched alkyl group having from 1 to 12 carbon atoms, which may be substituted (e.g., methyl, ethyl, propyl, butyl, pentyl, hexyl, heptyl, octyl, nonyl, decyl, dodecyl; examples of the group substituted to these groups include a halogen atom (e.g., chlorine, fluorine, bromine), a hydroxyl group, a thiol group, a carboxyl group, a sulfo group, a cyano group, an epoxy group, a —OR′ group (R′ represents a methyl group, an ethyl group, a propyl group, a butyl group, a heptyl group, a hexyl group, an octyl group, a decyl group, a propenyl group, a butenyl group, a hexenyl group, an octenyl group, a 2-hydroxyethyl group, a 3-chloropropyl group, a 2-cyanoethyl group, an N,N-dimethylaminoethyl group, a 2-bromoethyl group, a 2-(2-methoxyethyl)oxyethyl group, a 2-methoxycarbonylethyl group, a 3-carboxyethyl group, a 3-carboxypropyl group or a benzyl group), a —OCOR″ group (R″ has the same meaning as R′), a —COOR″ group, a —COR″ group, a —N(R′″)(R′″) group (R′″ represents a hydrogen atom or has the same meaning as R′, and R′″s may be the same or different), a —NHCONHR″ group, a —NHCOOR″ group, a —Si(R″)₃ group and a —CONHR″ group; a plurality of these substituents may be substituted in the alkyl group), a linear or branched alkenyl group having from 2 to 12 carbon atoms, which may be substituted (e.g., vinyl, propenyl, butenyl, pentenyl, hexenyl, octenyl, decenyl, dodecenyl; examples of the group substituted to these groups are the same as those of the group substituted to the alkyl group), an aralkyl group having from 7 to 14 carbon atoms, which may be substituted (e.g., benzyl, phenethyl, 3-phenylpropyl, naphthylmethyl, 2-naphthylethyl; examples of the group substituted to these groups are the same as those of the group substituted to the alkyl group; a plurality of these substituents may be substituted), an alicyclic group having from 5 to 10 carbon atoms, which may be substituted (e.g., cyclopentyl, cyclohexyl, 2-cyclohexylethyl, norbornyl, adamantyl; examples of the group substituted to these groups are the same as those of the group substituted to the alkyl group; a plurality of these substituents may be substituted), an aryl group having from 6 to 12 carbon atoms, which may be substituted (e.g., phenyl, naphthyl; examples of the substituent are the same as those of those of the group substituted to the alkyl group; a plurality of these substituents may be substituted), or a heterocyclic group containing at least one atom selected from a nitrogen atom, an oxygen atom and a sulfur atom, which may be condensed (e.g., pyran, furan, thiophene, morpholine, pyrrole, thiazole, oxazole, pyridine, piperidine, pyrrolidone, benzothiazole, benzoxazole, quinoline, tetrahydrofuran; these rings each may have a substituent and examples of the substituent are the same as those of the group substituted to the alkyl group; a plurality of substituents may be substituted).

The substituent in the —OR¹ group, —OCOR² group or —N(R³)(R⁴) group for Y of formula (VII) represents, for example, the following substituent. In the —OR¹ group, R¹ represents an aliphatic group having from 1 to 10 carbon atoms, which may be substituted [e.g., methyl, ethyl, propyl, butyl, heptyl, hexyl, pentyl, octyl, nonyl, decyl, propenyl, butenyl, heptenyl, hexenyl, octenyl, decenyl, 2-hydroxyethyl, 2-hydroxypropyl, 2-methoxyethyl, 2-(methoxyethyl)oxyethyl, 2-(N,N-diethylamino)ethyl, 2-methoxypropyl, 2-cyanoethyl, 3-methyloxypropyl, 2-chloroethyl, cyclohexyl, cyclopentyl, cyclooctyl, chlorocyclohexyl, methoxycyclohexyl, benzyl, phenethyl, dimethoxybenzyl, methylbenzyl, bromobenzyl].

In the —OCOR² group, R² represents an aliphatic group having the same meaning as R¹ or an aromatic group having from 6 to 12 carbon atoms, which may be substituted (examples of the aromatic group are the same as those described for the aryl group of R). In the —N(R³)(R⁴) group, R³ and R⁴ may be the same or different and each represents a hydrogen atom or an aliphatic group having from 1 to 10 carbon atoms, which may be substituted (examples of the aliphatic group are the same as those described for R¹ of the —OR¹ group). More preferably, the total number of carbon atoms in R³ and R⁴ is 16 or less. Specific examples of the silane compound represented by formula (VII) include, but not limited to, the following compounds:
tetrachlorosilane, tetramethoxysilane, tetraethoxysilane, tetraisopropoxysilane, tetra-n-propylsilane, methyl-trichlorosilane, methyltrimethoxysilane, methyltriethoxysilane, ethyltrichlorosilane, ethyltrimethoxysilane, ethyltrimethoxysilane, n-propyltrichlorosilane, n-propyltrimethoxysilane, n-hexyltrimethoxysilane, n-decyltrimethoxysilane, phenyltrichlorosilane, phenyltrimethoxysilane, dimethoxyditriethoxysilane, dimetlyldichlorosilane, dimethyldimethoxysilane, diphenyldimethoxysilane, phenylmethyldimethoxysilane, triethoxyhydrosilane, trimethoxyhydrosilane, vinyltrichlorosilane, vinyltrimethoxysilane, trifluoropropyltrimethoxysilane, γ-glycidoxypropylmethyldimethoxysilane, γ-glycidoxypropylmethyldiethoxysilane, γ-glycidoxypropyltriethoxysilane, γ-methacryloxypropyltrimethoxysilane, γ-aminopropylmethyldimethoxysilane, γ-aminopropyltriethoxysilane, γ-mercaptopropylmethyldimethoxysilane, γ-mercaptopropyltrimethoxysilane, γ-mercaptopropyltriethoxysilane and β-(3,4-epoxycyclohexyl)ethyltrimethoxysilane.

In the photosensitive-thermosensitive layer of the present invention, together with the silane compound of formula (VII), a metal compound capable of bonding to the resin on sol-gel conversion and forming a film, such as Ti, Zn, Sn, Zr and Al, can be used in combination. Examples of the metal compound used here include Ti(OR″)₄, TiCl₄, Zn(OR″)₂, Zn(CH₃COCHCOCH₃)₂, Sn(OR″)₄, Sn(CH₃COCHCOCH₃)₄, Sn(OCOR″)₄, SnCl₄, Zr(OR″)₄, Zr(CH₃COCHCOCH₃)₄, (NH₄)₂ZrO(CO₃)₂, Al(OR″)₃ and Al(CH₃COCHCOCH₃)₃, wherein R″ represents a methyl group, an ethyl group, a propyl group, a butyl group, a pentyl group or a hexyl group.

In order to accelerate the hydrolysis and polycondensation reaction of the compound represented by formula (VII) and the metal compound used in combination, an acidic catalyst or a basic catalyst is preferably used in combination. For the catalyst, an acidic or basic compound may be used as-is or may be used after dissolving it in water or a solvent such as alcohol (hereinafter this is referred to as an acidic catalyst or a basic catalyst). At this time, the concentration is not particularly limited but when the concentration is high, the hydrolysis and polycondensation reaction tend to proceed at a higher rate. However, if a basic catalyst in a high concentration is used, a precipitate may be produced in the sol solution. Therefore, the concentration of the basic catalyst is preferably 1N (concentration calculated in terms of an aqueous solution) or less.

Specific examples of the acidic catalyst include hydrogen halides such as hydrochloric acid, carboxylic acids such as nitric acid, sulfuric acid, sulfurous acid, hydrogen sulfide, perchloric acid, hydrogen peroxide, carbonic acid, formic acid and acetic acid, and sulfonic acids such as benzenesulfonic acid, and specific examples of the basic catalyst include ammoniacal bases such as aqueous ammonia, and amines such as ethylamine and aniline. However, the present invention is not limited thereto.

The photosensitive-thermosensitive layer produced by using the above-described sol-gel method is particularly preferred as the constitution of the photosensitive-thermosensitive layer according to the present invention. The sol-gel method is described in detail, for example, in Sumio Sakka, Sol-Gel Ho no Kagaku (Science of Sol-Gel Method), Agne Shofu-Sha (1988), and Seki Hirashima, Saishin Sol-Gel Ho niyoru Kinosei Usumaku Sakusei Gijutsu (Production Technique of Functional Thin Film by the Latest Sol-Gel Method), Sogo Gijutsu Center (1992).

The amount added of the hydrophilic resin in the photosensitive-thermosensitive layer having a crosslinked structure is preferably from 5 to 70 mass %, more preferably from 5 to 50 mass %, based on the solid content of the photosensitive-thermosensitive layer.

[Support]

The support for use in the lithographic printing plate precursor of the present invention is not particularly limited and may be sufficient if it is a dimensionally stable plate-like material. Examples thereof include paper, paper laminated with plastic (e.g., polyethylene, polypropylene, polystyrene), metal sheet (e.g., aluminum, zinc, copper), plastic film (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal), and paper or plastic film laminated with or having vapor-deposited thereon the above-described metal. Among these supports, polyester film and aluminum sheet are preferred, and aluminum sheet is more preferred because this is dimensionally stable and relatively inexpensive.

The aluminum sheet is a pure aluminum sheet, an alloy sheet mainly comprising aluminum and containing trace heteroelements, or an aluminum or aluminum alloy thin film laminated with a plastic. Examples of the heteroelement contained in the aluminum alloy include silicon, iron, manganese, copper, magnesium, chromium, zinc, bismuth, nickel and titanium. The heteroelement content in the alloy is preferably 10 mass % or less. In the present invention, a pure aluminum sheet is preferred, but completely pure aluminum is difficult to produce in view of refining technique and therefore, an aluminum sheet containing trace heteroelements may be used. The composition of the aluminum sheet is not particularly specified and conventionally known and commonly employed materials can be appropriately used.

The thickness of the support is preferably from 0.1 to 0.6 mm, more preferably from 0.15 to 0.4 mm, still more preferably from 0.2 to 0.3 mm.

In advance of using the aluminum sheet, the aluminum sheet is preferably subjected to a surface treatment such as surface roughening and formation of hydrophilic film. This surface treatment facilitates enhancing hydrophilicity and ensuring adhesion between the photosensitive-thermosensitive layer and the support. Prior to the surface-roughening of aluminum sheet, a degreasing treatment for removing the rolling oil on the surface is performed, if desired, by using a surfactant, an organic solvent, an alkaline aqueous solution or the like.

<Surface-Roughening Treatment>

The surface-roughening treatment of the aluminum sheet surface is performed by various methods and examples thereof include a mechanical surface-roughening treatment, an electrochemical surface-roughening treatment (surface-roughening treatment of electrochemically dissolving the surface) and a chemical surface-roughening treatment (a surface-roughening treatment of chemically and selectively dissolving the surface).

The mechanical surface-roughening treatment may be performed by using a known method such as ball polishing, brush polishing, blast polishing and buff polishing.

The method for the electrochemical surface-roughening treatment includes, for example, a method of passing an alternating or direct current in an electrolytic solution containing an acid such as hydrochloric acid or nitric acid. Also, a method using a mixed acid described in JP-A-54-63902 may be used.

<Formation of Hydrophilic Film>

The aluminum sheet subjected to the surface-roughening treatment and, if desired, to other treatments is then subjected to a treatment for providing a hydrophilic film having a low thermal conductivity. The thermal conductivity in the thickness direction of the hydrophilic film is 0.05 W/mK or more, preferably 0.08 W/mK or more, and 0.5 W/mK or less, preferably 0.3 W/mK or less, more preferably 0.2 W/mK or less. When the thermal conductivity in the film thickness direction is from 0.05 to 0.5 W/mK, the heat generated in the photosensitive-thermosensitive layer upon laser light exposure can be prevented from diffusing into the support. As a result, in the case of using the lithographic printing plate precursor of the present invention as an on-press development type or non-processing type, the heat generated upon laser exposure can be effectively used and the sensitivity is elevated, so that image formation and printout image formation can be satisfactorily attained.

The thermal conductivity in the thickness direction of the hydrophilic film as defined in the present invention is described below. As for the method of measuring thermal conductivity of thin film, various methods have been heretofore reported. In 1986, ONO et al. reported a thermal conductivity in the plane direction of thin film determined by using a thermograph. Also, attempts to apply an AC heating method to the measurement of thermal properties of thin film have been reported. The history of the AC heating method can be traced even to the report of 1863. In recent years, heating methods using a laser have been developed and various measuring methods utilizing combination with Fourier conversion have been proposed. In practice, devices using a laser angstrom method are commercially available. These methods all are to determine the thermal conductivity in the plane direction (in-plane direction) of thin film.

However, in considering the thermal conduction of thin film, the important factor is rather the thermal diffusion in the depth direction. As reported in various papers, the thermal conductivity is not isotropic and particularly, in cases as in the present invention, it is very important to directly measure the thermal conductivity in the film thickness direction. From such a standpoint, a method using a thermal comparator has been reported in the paper by Lambropoulos et al. (J. Appl. Phys., 66 (9) (November, 1989)) and the paper by Henager et al. (APPLIED OPTICS, Vol. 32, No. 1 (Jan. 1, 1993)) with an attempt to measure the thermal properties in the thickness direction of thin film. Furthermore, a method of measuring the thermal diffusivity of polymer thin film by temperature wave thermal analysis to which Fourier analysis is applied has been recently reported by Hashimoto et al. (Netsu Sokutei (Heat Measurement), 27 (3) (2000)).

The thermal conductivity in the thickness direction of hydrophilic film as defined in the present invention is measured by a method using the above-described thermal comparator. This method is specifically described below, but its fundamental principles are described in detail in the paper by Lambropoulos et al. and the paper by Henager et al. In the present invention, the thermal conductivity is measured by the method described in JP-A-2003-103951 using the thermal comparator shown in FIG. 3 of the same patent publication.

The relationship between each temperature and thermal conductivity of film can be expressed by the following formula (1):

$$[ Mathmatical Formula 1 ] \\ \frac{( {T}_{r} - {T}_{b} )}{( {T}_{r} - {T}_{t} )} = ( \frac{4 {K}_{1} {r}_{1}}{{K}_{tf} {A}_{3}} ) t + ( 1 + ( \frac{4 {K}_{1} {r}_{1}}{{K}_{2} {A}_{2}} ) {t}_{2} + ( \frac{{K}_{1} {r}_{1}}{{K}_{4} {r}_{1}} ) ) \qquad ( 1 )$$

wherein Tₜ: temperature at distal end of tip, T_{b}: heat sink temperature, K_{tf}: thermal conductivity of film, K₁: thermal conductivity of reserver, K₂: thermal conductivity of tip (in the case of oxygen-free copper, 400 W/mK), K₄: thermal conductivity of metal substrate (when film is not provided thereon), r₁: radius of curvature at distal end of tip, A₂: contact area between reserver and tip, A₃: contact area between tip and film, t: film thickness, and t₂: contact thickness (about 0).

By changing the film thickness (t) and measuring and plotting respective temperatures (Tₜ, T_{b} and Tᵣ), the gradient of formula (1) is determined, whereby the thermal conductivity of film (K_{tf}) can be determined. That is, as apparent from formula (1), this gradient is a value determined by the thermal conductivity of reserver (K₁), the radius of curvature at distal end of tip (r₁), the thermal conductivity of film (K_{tf}) and the contact area between tip and film (A₃) and since K₁, r₁ and A₃ are known values, the value of K_{tf} can be determined from the gradient.

The present inventors determined the thermal conductivity of a hydrophilic film (anodic oxide film Al₂O₃) provided on an aluminum substrate by using the above-described measuring method. The temperatures were measured by changing the film thickness, as a result, the thermal conductivity of Al₂O₃ determined from the gradient of graph was 0.69 W/mK. This reveals good agreement with the results in the paper by Lambropoulos et al. This result also reveals that the thermal physical values of thin film differ from the thermal physical values of bulk (the thermal conductivity of bulk Al₂O₃ is 28 W/mK).

When the above-described method is used for the measurement of the thermal conductivity in the thickness direction of the hydrophilic film on the lithographic printing plate precursor of the present invention, by using a tip with fine distal end and keeping constant the pressing load, non-fluctuated results can be obtained even on the surface roughened for use as a lithographic printing plate and therefore, this use is preferred. The thermal conductivity is preferably determined as an average value by measuring the thermal conductivity at different multiple points on a sample, for example, at 5 points.

The thickness of the hydrophilic film is, in view of less scratchability and printing press, preferably 0.1 μm or more, more preferably 0.3 μm or more, still more preferably 0.6 μm or more. Also, from the standpoint of production cost, since a large energy is necessary for providing a thick film, the film thickness is preferably 5 μm or less, more preferably 3 μm or less, still more preferably 2 μm or less.

On taking account of effect on heat insulation and in view of film strength and less scumming at printing, the hydrophilic film of the present invention preferably has a density of 1,000 to 3,200 kg/m³.

As for the method of measuring the density, for example, from the mass measured by Mason's method (anodic oxide film mass method by dissolution in a chromic acid/phosphoric acid mixed solution) and the film thickness determined by observing the cross section through SEM, the density can be calculated according to the following formula:
Density (kg/m³)=(mass of hydrophilic film per unit area/film thickness)

The method for providing the hydrophilic film is not particularly limited and, for example, anodization, vapor deposition, CVD, sol-gel method, sputtering, ion plating or diffusion method can be appropriately used. Also, a method of coating a solution obtained by mixing hollow particles in the hydrophilic resin or sol-gel solution can be used.

Among these, a treatment of producing an oxide by anodization, that is, an anodization treatment, is most preferred. The anodization treatment can be performed by a method conventionally employed in this field. Specifically, when DC or AC is passed to an aluminum sheet in an aqueous or nonaqueous solution comprising a sulfuric acid, a phosphoric acid, a chromic acid, an oxalic acid, a sulfamic acid, a benzenesulfonic acid or the like individually or in combination of two or more thereof, an anodic oxide film which is a hydrophilic film is formed on the surface of the aluminum sheet. The conditions for the anodization treatment vary according to the electrolytic solution used and cannot be indiscriminately determined, but in general, suitable conditions are such that the electrolytic solution concentration is from 1 to 80 mass %, the liquid temperature is from 5 to 70° C., the current density is from 0.5 to 60 A/dm², the voltage is from 1 to 200 V and the electrolysis time is from 1 to 1,000 seconds. Among such anodization treatments, preferred are a method of performing the anodization treatment in a sulfuric acid electrolytic solution at a high current density described in British Patent 1,412,768 and a method of performing the anodization treatment by using a phosphoric acid as the electrolytic bath described in U.S. Pat. No. 3,511,661. Also, a multistage anodization treatment of, for example, performing the anodization treatment in a sulfuric acid and further in a phosphoric acid may be employed.

In the present invention, in view of less scratchability and press life, the coverage of the anodic oxide film is preferably 0.1 g/m² or more, more preferably 0.3 g/m² or more, still more preferably 2 g/m² or more, yet still more preferably 3.2 g/m² or more, and since a large energy is necessary for providing a thick film, preferably 100 g/m² or less, more preferably 40 g/m² or less, still more preferably 20 g/m² or less.

On the surface of the anodic oxide film, fine recesses called a micropore are formed and evenly distributed. The density of micropores present in the anodic oxide film can be adjusted by appropriately selecting the treatment conditions. By elevating the density of micropores, the thermal conductivity in the thickness direction of the anodic oxide film can be made to 0.05 to 0.5 W/mK. The micropore size can also be adjusted by appropriately selecting the treatment conditions. By enlarging the micropore size, the thermal conductivity in the thickness direction of the anodic oxide film can be made to 0.05 to 0.5 W/mK. The micropore size can also be adjusted by appropriately selecting the treatment conditions. By enlarging the micropore size, the thermal conductivity in the thickness direction of the anodic oxide film can be made to 0.05 to 0.5 W/mK.

In the present invention, for the purpose of decreasing the thermal conductivity, a pore wide treatment of enlarging the pore size of micropores is preferably performed after the anodization treatment. In this pore wide treatment, the aluminum substrate having formed thereon the anodic oxide film is dipped in an aqueous acid solution or an aqueous alkali solution, as a result, the anodic oxide film is dissolved and the pore size of micropores is enlarged. The pore wide treatment is preferably performed to dissolve the anodic oxide film in an amount of 0.1 to 20 g/m², more preferably from 0.1 to 5 g/m², still more preferably from 0.2 to 4 g/m².

In the case of using an aqueous acid solution for the pore wide treatment, an aqueous solution of an inorganic acid such as sulfuric acid, phosphoric acid, nitric acid or hydrochloric acid, or a mixture thereof is preferably used. The concentration of the aqueous acid solution is preferably from 10 to 1,000 g/L, more preferably from 20 to 500 g/L. The temperature of the aqueous acid solution is preferably from 10 to 90° C., more preferably from 30 to 70° C., and the dipping time in the aqueous acid solution is preferably from 1 to 300 seconds, more preferably from 2 to 100 seconds. On the other hand, in the case of using an aqueous alkali solution for the pore wide treatment, an aqueous solution of at least one alkali selected from the group consisting of sodium hydroxide, potassium hydroxide and lithium hydroxide is preferably used. The pH of the aqueous alkali solution is preferably from 10 to 13, more preferably from 11.5 to 13.0. The temperature of the aqueous alkali solution is preferably from 10 to 90° C., more preferably from 30 to 50° C., and the dipping time in the aqueous alkali solution is preferably from 1 to 500 seconds, more preferably from 2 to 100 seconds. However, if the micropore size on the outermost surface is excessively enlarged, the antiscumming performance at printing deteriorates. The micropore size on the outermost surface is preferably to 40 nm or less, more preferably 20 nm or less, and most preferably 10 nm or less. Therefore, for ensuring both heat insulation and antiscumming performance, the anodic oxide film more preferably has a profile such that the surface micropore size is from 0 to 40 nm and the inner micropore size is from 20 to 300 nm. For example, when the electrolytic solution is the same kind, it is known that the pore size of pores produced by electrolysis is proportional to the electrolytic voltage at electrolysis. By utilizing this property, a method of gradually elevating the electrolytic voltage and thereby producing pores enlarged in the bottom portion can be used. It is also known that when the kind of the electrolytic solution is changed, the pore size changes. The pore size is larger in the order of sulfuric acid, oxalic acid and phosphoric acid. Accordingly, a method of performing anodization by using a sulfuric acid for the electrolytic solution in the first stage and using a phosphoric acid in the second stage can be used. The lithographic printing plate support obtained through anodization treatment and/or pore wide treatment may also be subjected to a pore-sealing treatment described later.

Other than the above-described anodic oxide film, the hydrophilic film may be an inorganic film provided by sputtering, CVD or the like. Examples of the compound constituting the inorganic film include an oxide, a nitride, a silicide, a boride and a carbide. The inorganic film may comprise only a single compound or may comprise a mixture of compounds. Specific examples of the compound constituting the inorganic film include aluminum oxide, silicon oxide, titanium oxide, zirconium oxide, hafnium oxide, vanadium oxide, niobium oxide, tantalum oxide, molybdenum oxide, tungsten oxide, chromium oxide; aluminum nitride, silicon nitride, titanium nitride, zirconium nitride, hafnium nitride, vanadium nitride, niobium nitride, tantalum nitride, molybdenum nitride, tungsten nitride, chromium nitride, silicon nitride, boron nitride; titanium silicide, zirconium silicide, hafnium silicide, vanadium silicide, niobium silicide, tantalum silicide, molybdenum silicide, tungsten suicide, chromium silicide; titanium boride, zirconium boride, hafnium boride, vanadium boride, niobium boride, tantalum boride, molybdenum boride, tungsten boride, chromium boride; aluminum carbide, silicon carbide, titanium carbide, zirconium carbide, hafnium carbide, vanadium carbide, niobium carbide, tantalum carbide, molybdenum carbide, tungsten carbide, and chromium carbide.

<Pore-Sealing Treatment>

In the present invention, as described above, the support for the lithographic printing plate of the present invention obtained by providing a hydrophilic layer may be subjected to a pore-sealing treatment. Examples of the pore-sealing treatment for use in the present invention include a pore-sealing treatment of an anodic oxide film by steam under pressure or hot water described in JP-A-4-176690 and JP-A-11-301135. Also, this treatment may be performed by using a known method such as silicate treatment, aqueous bichromate solution treatment, nitrite treatment, ammonium acetate salt treatment, electrodeposition pore-sealing treatment, triethanolamine treatment, barium carbonate treatment, or treatment with hot water containing a very slight amount of phosphate. For example, when electrodeposition pore-sealing treatment is applied, the pore-sealed film is formed from the bottom of a pore, and when steam pore-sealing treatment is applied, the pore-sealed film is formed from the top of a pore. Depending on the pore-sealing treatment, the manner of forming the pore-sealed film differs. Other examples of the treatment include dipping in a solution, spraying, coating, vapor deposition, sputtering, ion plating, flame spray coating and plating, but the treating method is not particularly limited. In particular, a pore-sealing treatment using particles having an average particle size of 8 to 800 nm described in JP-A-2002-214764 is preferred.

The pore-sealing treatment using particles is performed by using particles having an average particle size of 8 to 800 nm, preferably from 10 to 500 nm, more preferably from 10 to 150 nm. Within this range, the particles can be hardly fitted into the inside of a micropore present in the hydrophilic film and sufficiently high effect of elevating the sensitivity, good adhesion to the photosensitive-thermosensitive layer and excellent press life are ensured. The thickness of the particle layer is preferably from 8 to 800 nm, more preferably from 10 to 500 nm.

The particle for use in the present invention preferably has a thermal conductivity of 60 W/mK or less, more preferably 40 W/mK or less, still more preferably from 0.3 to 10 W/mK. When the thermal conductivity is 60 W/mK or less, the diffusion of heat into the aluminum substrate can be satisfactorily prevented and a sufficiently high effect of elevating the sensitivity is obtained.

Examples of the method for providing the particle layer include, but are not limited to, dipping in a solution, spraying, coating, electrolysis, vapor deposition, sputtering, ion plating, flame spray coating and plating.

In the electrolysis, DC or AC can be used. Examples of the waveform of the AC for use in the electrolysis include sine wave, rectangular wave, triangular wave and trapezoidal wave. In view of the cost for producing a power source device, the frequency of the AC is preferably from 30 to 200 Hz, more preferably from 40 to 120 Hz. In the case of using a trapezoidal wave as the waveform of AC, the time tp for each current to reach the peak from 0 is preferably 0.1 to 2 msec, more preferably from 0.3 to 1.5 msec. If the tp is less than 0.1 msec, this may affect the impedance of the power source circuit to require a large power source voltage at the rising of current waveform and in turn, a high equipment cost for the power source.

As for the hydrophilic particle, Al₂O₃, TiO₂, SiO₂ and ZrO₂ are preferably used individually or in combination of two or more thereof. The electrolytic solution is obtained, for example, by suspending the hydrophilic particles in water or the like such that the hydrophilic particle content becomes from 0.01 to 20 mass % based on the entire. The electrolytic solution may be subjected to adjustment of pH, for example, by adding a sulfuric acid so as to have plus or minus electric charge. The electrolysis is preformed, for example, by passing DC, assigning the aluminum sheet to the cathode and using the above-described electrolytic solution under the conditions such that the voltage is from 10 to 200 V and the treatment time is from 1 to 600 seconds. By this method, the micropore present in the anodic oxide film can be easily closed while leaving a void in its inside.

Also, the pore-sealing treatment may be performed by a method of providing by coating, for example, a layer comprising a compound having at least one amino group and at least one group selected from the group consisting of a carboxyl group or a salt thereof and a sulfo group or a salt thereof described in JP-A-60-19491; a layer comprising a compound selected from compounds having at least one amino group and at least one hydroxyl group, and salts thereof described in JP-A-60-232998; a layer containing a phosphate described in JP-A-62-19494; or a layer comprising a polymer compound containing at least one monomer unit having a sulfo group, as a repeating unit in the molecule described in JP-A-59-101651.

In addition, the pore-sealing treatment may be performed by a method of providing a layer comprising a compound selected from carboxymethyl cellulose; dextrin; gum arabic; phosphonic acids having an amino group, such as 2-aminoethylphosphonic acid; organic phosphonic acids such as phenylphosphonic acid, naphthylphosphonic acid, alkylphosphonic acid, glycerophosphonic acid, methylenediphosphonic acid and ethylenediphosphonic acid, which are each may have a substituent; organic phosphoric acid esters such as phenylphosphoric acid, naphthylphosphoric acid, alkylphosphoric acid and glycerophosphoric acid, which are each may have a substituent; organic phosphinic acids such as phenylphosphinic acid, naphthylphosphinic acid, alkylphosphinic acid and glycerophosphinic acid, which are each may have a substituent; amino acids such as glycine and β-alanine; and hydrochlorides of amines having a hydroxyl group, such as hydrochloride of triethanolamine.

In the pore-sealing treatment, a silane coupling agent having an unsaturated group may be applied. Examples of the silane coupling agent include N-3-(acryloxy-2-hydroxypropyl)-3-aminopropyltriethoxysilane, (3-acryloxypropyl)dimethylmethoxysilane, (3-acryloxypropyl)methyldimethoxysilane, (3-acryloxypropyl)trimethoxysilane, 3-(N-allylamino)propyltrimethoxysilane, allyldimethoxysilane, allyltriethoxysilane, allyltrimethoxysilane, 3-butenyltriethoxysilane, 2-(chloromethyl)allyltrimethoxysilane, methacrylamidopropyltriethoxysilane, N-(3-methacryloxy-2-hydroxypropyl)-3-aminopropyltriethoxysilane, (methacryloxymethyl)dimethylethoxysilane, methacryloxymethyltriethoxysilane, methacryloxymethyltrimethoxysilane, methacryloxypropyldimethylethoxysilane, methacryloxpropyldimethylmethoxysilane, methacryloxypropylmethyldiethioxysilane, methacryloxypropylmethyldimethoxysilane, methacryloxypropylmethyltriethoxysilane, methacryloxypropylmethyltrimethoxysilane, methacryloxypropyltris(methoxyethyl)silane, methoxydimethylvinylsilane, 1-methoxy-3-(trimethylsiloxy)butadiene, styrylethyltrimethoxysilane, 3-(N-styrylmethyl-2-aminoethylamino)-propyltrimethoxysilane hydrochloride, vinyldimethylethoxysilane, vinyldiphenylethoxysilane, vinylmethyldiethoxysilane, vinylmethyldimethoxysilane, o-(vinyloxyethyl)-N-(triethoxysilylpropyl)urethane, vinyltriethoxysilane, vinyltrimethoxysilane, vinyltri-tert-butoxysilane, vinyltriisopropoxysilane, vinyltriphenoxysilane, vinyltris(2-methoxyethoxy)silane and diallylaminopropylmethoxysilane. Among these, preferred are silane coupling agents having a methacryloyl group or an acryloyl group, which are high in the reactivity of unsaturated group.

Other examples of the treatment include a sol-gel coating treatment described in JP-A-5-50779, a treatment of coating phosphonic acids described in JP-A-5-246171, a treatment of coating a backcoat material described in JP-A-6-234284, JP-A-6-191173 and JP-A-6-230563, a treatment with phosphonic acids described in JP-A-6-262872, a coating treatment described in JP-A-6-297875, an anodization treatment described in JP-A-10-109480, and a dipping treatment described in JP-A-2000-81704 and JP-A-2000-89466, and any of these methods may be used.

After forming a hydrophilic film, the aluminum sheet surface is subjected to a hydrophilization treatment, if desired. The hydrophilization treatment includes an alkali metal silicate method described in U.S. Pat. Nos. 2,714,066, 3,181,461, 3,280,734 and 3,902,734. In this method, the support is electrolyzed by dipping it in an aqueous solution of sodium silicate or the like. Other examples include a method of performing the treatment with potassium fluorozirconate described in JP-B-36-22063, and a method of performing the treatment with polyvinylphosphonic acid described in U.S. Pat. Nos. 3,276,868, 4,153,461 and 4,689,272.

In the case of using a support insufficient in the hydrophilicity on the surface, such as polyester film, for the support of the present invention, a hydrophilic layer is preferably coated to render the surface hydrophilic. Preferred examples of the hydrophilic layer include a layer formed by coating a coating solution containing a colloid of an oxide or hydroxide of at least one element selected from beryllium, magnesium, aluminum, silicon, titanium, boron, germanium, tin, zirconium, iron, vanadium, antimony and a transition metal described in JP-A-2001-199175, a hydrophilic layer having an organic hydrophilic matrix obtained by crosslinking or pseudo-crosslinking an organic hydrophilic polymer described in JP-A-2002-79772, a hydrophilic layer having an inorganic hydrophilic matrix obtained by sol-gel conversion comprising hydrolysis and condensation reaction of polyalkoxysilane, titanate, zirconate or aluminate, and a hydrophilic layer comprising an inorganic thin film having a surface containing a metal oxide. Among these, a hydrophilic layer formed by coating a coating solution containing a colloid of an oxide or hydroxide of silicon is more preferred.

In the case of using polyester film or the like as the support of the present invention, an antistatic layer is preferably provided on the hydrophilic layer side or opposite of the support or on both sides. When an antistatic layer is provided between the support and the hydrophilic layer, this contributes to the enhancement of adhesion to the hydrophilic layer. Examples of the antistatic layer which can be used include a polymer layer having dispersed therein metal oxide fine particle or matting agent described in JP-A-2002-79772.

The support preferably has a center line average roughness of 0.10 to 1.2 μm. Within this range, good adhesion to the photosensitive-thermosensitive layer, good press life and good antiscumming property can be obtained.

The color density of the support is preferably from 0.15 to 0.65 in terms of the reflection density value. Within this range, good image-forming property by virtue of antihalation at the image exposure and good suitability for plate inspection after development can be obtained.

[Backcoat Layer]

After the support is subjected to a surface treatment or formation of an undercoat layer, a backcoat may be provided on the back surface of the support, if desired.

Suitable examples of the backcoat include a coat layer comprising a metal oxide obtained by hydrolyzing and polycondensing an organic polymer compound described in JP-A-5-45885 or an organic or inorganic metal compound described in JP-A-6-35174. Among these, those using an alkoxy compound of silicon, such as Si(OCH₃)₄, Si(OC₂H₇)₄, Si(OC₃H₇)₄ and Si(OC₄H₉)₄, are preferred because the raw material is inexpensive and easily available.

[Undercoat Layer]

In the lithographic printing plate precursor of the present invention, if desired, an undercoat layer can be provided between the photosensitive-thermosensitive layer and the support. The undercoat layer functions as a heat-insulating layer, as a result, the heat generated upon exposure with infrared laser is prevented from diffusing into the support and can be efficiently used and the sensitivity can be advantageously elevated. Furthermore, in the unexposed area, the photosensitive-thermosensitive layer is rendered easily separable from the support and therefore, the on-press developability is enhanced.

Specific examples of the undercoat layer include a silane coupling agent having an addition-polymerizable ethylenic double bond reactive group described in JP-A-10-282679 and a phosphorus compound having an ethylenic double bond reactive group described in 2-304441.

The amount coated (solid content) of the undercoat layer is preferably from 0.1 to 100 mg/m², more preferably from 1 to 30 mg/m².

[Protective Layer]

In the lithographic printing plate precursor of the present invention, a protective layer may be provided on the photosensitive-thermosensitive layer, if desired, for the purpose of preventing generation of scratches or the like on the photosensitive-thermosensitive layer, blocking oxygen or preventing ablation at the exposure with a high-intensity laser.

In the present invention, the exposure is usually performed in air and the protective layer prevents low molecular compounds such as oxygen and basic substance present in air, which inhibit an image-forming reaction occurring upon exposure in the photosensitive-thermosensitive layer, from mixing into the photosensitive-thermosensitive layer and thereby prevents the inhibition of image-forming reaction at the exposure in air. Accordingly, the property required of the protective layer is low permeability to low molecular compounds such as oxygen. Furthermore, the protective layer preferably has good transparency to light used for exposure, excellent adhesion to the photosensitive-thermosensitive layer, and easy removability during on-press development after exposure. Various studies have been heretofore made on the protective layer having these properties and such protective layers are described in detail, for example, in U.S. Pat. No. 3,458,311 and JP-A-5549729.

Examples of the material used for the protective layer include water-soluble polymer compounds having relatively excellent crystallinity. Specific examples thereof include water-soluble polymers such as polyvinyl alcohol, polyvinylpyrrolidone, acidic celluloses, gelatin, gum arabic and polyacrylic acid. In particular, when polyvinyl alcohol (PVA) is used as the main component, most excellent results are obtained with respect to basic properties such as oxygen-blocking property and development removability. As long as the polyvinyl alcohol contains an unsubstituted vinyl alcohol unit for giving necessary oxygen-blocking property and water solubility to the protective layer, a part thereof may be replaced by an ester, an ether or an acetal or may have another copolymerization component.

Examples of the polyvinyl alcohol which can be suitably used include those having a hydrolysis degree of 71 to 100% and a polymerization degree of 300 to 2,400. Specific examples thereof include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8 produced by Kuraray Co., Ltd.

The components (for example, selection of PVA and use of additives), coated amount and the like of the protective layer are appropriately selected by taking account of fogging, adhesion, scratch resistance and the like in addition to the oxygen-blocking property and development removability. In general, as the PVA has a higher percentage of hydrolysis (namely, as the unsubstituted vinyl alcohol unit content in the protective layer is higher) or as the layer thickness is larger, the oxygen-blocking property is enhanced and this is preferred in view of sensitivity. Also, in order to prevent the generation of unnecessary polymerization reaction at the production or during storage or unnecessary fogging at the image exposure or prevent thickening or the like of the image line, an excessively high oxygen permeability is not preferred. Accordingly, the oxygen permeability A at 25° C. and 1 atm is preferably 0.2≦A≦20 (cc/m²·day).

As other components of the protective layer, glycerin, dipropylene glycol and the like may be added in an amount corresponding to several mass % based on the water-soluble polymer compound so as to impart flexibility. Also, an anionic surfactant such as sodium alkylsulfate and sodium alkylsulfonate; an amphoteric surfactant such as alkylaminocarboxylate and alkylaminocarboxylate; or a nonionic surfactant such as polyoxyethylene alkylphenyl ether may be added in an amount of several mass % based on the (co)polymer.

The thickness of the protective layer is suitably from 0.1 to 5 μm, preferably from 0.2 to 2 μm.

The adhesion to the image area, scratch resistance and the like of the protective layer are also very important in view of handling of the lithographic printing plate precursor. More specifically, when a protective layer which is hydrophilic by containing a water-soluble polymer compound is stacked on the photosensitive-thermosensitive layer which is lipophilic, the protective layer is readily separated due to insufficient adhesive strength and in the separated portion, defects such as curing failure ascribable to polymerization inhibition by oxygen may be caused.

In order to solve this problem, various proposals have been made with an attempt to improve the adhesive property between the photosensitive-thermosensitive layer and the protective layer. For example, JP-A-49-70702 and Unexamined British Patent Publication No. 1,303,578 describe a technique of mixing from 20 to 60 mass % of an acrylic emulsion, a water-insoluble vinylpyrrolidone-vinyl acetate copolymer or the like in a hydrophilic polymer mainly comprising polyvinyl alcohol and stacking the obtained solution on the photosensitive-thermosensitive layer, whereby sufficiently high adhesive property can be obtained. In the present invention, these known techniques all can be used. The method for coating the protective layer is described in detail, for example, in U.S. Pat. No. 3,458,311 and JP-A-55-49729.

Furthermore, other functions may be imparted to the protective layer. For example, when a colorant (for example, water-soluble dye) excellent in the transparency to infrared ray used for exposure and capable of efficiently absorbing light at other wavelengths is added, the aptitude for safelight can be enhanced without causing decrease of sensitivity.

[Exposure]

In the lithographic printing method of the present invention, the above-described lithographic printing plate precursor of the present invention is imagewise exposed by an infrared laser.

The infrared laser for use in the present invention is not particularly limited, but suitable examples thereof include a solid or semiconductor laser of radiating an infrared ray at a wavelength of 760 to 1,200 nm. The output of the infrared laser is preferably 100 mW or more and in order to shorten the exposure time, a multi-beam laser device is preferably used.

The exposure tine is preferably 20 μseconds or less per one picture element. The amount of energy irradiated is preferably from 10 to 300 mJ/cm².

[Printing Method]

In the lithographic printing method of the present invention, after the lithographic printing plate precursor of the present invention is imagewise exposed with an infrared laser as described above, printing is performed by supplying an oily ink and an aqueous component without passing through any development processing step.

Specific examples of the method therefor include a method of exposing the lithographic printing plate precursor with an infrared laser, then loading it on a printing press without passing through a development processing step and performing printing, and a method of loading the lithographic printing plate precursor on a printing press, exposing it with an infrared laser on the printing press, and performing printing without passing through a development processing step.

For example, in one embodiment of the negative on-press development-type lithographic printing plate precursor, when the lithographic printing plate precursor is imagewise exposed with an infrared laser and then printing is performed by supplying an aqueous component and an oily ink without passing through a development processing step such as wet development, the photosensitive-thermosensitive layer cured by the exposure forms an oily ink-receiving part having a lipophilic surface in the exposed area of photosensitive-thermosensitive layer. On the other hand, in the unexposed area, the uncured photosensitive-thermosensitive layer is removed by dissolving or dispersing in the supplied aqueous component and/or oily ink and the hydrophilic support surface in this portion is revealed.

As a result, the aqueous component adheres to the revealed hydrophilic surface and the oily ink adheres to the photosensitive-thermosensitive layer in the exposed region, thereby initiating the printing. Here, either the aqueous component or the oily ink may be first supplied to the plate surface, but the oily ink is preferably first supplied so as to prevent the aqueous component from being contaminated by the photosensitive-thermosensitive layer in the unexposed area. A fountain solution and a printing ink for normal lithographic printing are used as the aqueous component and oily ink, respectively.

In this way, the lithographic printing plate precursor is on-press developed on an off-set printing press and used as-is for printing of a large number of sheets.

### EXAMPLES

The present invention is described in greater detail below by referring to the Examples, but the present invention should not be construed as being limited thereto.

[Production of Lithographic Printing Plate Precursor]

### Example 1

<Preparation of Aluminum Support>

A 0.3 mm-thick aluminum plate (construction material: JIS1050) was degreased with an aqueous 10 mass % sodium aluminate solution at 50° C. for 30 seconds to remove the rolling oil on the plate surface. Thereafter, the aluminum plate surface was grained by using three nylon brushes implanted with bundled bristles having a diameter of 0.3 mm and a water suspension (specific gravity: 1.1 g/cm³) of pumice having a median diameter of 25 μm, and then thoroughly washed with water. This plate was etched by dipping it in an aqueous 25 mass % sodium hydroxide solution at 45° C. for 9 seconds and after washing with water, dipped in 20 mass % nitric acid at 60° C. for 20 seconds, followed by washing with water. At this time, the etched amount of the grained surface was about 3 g/m².

Subsequently, the aluminum plate was subjected to a continuous electrochemical surface-roughening treatment by using AC of 60 Hz. The electrolytic solution used here was an aqueous 1 mass % nitric acid solution (containing 0.5 mass % of aluminum ion) at a liquid temperature of 50° C. This electrochemical surface-roughening treatment was performed by using an AC power source of giving a trapezoidal AC having a trapezoidal waveform that the tine TP necessary for the current value to reach the peak from zero was 0.8 msec and the duty ratio was 1:1, and disposing a carbon electrode as the counter electrode. The auxiliary anode was ferrite. The current density was 30 A/dm² in terms of the peak value of current, and 5% of the current flowing from the power source was split to the auxiliary anode. The quantity of electricity at the nitric acid electrolysis was 175 C/dm² when the aluminum plate was serving as the anode. Thereafter, the aluminum plate was water-washed by spraying.

Subsequently, the aluminum plate was subjected to an electrochemical surface-roughening treatment in the same maimer as in the nitric acid electrolysis above by using an aqueous 0.5 mass % hydrochloric acid solution (containing 0.5 mass % of aluminum ion) at a liquid temperature of 50° C. under the conditions that the quantity of electricity was 50 C/dm² when the aluminum plate was sending as the anode. Thereafter, the aluminum plate was water-washed by spraying. This plate was treated in 15% sulfuric acid (containing 0.5 mass % of aluminum ion) as the electrolytic solution at a current density of 15 A/dm² to provide a DC anodic oxide film of 2.5 g/m², then washed with water, dried and further treated in an aqueous 2.5 mass % sodium silicate solution at 30° C. for 10 seconds. The center line average roughness (Ra) was measured by using a needle having a diameter of 2 μm and found to be 0.51 μm.

<Formation of Undercoat Layer>

Coating Solution (1) for undercoat layer having the following composition was bar-coated on the thus-treated support and then dried in an oven at 80° C. for 20 seconds to form an undercoat layer having a dry coated amount of 0.005 g/m².

Coating Solution (1) for Undercoat Layer

| Coating Solution (1) for Undercoat Layer | | |
|---|---|---|
| Water | 10 | g |
| Methanol | 90 | g |
| Polymer (1) shown below | 0.09 | g |

Polymer (1):

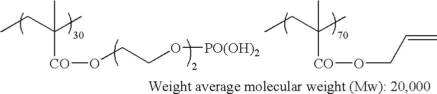

<Production of Lithographic Printing Plate Precursor>

On the undercoat layer formed above, Coating Solution (1) for photosensitive-thermosensitive layer having the following composition was bar-coated and dried in an oven at 70° C. for 60 seconds to form a photosensitive-thermosensitive layer having a dry coated amount of 1.0 g/m², thereby obtaining Lithographic Printing Plate Precursor 1.

Coating Solution (1) for Photosensitive-Thermosensitive Layer:

| | | |
|---|---|---|
| Coating Solution (1) for Photosensitive-Thermosensitive Layer: | | |
| Water | 50 | g |
| Propylene glycol monomethyl ether | 50 | g |
| Microcapsule (1) shown below (as solid content) | 6 | g |
| Microcapsule (2) shown below (as solid content) | 2.5 | g |
| Polymerization Initiator (1) shown below | 1 | g |
| Isocyanuric acid EO-modified triacrylate (NK Ester M-315, | 0.5 | g |
| produced by Shin-Nakamura Chemical Co., Ltd.) | | |
| Fluorine-Containing Surfactant (1) shown below | 0.2 | g |
| Polymerization Initiator (1): | | |
| 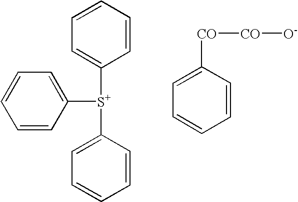 | | |
| Fluorine-Containing Surfactant (1): | | |

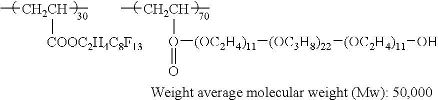

(Synthesis of Microcapsule (1))

As the oil phase component 8.7 g of trimethylolpropane and xylene diisocyanate adduct (Takenate D-110N, produced by Mitsui Takeda Chemicals, Inc.), 1 g of 2-methacryloyloxyethylisocyanate (Karenz MOI, produced by Showa Denko K.K.), 5.5 g of isocyanuric acid EO-modified triacrylate (NK Ester M-315, produced by Shin-Nakamura Chemical Co., Ltd.), 0.5 g of Infrared Absorbent (1) shown below, and 0.1 g of Na dodecylbenzenesulfonate (Pionin A-41C, produced by Takemoto Yushi Co., Ltd.) were dissolved in 17 g of ethyl acetate. As the aqueous phase component, 40 g of an aqueous 4 mass % polyvinyl alcohol (PVA-205, produced by Kuraray Co., Ltd.) solution was prepared. The oil phase component and the aqueous phase component were mixed and emulsified in a homogenizer at 12,000 rpm for 10 minutes. Thereafter, 25 g of distilled water was added to the resulting emulsified product and the mixture was stirred at room temperature for 30 minutes and then stirred at 40° C. for 3 hours. The thus-obtained microcapsule solution was diluted with distilled water to a solid content concentration of 20 mass %. The average particle size was 0.3 μm. 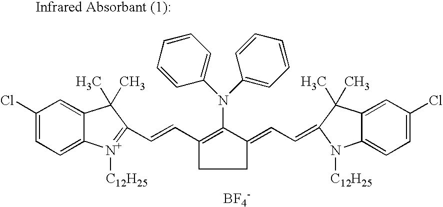
(Synthesis of Microcapsule (2))

As the oil phase component, 10 g of trimethylolpropane and xylene diisocyanate adduct (Takenate D-110N, produced by Mitsui Takeda Chemicals, Inc.), 5 g of leuco Malachite Green (produced by Tokyo Kasei Kogyo Co., Ltd.), 0.5 g of Triazine Compound (1) shown below, 0.5 g of Infrared Absorbent (1) and 0.1 g of Na dodecylbenzenesulfonate (Pionin A-41C, produced by Takemoto Yushi Co., Ltd.) were dissolved in 17 g of ethyl acetate. As the aqueous phase component, 40 g of an aqueous 4 mass % PVA-205 solution was prepared. The oil phase component and the aqueous phase component were mixed and emulsified in a homogenizer at 12,000 rpm for 10 minutes. Thereafter, 0.38 g of tetraethylenepentamine and 25 g of distilled water was added to the resulting emulsified product and the mixture was stirred at room temperature for 30 minutes and then stirred at 65° C. for 3 hours. The thus-obtained microcapsule solution was diluted with distilled water to a solid content concentration of 20 mass %. The average particle size was 0.3 μm.

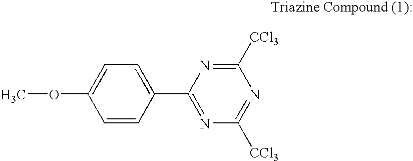

### Example 2

A lithographic printing plate precursor was obtained in the same manner as in Example 1 except that Coating Solution (2) for photosensitive-thermosensitive layer having the following composition was bar-coated and then dried in an oven at 100° C. for 60 seconds to form a photosensitive-thermosensitive layer having a dry coated amount of 1.0 g/m².

Coating Solution (2) for Photosensitive-Thermosensitive Layer:

| | | |
|---|---|---|
| Coating Solution (2) for Photosensitive-Thermosensitive Layer: | | |
| Infrared Absorbent (1) | 0.3 | g |
| Polymerization Initiator (1) | 0.9 | g |
| Binder Polymer (1) shown below | 2.5 | g |
| Polymerizable compound | 5.4 | g |
| Isocyanuric acid EO-modified triacrylate (NK Ester M-315, | | |
| produced by Shin-Nakamura Chemical Co., Ltd.) | | |
| Triazine Compound (1) | 0.1 | g |
| Leuco Crystal Violet (produced by Tokyo Kasei | 0.8 | g |
| Kogyo Co., Ltd.) | | |
| Fluorine-Containing Surfactant (1) | 0.1 | g |
| Methanol | 4 | g |
| Methyl ethyl ketone | 96 | g |
| Binder Polymer (1): | | |

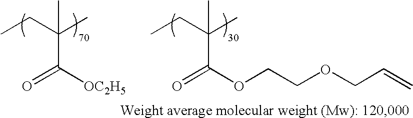

### Example 3

A lithographic printing plate precursor was obtained in the same manner as in Example 1 except that Coating Solution (3) for photosensitive-thermosensitive layer having the following composition was bar-coated and then dried in an oven at 80° C. for 60 seconds to form a photosensitive-thermosensitive layer having a dry coated amount of 1.0 g/m².

Coating Solution (3) for Photosensitive-Thermosensitive Layer:

| | | |
|---|---|---|
| Coating Solution (3) for Photosensitive-Thermosensitive Layer: | | |
| Infrared Absorbent (2) shown below | 0.3 | g |
| Polymerization Initiator (1) | 0.9 | g |
| Binder Polymer (1) | 2.5 | g |
| Polymerizable compound | 5.4 | g |
| Pentaerythritol triacrylate (SR444, produced by Nippon Kayaku | | |
| Co., Ltd.) | | |
| Microcapsule (2) (as solid content) | 2.5 | g |
| Fluorine-Containing Surfactant (1) | 0.1 | g |
| Methanol | 10 | g |
| Water | 35 | g |
| Propylene glycol monomethyl ether | 50 | g |
| Infrared Absorbent (2): | | |

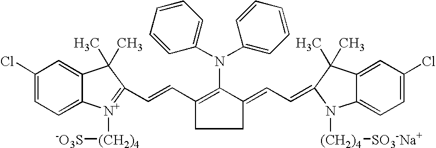

### Example 4

A lithographic printing plate precursor was obtained in the same manner as in Example 1 except that Coating Solution (4) for photosensitive-thermosensitive layer having the following composition was bar-coated and then dried in an oven at 100° C. for 60 seconds to form a photosensitive-thermosensitive layer having a dry coated amount of 1.0 g/m².

Coating Solution (4) for Photosensitive-Thermosensitive Layer:

| | | |
|---|---|---|
| Infrared Absorbent (2) shown below | 0.3 | g |
| Polymerization Initiator (1) | 0.9 | g |
| Binder Polymer (1) | 1.8 | g |
| Polymerizable compound | 2.0 | g |
| Pentaerythritol triacrylate (SR444, | | |
| produced by Nippon Kayaku Co., Ltd.) | | |
| Microcapsule (2) (as solid content) | 2.5 | g |
| Microcapsule (3) shown below (as solid content) | 2.5 | g |
| Fluorine-Containing Surfactant (1) | 0.1 | g |
| Methanol | 10 | g |
| Water | 35 | g |
| Propylene glycol monomethyl ether | 50 | g |

(Synthesis of Microcapsule (3))

As the oil phase component, 8.7 g of trimethylolpropane and xylene diisocyanate adduct (Takenate D-110N, produced by Mitsui Takeda Chemicals, Inc.), 1 g of 2-methacryloyloxyethylisocyanate (Karenz MOI, produced by Showa Denko K.K.), pentaerythritol triacrylate (SR444, produced by Nippon Kayaku Co., Ltd.), and 0.1 g of Na dodecylbenzenesulfonate (Pionin A-41C, produced by Takemoto Yushi Co., Ltd.) were dissolved in 17 g of ethyl acetate. As the aqueous phase component, 40 g of an aqueous 4 mass % PVA-205 solution was prepared. The oil phase component and the aqueous phase component were mixed and emulsified in a homogenizer at 12,000 rpm for 10 minutes. Thereafter, 25 g of distilled water was added to the resulting emulsified product and the mixture was stirred at room temperature for 30 minutes and then stirred at 40° C. for 3 hours. The thus-obtained microcapsule solution was diluted with distilled water to a solid content concentration of 20 mass %. The average particle size was 0.3 μm.

### Example 5

A lithographic printing plate precursor was obtained in the same manner as in Example 4 except that Coating Solution (1) for protective layer shown below was further bar-coated on the photosensitive-thermosensitive layer of Example 4 and then dried in an oven at 100° C. for 60 seconds to form a protective layer having a dry coated amount of 0.5 g/m².

Coating Solution (1) for Protective Layer:

| | | |
|---|---|---|
| Polyvinyl alcohol (saponification degree: 98.5 mol % | 1.0 | g |
| (PVA105, produced by Kuraray Co., Ltd.) | | |
| Polyoxyethylene lauryl ether (EMALEX 710, produced | 0.01 | g |
| by Nihon Emulsion Co., Ltd.) | | |
| Water | 19.0 | g |

### Comparative Example 1

A lithographic printing plate precursor was obtained in the same manner as in Example 4 except that Microcapsule (2) in Coating Solution (4) for photosensitive-thermosensitive layer was entirely replaced by Microcapsule (3).

### Examples 6 to 26

<Preparation of Aluminum Support>

Using a 0.24 mm-thick aluminum plate according to JIS 1050, a pretreatment, a surface-roughening treatment, a hydrophilic film-producing treatment and if desired, a post-treatment were performed in this order to prepare an aluminum support for use in Examples 6 to 26. The surface-roughening treatment was performed by any one method of A to J described below and the hydrophilic film-producing treatment and the post-treatment were performed by the method described in Production Example of each substrate.

<Surface-Roughening Treatments A, B and C>

The aluminum plate was subjected to a dissolution treatment to give a dissolution amount of 2 g/m² by dipping it in an aqueous 1 mass % sodium hydroxide solution kept at 50° C. After washing with water, the aluminum plate was neutralized by dipping it in an aqueous solution having the same composition as the electrolytic solution used in the subsequent electrochemical surface-roughening treatment for 10 seconds and then washed with water.

The resulting aluminum substrate material was then subjected to an electrochemical surface-roughening treatment which was performed in multiple installments with a pause by using sine-wave AC at a current density of 50 A/dm³. The composition of electrolytic solution, the quantity of electricity per one treatment, the number of electrolysis treatments, and the pause tine are shown in Table 1. After the electrochemical surface-roughening treatment, the substrate was subjected to an alkali dissolution treatment to give a dissolution amount of 2 g/m² by dipping it in an aqueous 1 mass % sodium hydroxide solution kept at 50° C., then washed with, neutralized by dipping it in an aqueous 10 mass % sulfuric acid solution kept at 25° C., and washed with water.

TABLE 1
Conditions of Surface-Roughening Treatments A, B and C

| Kind of Surface- | Composition of Electrolytic Solution | | Quantity of | Number of | Pose |
|---|---|---|---|---|---|
| Roughening | Hydrochloric Acid | Acetic Acid | Electricity per One | Electrolysis | Time |
| Treatment | (g/liter) | (g/liter) | Treatment (C/dm²) | Treatments (times) | (sec) |
| A | 10 | 0 | 80 | 6 | 1.0 |
| B | 10 | 0 | 40 | 12 | 4.0 |
| C | 10 | 20 | 100 | 2 | 0.8 |

<Surface-Roughening Treatment D>

The aluminum plate was degreased and etched by dipping it in an aqueous 10 mass % sodium hydroxide solution at 50° C., then washed with running water, neutralized with an aqueous 25 mass % sulfuric acid solution for 20 seconds, and washed with water. Subsequently, the aluminum plate was subjected to an electrolytic surface-roughening treatment at 20° C. in an aqueous 1 mass % hydrochloric acid solution (containing 0.5 mass % of aluminum ion) by using a trapezoidal rectangular wave where the time (TP) necessary for the current value to reach the peak from 0 was 2 msec, the frequency was 60 Hz and the duty ratio was 1:1, and disposing a carbon electrode as the counter electrode, such that the average current density at aluminum anode tine was 27 A/dm² (the current density ratio between anode time and cathode time of aluminum was 1:0.95) and the quantity of electricity at the aluminum anode time was 350 C/dm². Thereafter, the aluminum plate was etched by spraying an aqueous solution containing 26 mass % of sodium hydroxide and 6.5 mass % of aluminum ion at a liquid temperature of 45° C., to give an entire etched amount of 0.7 g/m² including smut and then desmutted by spraying an aqueous 25 mass % nitric acid solution (containing 0.3 mass % of aluminum ion) at 60° C. for 10 seconds.

<Surface-Roughening Treatment E>

The aluminum plate surface was surface-roughened by using a nylon brush having a bristle diameter of 0.72 mm and a bristle length of 80 mm and using a water suspension of pumice stones having an average particle size of about 15 to 35 μm and then thoroughly washed with water. Thereafter, the aluminum plate was etched by dipping it in an aqueous 10 mass % sodium hydroxide solution at 70° C. for 30 seconds, washed with running water, rinsed for neutralization with an aqueous 20 mass % nitric acid solution and then washed with water. The thus mechanically surface-roughened aluminum plate was further subjected to the following electrochemical surface-roughening treatment.

In an aqueous hydrochloric acid solution prepared by adding aluminum chloride to hydrochloric acid such that the hydrochloric acid concentration was 7.5 g/liter and the aluminum ion concentration was 5 g/liter, the aluminum plate mechanically surface-roughened above was subjected to an AC electrolysis at a liquid temperature of 35° C. by using a radial cell (the cell shown in FIG. 2 of JP-A-2003-103951) and applying AC. The AC used was a sine wave generated by adjusting the current and voltage of a commercial current at a frequency of 60 Hz with use of an induction voltage regulator and a transformer. The total quantity of electricity when the aluminum plate was serving as the anode was 50 C/dm² and the Qc/Qa in one cycle of the AC was 0.95.

The concentrations of hydrochloric acid and aluminum ion in the aqueous hydrochloric acid solution were kept constant by: determining the relationship of the temperature, electric conductivity and ultrasonic wave propagation velocity with the hydrochloric acid and aluminum ion concentrations; adding a concentrated hydrochloric acid having a concentration of 35 mass % and water to the inside of an electrolytic cell body from a circulation tank so that the temperature, electric conductivity and ultrasonic wave propagation velocity of the aqueous hydrochloric acid solution could be adjusted to predetermined values; and overflowing the excess aqueous hydrochloric acid solution. Subsequently, the aluminum plate was etched by using, as the treating solution, an alkali solution containing 5 mass % of sodium hydroxide and 0.5 mass % of aluminum ion at a liquid temperature of 45° C., such that the dissolution amount of the aluminum plate on the surface-roughened surface was 0.1 g/m² and the dissolution amount on the surface opposite the surface-roughened surface was 0.05 g/m².

On both surfaces of the etched aluminum plate, an aqueous sulfuric acid solution containing 300 g/liter of sulfuric acid and 5 g/liter of aluminum ion at a liquid temperature of 50° C. was sprayed to perform a desmutting treatment.

<Surface-Roughening Treatment F>

After Surface-Roughening Treatment A, an electrolytic surface-roughening treatment was further performed in the following aqueous nitric acid solution.

The aluminum plate was subjected to an electrolytic surface-roughening treatment at 50° C. in an aqueous 1 mass % nitric acid solution (containing 0.5 mass % of aluminum ion) by using a trapezoidal rectangular wave where the time (TP) necessary for the current value to reach the peak from 0 was 2 msec, the frequency was 60 Hz and the duty ratio was 1:1, disposing a carbon electrode as the counter electrode and using a radial cell (the cell shown in FIG. 2 of JP-A-2003-10395 1), such that the average current density at aluminum anode time was 27 A/dm² (the current density ratio between anode time and cathode time of aluminum was 1:0.95) and the quantity of electricity at the aluminum anode time was 350 C/dm². Thereafter, the aluminum plate was etched by spraying an aqueous solution containing 26 mass % of sodium hydroxide and 6.5 mass % of aluminum ion at a liquid temperature of 45° C., to give an entire etched amount of 0.2 g/m² including smut and then desmutted by spraying an aqueous 25 mass % nitric acid solution (containing 0.3 mass % of aluminum ion) at 60° C. for 10 seconds.

<Surface-Roughening Treatment G>

A treatment (mechanical surface-roughening, alkali etching, neutralization, water washing) resulting from omitting the electrochemical surface-roughening treatment and subsequent treatments in Surface-Roughening Treatment E was designated as Surface-Roughening Treatment G.

<Surface-Roughening Treatment H>

The aluminum plate was subjected to a dissolution treatment by dipping it in an aqueous 1 mass % sodium hydroxide solution kept at 50° C. to give a dissolution amount of 2 g/m². After washing with water, the aluminum plate was neutralized by dipping it in an aqueous solution having the same composition as the electrolytic solution used in the subsequent electrochemical surface-roughening treatment for 10 seconds and then washed with water.

Subsequently, the aluminum substrate material was subjected to an electrochemical surface-roughening treatment which was performed with once pause of 0.5 seconds by using an aqueous 1 mass % nitric acid solution (containing 0.5 mass % of aluminum ion) and using sine-wave AC at a current density of 50 A/dm³ with a quantity of electricity of 250 C/dm² per one treatment and 500 C/dm² in total, and then washed with water. After the electrochemical surface-roughening treatment, the substrate was subjected to an alkali dissolution treatment to give a dissolution amount of 5 g/m² by dipping it in an aqueous 1 mass % sodium hydroxide solution kept at 50° C., then washed with, neutralized by dipping it in an aqueous 10 mass % sulfuric acid solution kept at 25° C., and washed with water.

<Surface-Roughening Treatment I>

A surface-roughening treatment was performed in the same manner as Surface-Roughening Treatment H except that the alkali dissolution treatment after the electrochemical surface-roughening treatment was not performed.

<Surface-Roughening Treatment J>

A mechanical surface-roughening treatment was performed by using a brush roller with rotating nylon brushes while supplying an abrasive slurry suspension of quartz sand (abrasive, average particle size: 25 μm) having a specific gravity of 1.12 in water to the aluminum plate surface through a spray tube. The nylon brush used was made of 6,10-nylon and had a bristle length of 50 mm and a bristle diameter of 0.48 mm. This nylon brush was produced by perforating holes in a stainless steel-made cylinder having a diameter of 300 mm and densely implanting bristles in the holes. Three nylon brushes were used in the brush roller and the distance between two support rollers (φ200 mm) disposed below the brush was 300 mm. The load of the driving motor for rotating the brush was controlled with respect to the load before the nylon brush was pressed to the aluminum plate, and the brush roller was pressed such that the mean arithmetic roughness (Ra) of the roughened aluminum plate became 0.45 μm. The rotating direction of the brush was the same as the traveling direction of the aluminum plate. After this treatment, the aluminum plate was washed with water. The concentration of abrasive was kept constant by determining the abrasive concentration from the temperature and specific gravity with reference to a table previously prepared from the relationship of the abrasive concentration, temperature and specific gravity, and adding water and abrasive under the feedback control. When the abrasive is ground and the particle size is decreased, the surface profile of the roughened aluminum plate changes. Therefore, abrasive particles having a small particle size were successively discharged out of the system by a cyclone. The particle size of the abrasive was from 1 to 35 μm.

(2) Alkali Etching Treatment

An alkali etching treatment was performed by spraying an aqueous solution containing 27 mass % of NaOH and 6.5 mass % of aluminum ion at a liquid temperature of 70° C. through a spray tube on the aluminum plate. On the aluminum plate, the dissolution amount of the surface to be afterward subjected to an electrochemical surface-roughening treatment was 8 g/m² and the dissolution amount of the opposite surface was 2 g/m². The concentration of etching solution used for the alkali etching treatment was kept constant by determining the etching solution concentration from the temperature, specific gravity and electric conductivity with reference to a table previously prepared from the relationship of the NaOH concentration, aluminum ion concentration, temperature and specific gravity, and adding water and an aqueous 48 mass % NaOH solution under the feedback control. After this treatment, the aluminum plate was washed with water.

(3) Desmutting Treatment:

A desmutting treatment was performed for 10 seconds by spraying with a spray an aqueous nitric acid solution at a liquid temperature of 35° C. on the aluminum plate. For the aqueous nitric acid solution, the overflow waste solution from the electrolysis apparatus used in the next step was used. The spray tube for spraying the desmut-treating solution was disposed at several points not to dry the aluminum plate until the next step.

(4) Electrochemical Surface-Roughening Treatment

An electrochemical surface-roughening treatment was continuously performed by using the trapezoidal wave AC descried in JP-A-2003-103951 (FIG. 1) and two radial cells of the electrolytic apparatus shown in FIG. 2 of the same patent publication. For the acidic aqueous solution, an aqueous 1 mass % nitric acid solution (containing 0.5 mass % of aluminum ion and 0.007 mass % of ammonium ion) was used. The liquid temperature was 50° C. The AC was passed such that the time tp and tp′ necessary for the current value to reach the peak from 0 was 1 msec, and a carbon electrode was disposed as the counter electrode. The current density at the peak of AC was 50 A/dm² at both the anode time and the cathode time of the aluminum plate. Furthermore, the ratio (Q_{C}/Q_{A}) of the quantity of electricity at the cathode time (Q_{C}) of AC to the quantity of electricity at the anode time (Q_{A}), the duty, the frequency and the total quantity of electricity at the anode time were as shown below. Thereafter, the aluminum plate was water-washed by spraying.

The duty was 0.50, the frequency was 60 Hz, the total quantity of electricity at the anode time Q_{A} was 180 C/dm², the ratio Q_{C}/Q_{A} of the quantity of electricity was 0.95, and the concentration of the aqueous nitric acid solution was controlled by adding a stock nitric acid solution of 67 mass % and water in proportion to the electricity passed and sequentially allowing the acidic aqueous solution (aqueous nitric acid solution) in the same amount as the volume added of nitric acid and water to overflow from the electrolysis apparatus, thereby discharging it out of the electrolysis apparatus system. At the same time, the concentration was kept constant under the control of determining the concentration of the aqueous nitric acid solution from the temperature, electric conductivity and ultrasonic wave propagation velocity of the aqueous nitric acid solution with reference to a table previously prepared from the relationship of the nitric acid concentration, aluminum ion concentration, temperature, electric conductivity of solution and ultrasonic wave propagation velocity of solution, and sequentially adjusting the amounts added of the stock nitric acid solution and water.

(5) Alkali Etching Treatment

An alkali etching treatment was performed by spraying an aqueous solution containing 26 mass % of NaOH and 6.5 mass % of aluminum ion at a liquid temperature of 45° C. on the aluminum plate. The dissolution amount of the aluminum plate was 1 g/m². The concentration of etching solution was kept constant by determining the etching solution concentration from the temperature, specific gravity and electric conductivity with reference to a table previously prepared from the relationship of the NaOH concentration, aluminum ion concentration, temperature and specific gravity, and adding water and an aqueous 48 mass % NaOH solution under the feedback control. After this treatment, the aluminum plate was washed with water.

(6) Acidic Etching Treatment

An acidic etching treatment was performed by using a sulfuric acid (sulfuric acid concentration: 300 g/L, aluminum ion concentration: 15 g/L) as the acidic etching solution and spraying this etching solution on the aluminum plate at 80° C. for 8 seconds through a spray tube. The concentration of acidic etching solution was kept constant by determining the acidic etching solution concentration from the temperature, specific gravity and electric conductivity with reference to a table previously prepared from the relationship of the sulfuric acid concentration, aluminum ion concentration, temperature, specific gravity and electric conductivity of solution, and adding water and 50 mass % sulfuric acid under the feedback control. After this treatment, the aluminum plate was washed both water.

<Production of Substrates 1 to 6 and 20>

The substrates subjected to Surface-Roughening Treatments A to F and J each was anodized for 20 seconds by using an anodization apparatus at a sulfuric acid concentration of 170 g/liter (containing 0.5 mass % of aluminum ion), a liquid temperature of 40° C. and a current density of 30 A/dm², and then washed with water. Subsequently, each substrate was dipped in an aqueous sodium hydroxide solution at a liquid temperature of 30° C. and a pH of 13 for 70 seconds and then washed with water. The resulting substrate was dipped in an aqueous 1 mass % colloidal silica (Snowtex ST-N, produced by Nissan Chemical Industries, Ltd., particle size: about 20 nm) solution at 70° C. for 14 seconds and then washed with water. Thereafter, the substrate was dipped in 2.5 mass % No. 3 sodium silicate at 70° C. for 14 seconds and then washed with water. In this way, Substrates 1 to 6 and 20 were produced.

<Production of Substrate 7>

The aluminum plate subjected to Surface-Roughening Treatment E was anodized in a 50 g/liter oxalic acid solution at 30° C. and a current density of 12 A/dm² for 2 minutes and then washed with water to produce an anodic oxide film of 4 g/m². Subsequently, the aluminum plate was dipped in an aqueous sodium hydroxide solution at a liquid temperature of 50° C. and a pH of 13 for 2 minutes and then washed with water. Thereafter, the aluminum plate was dipped in 2.5 mass % No. 3 sodium silicate at 70° C. for 14 seconds and then washed with water to produce Substrate 7.

<Production of Substrate 8>

The aluminum plate subjected to Surface-Roughening Treatment E was anodized at a sulfuric acid concentration of 170 g/liter (containing 0.5 mass % of aluminum ion), a liquid temperature of 30° C. and a current density of 5 A/dm² for 70 seconds and then washed with water. Subsequently, the aluminum plate was treated with sodium silicate in the same manner as in Production Example 7 and then washed with water to produce Substrate 8.

<Production of Substrates 9 to 13>

Substrates 9 to 13 were produced in the same manner as in Production Example 5 except that the anodization treatment time in Production Example 5 (Substrate 5) using the substrate subjected to Surface-Roughening Treatment E was changed to 12 seconds, 16 seconds, 24 seconds, 44 seconds and 90 seconds, respectively.

<Production of Substrate 14>

Substrate 14 was produced in the same manner as in Production Example 5 of Substrate 5 except that the dipping in an aqueous colloidal silica solution was not performed.

<Production of Substrate 15>

The substrate subjected to Surface-Roughening Treatment E was anodized in an electric solution having a sulfuric acid concentration of 100 g/liter and an aluminum ion concentration of 5 g/liter at a liquid temperature 51° C. and a current density of 30 A/dm² and then washed with water to produce an anodic oxide film of 2 g/m². Subsequently, the substrate was anodized in an electrolytic solution having a sulfuric acid concentration of 170 g/liter and an aluminum ion concentration of 5 g/liter at a liquid temperature of 40° C. and a current density of 30 A/dm² under control to give a total anodic oxide film coverage of 4.0 g/m² and then washed with water to produce an anodic oxide film. Thereafter, the substrate was dipped in an aqueous 2.5 mass % No. 3 sodium silicate solution at a liquid temperature of 70° C. for 14 seconds and then washed with water to produce Substrate 15.

<Production of Substrate 16>

The substrate subjected to Surface-Roughening Treatment E was anodized in an electric solution having a sulfuric acid concentration of 170 g/liter and an aluminum ion concentration of 5 g/liter at a liquid temperature of 43° C. and a current density of 30 A/dm² and then washed with water to produce an anodic oxide film of 2 g/m². Subsequently, the substrate was anodized in an electrolytic solution having a phosphoric acid concentration of 120 g/liter and an aluminum ion concentration of 5 g/liter at a liquid temperature of 40° C. and a current density of 18 A/dm² and then washed with water. Thereafter, the substrate was dipped in an aqueous 2.5 mass % No. 3 sodium silicate solution at a liquid temperature of 70° C. for 14 seconds and then washed with water to produce Substrate 16.

<Production of Substrates 17 to 19>

Substrates 17 to 19 were produced in the same manner as in Example 14 except that substrates subjected to Surface-Roughening Treatments G, H and I were used, respectively, in place of the surface-roughened substrate of Production Example 14 (Substrate 14).

<Production of Substrate 21>

The substrate subjected to Surface-Roughening Treatment A was anodized in an electric solution having a sulfuric acid concentration of 200 g/liter and an aluminum ion concentration of 5 g/liter at a liquid temperature of 45° C., a voltage of about 10 V and a current density of 1.5 A/dm² for about 300 seconds to produce an anodic oxide film of 3 g/m² and then washed with water. Subsequently, the substrate was post-treated in an aqueous solution containing 20 g/liter of sodium hydrogencarbonate at a liquid temperature of 40° C. for 30 seconds then rinsed with water at 20° C. for 120 seconds and dried. Thereafter, the resulting substrate was dipped in an aqueous 5 mass % citric acid solution for 60 seconds, then washed with water and dried at 40° C. to produce Substrate 21.

The surface-roughened profile of aluminum substrates obtained in Production Examples and the physical property values and the like of hydrophilic film were shown in Table 2. The measuring methods of respective physical property values are as follows. Incidentally, the density was measured by the method described above.

<Measuring Methods of Average Opening Diameter of Large Corrugations, Average Opening Diameter of Small Pits, and Ratio of Average Depth of Small Pits to Average Opening Diameter of Small Pits>

These values all were measured by taking an SEM photograph of the aluminum substrate surface. The average opening diameter d₂ (μm) of large corrugations was determined by using an SEM photograph at a magnification of 1,000, measuring individual corrugations having a clearly distinguishable contour on the long diameter and the short diameter, designating the average thereof as the opening diameter of corrugation, and dividing the sum of opening diameters of large corrugations measured in the SEM photograph by 50 as the number of large corrugations measured. The SEM used here was S-900 manufactured by Hitachi, Ltd.

The average opening diameter d₁ (μm) of small pits was measured in the same manner as in the measurement of the opening diameter of large corrugations by using an SEM photograph at a magnification of 30,000. The SEM used here was S-900 manufactured by Hitachi, Ltd.

The ratio h/d₁ of the average depth h (μm) of small pits to the average opening diameter d₁ (μm) of small pits was measured by using an SEM photograph of the cross section at a magnification of 30,000, and an average of 50 portions measured was used.

<Measuring Method of Thermal conductivity in Thickness Direction of Hydrophilic Film>

In addition to Aluminum Substrates 1 to 21 of the present invention and Substrate 1 for comparison, two kinds of sheets were produced for each of aluminum substrates differing from those substrates only in the thickness of the hydrophilic film. The aluminum substrates differing only in the film thickness were produced in the same manner as the aluminum substrates of Production Examples except that the anodization time was changed to 0.5 times and 2 times, respectively.

Three kinds of aluminum substrates differing only in the film thickness were measured by the apparatus shown in FIG. 3 of JP-A-2003-103951 and the thermal conductivity in the thickness direction of the hydrophilic film was calculated by mathematical formula (1). The measurement was performed on different 5 points of the sample and an average thereof was used.

As for the thickness of the hydrophilic film, the cross section of the hydrophilic film was observed by SEM T-20 manufactured by JEOL Ltd., the film thickness was actually measured at 50 portions, and an average thereof was used.

<Measuring Method of Pore Size of Micropore in Anodic Oxide Film>

The pore size of micropore in the anodic oxide film was measured for the pore size of the surface layer and the pore size at the position of 0.4 μm deep from the surface layer. The anodic oxide film surface in the case of the pore size of the surface layer or the side face (usually, ruptured face) of the cracked portion generated on bending the anodized aluminum substrate in the case of the pore size at 0.4 μm from the surface layer was observed by ultrahigh resolution SEM (Hitachi S-900). The observation was performed at a relatively low accelerating voltage of 12 V at a magnification of 150,000 without applying vapor-deposition treatment for imparting electric conductivity. For either pore size, an average of measured values obtained by randomly selecting 50 pores was used. The standard deviation error was +10% or less in both pore sizes.

<Measurement Method of Porosity>

The porosity of the anodic oxide film was determined by the following formula:
Porosity (%)={1-(density of oxide film/3.98)}×100

Here, 3.98 is a density (g/cm³) of aluminum oxide according to Kagaku Binran (Handbook of Chemistry).

TABLE 2
Production Conditions and Properties of Aluminum Substrate

| | | Electrolytic | | | | | |
|---|---|---|---|---|---|---|---|
| | | Solution of | | Average Opening | | Anodization | |
| | Surface- | Electrochemical | Large | Diameter of | Ratio of | | Film |
| Substrate | Roughening | Surface- | Corrugation | Small Pits | Depth/Pit | Electrolytic | Coverage |
| No. | Treatment | Roughening | (μm) | (μm) | Diameter | Solution | (g/m²) |
| 1 | A | hydrochloric acid | 4.8 | 0.6 | 0.15 | sulfuric acid | 5.0 |
| 2 | B | hydrochloric acid | 3.5 | 0.6 | 0.18 | sulfuric acid | 5.0 |
| 3 | C | hydrochloric + | 5.0 | 0.8 | 0.20 | sulfuric acid | 5.0 |
| | | acetic acid | | | | | |
| 4 | D | hydrochloric acid | 4.5 | 0.3 | 0.25 | sulfuric acid | 5.0 |
| 5 | E | hydrochloric acid | 17 | 0.05 | 0.20 | sulfuric acid | 5.0 |
| 6 | F | hydrochloric acid → | 4.8 | 0.28 | 0.50 | sulfuric acid | 5.0 |
| | | nitric acid | | | | | |
| 7 | E | hydrochloric acid | 17 | 0.05 | 0.20 | oxalic acid | 4.0 |
| 8 | E | hydrochloric acid | 17 | 0.05 | 0.20 | sulfuric acid | 4.0 |
| 9 | E | hydrochloric acid | 17 | 0.05 | 0.20 | sulfuric acid | 3.2 |
| 10 | E | hydrochloric acid | 17 | 0.05 | 0.20 | sulfuric acid | 4.0 |
| 11 | E | hydrochloric acid | 17 | 0.05 | 0.20 | sulfuric acid | 6.0 |
| 12 | E | hydrochloric acid | 17 | 0.05 | 0.20 | sulfuric acid | 10.0 |
| 13 | E | hydrochloric acid | 17 | 0.05 | 0.20 | sulfuric acid | 20.0 |
| 14 | E | hydrochloric acid | 17 | 0.05 | 0.20 | sulfuric acid | 5.0 |
| 15 | E | hydrochloric acid | 17 | 0.05 | 0.20 | sulfuric acid → | 4.0 |
| | | | | | | nitric acid | |
| 16 | E | hydrochloric acid | 17 | 0.05 | 0.20 | sulfuric acid → | 4.0 |
| | | | | | | phosphoric acid | |
| 17 | G | none | 17 | none | none | sulfuric acid | 4.0 |
| 18 | H | nitric acid | none | 3.4 | 0.18 | sulfuric acid | 4.0 |
| 19 | I | nitric acid | none | 2.1 | 0.60 | sulfuric acid | 4.0 |
| 20 | J | nitric acid | 10 | 1.4 | 0.15 | sulfuric acid | 5.0 |
| 21 | A | hydrochloric acid | 4.8 | 0.6 | 0.15 | sulfuric acid | 3.0 |

| | | | | Pore Size (nm) | | | |
|---|---|---|---|---|---|---|---|
| | Thermal | | | | 0.4 μm | | |
| | Conductivity | Density | | Surface | from Surface | | Thickness of Hydrophilic |
| Substrate No. | (g/mk) | (kg/m²) | Porosity (%) | Layer | Layer | Pore-Sealing | Film (μm) |
| 1 | 0.4 | 2000 | 50 | 0 | 30 | applied | 2.5 |
| 2 | 0.4 | 2000 | 50 | 0 | 30 | applied | 2.5 |
| 3 | 0.4 | 2000 | 50 | 0 | 30 | applied | 2.5 |
| 4 | 0.4 | 2000 | 60 | 0 | 30 | applied | 2.5 |
| 5 | 0.4 | 2000 | 50 | 0 | 30 | applied | 2.5 |
| 6 | 0.4 | 2000 | 50 | 0 | 30 | applied | 2.5 |
| 7 | 0.05 | 1050 | 70 | 40 | 50 | none | 3.8 |
| 8 | 0.5 | 3150 | 20 | 20 | 20 | none | 1.3 |
| 9 | 0.4 | 2000 | 50 | 0 | 24 | applied | 1.6 |
| 10 | 0.4 | 2000 | 50 | 0 | 27 | applied | 2.0 |
| 11 | 0.4 | 2000 | 50 | 0 | 32 | applied | 3.0 |
| 12 | 0.4 | 1800 | 55 | 0 | 35 | applied | 5.6 |
| 13 | 0.4 | 1600 | 60 | 0 | 38 | applied | 12.5 |
| 14 | 0.4 | 2000 | 50 | 20 | 30 | none | 2.5 |
| 15 | 0.4 | 3000 | 25 | 10 | 20 | none | 1.3 |
| 16 | 0.3 | 2500 | 40 | 15 | 200 | none | 1.6 |
| 17 | 0.4 | 2000 | 50 | 30 | 30 | none | 2.0 |
| 18 | 0.4 | 2000 | 50 | 30 | 30 | none | 2.0 |
| 19 | 0.4 | 2000 | 50 | 30 | 30 | none | 2.0 |
| 20 | 0.4 | 2000 | 50 | 0 | 30 | applied | 2.5 |
| 21 | 0.7 | 3400 | 15 | 7 | 10 | none | 0.9 |

<Production of Lithographic Printing Plate Precursor>

Lithographic printing plate precursors of Examples 6 to 26 were obtained by forming the undercoat layer and photosensitive-thermosensitive layer in the same manner as in Example 4 except for changing the substrate to Substrates 1 to 21 of Production Examples above in Examples 6 to 26, respectively.

[Evaluation of Lithographic Printing Plate Precursor]

1. Measurement of Lightness Difference ΔL Between Exposed Area and Unexposed Area (Evaluation of Printout Image)

The obtained lithographic printing plate precursors each was exposed by Trendsetter 3244VX (manufactured by Creo) having mounted thereon a water cooling 40 W infrared semiconductor laser, with a plate surface energy amount shown in Table 3 under the conditions that the resolution was 2,400 dpi.

In order to evaluate the printout image, L* values of exposed area and unexposed area were measured by a color-difference meter (Color and Color-Difference Meter CR-221, manufactured by Minolta Co., Ltd.) and from the absolute value of the difference therebetween, the lightness difference ΔL was determined. The results are shown in Table 3. The contrast between exposed area and unexposed area was good except for Comparative Example 1 and the fine line or letter could be recognized.

2. Evaluation of On-Press Developability and Printing

Without passing through development processing, the resulting exposed lithographic printing plate precursor was loaded on a cylinder of printing press SOR-M manufactured by Heidelberg. Using a fountain solution (EU-3 (etching solution, produced by Fuji Photo Film Co., Ltd.))/water/isopropyl alcohol=1/89/10 (by volume)) and TRANS-GN(N) black ink (produced by Dai-Nippon Ink & Chemicals, Inc.), 100 sheets were printed after supplying the fountain solution and ink at a printing speed of 6,000 sheets per hour.

The number of printing sheets required until the on-press development of the photosensitive-thermosensitive layer in the unexposed area was completed on the printing press and the transfer of ink onto the printing sheet did not occur was counted and evaluated as the on-press developability, as a result, with any lithographic printing plate precursor, a printed matter free from staining in the non-image area was obtained within 100 sheets.

Thereafter, 5,000 sheets were printed, as a result, with any lithographic printing plate precursor, a good printed matter free from reduction of the ink density in the image area and staining in the non-image area could be obtained.

TABLE 3
Measurement Results of Lightness Difference ΔL

| Lithographic | | |
|---|---|---|
| Printing Plate | Exposure Energy | Lightness |
| Precursor Used | (mJ/cm²) | Difference ΔL |
| Example 1 | 100 | 8.2 |
| Example 2 | 100 | 6.6 |
| Example 3 | 100 | 7.0 |
| Example 4 | 70 | 4.5 |
| | 100 | 7.3 |
| | 150 | 10.0 |
| | 300 | 15.4 |
| Example 5 | 100 | 8.0 |
| Comparative | 100 | 0.6 |
| Example 1 | 300 | 1.5 |
| Example 6 | 100 | 7.8 |
| Example 7 | 100 | 7.7 |
| Example 8 | 100 | 7.8 |
| Example 9 | 100 | 7.8 |
| Example 10 | 100 | 8.0 |
| Example 11 | 100 | 7.7 |
| Example 12 | 100 | 9.8 |
| Example 13 | 100 | 7.4 |
| Example 14 | 100 | 7.7 |
| Example 15 | 100 | 8.0 |
| Example 16 | 100 | 7.9 |
| Example 17 | 100 | 8.4 |
| Example 18 | 100 | 8.6 |
| Example 19 | 100 | 7.9 |
| Example 20 | 100 | 7.7 |
| Example 21 | 100 | 8.2 |
| Example 22 | 100 | 7.6 |
| Example 23 | 100 | 7.8 |
| Example 24 | 100 | 8.1 |
| Example 25 | 100 | 7.6 |
| Example 26 | 100 | 4.3 |

As apparent from the results above, in Comparative Example not using a discoloring agent or a discoloration system, the lightness difference AL is very small, whereas the lithographic printing plate precursor of the present invention using a discoloring agent or a discoloration system has a large ΔL value.

Furthermore, it is seen from these results that as compared with Example 2 where the infrared absorbent and discoloration system are not microencapsulated, the lightness difference is large in other Examples where at least either the infrared absorbent or discoloration system is encapsulated in a microcapsule and the discoloration system is separated from the radical polymerizable compound.

Also, when Examples 6 to 26 are compared, it is seen that those where the thermal conductivity in the thickness direction of the support hydrophilic film is from 0.05 to 5.0 W/mK are more excellent in the lightness difference.

### Example 27

(Preparation of Support)

A 0.3 mm-thick aluminum plate according to JIS-A-1050 was treated by practicing the following steps (a) to (k) in this order.

(a) Mechanical Surface-Roughening Treatment

A mechanical surface-roughening treatment was performed by using a rotating roller-shaped nylon brush while supplying an abrasive slurry suspension of an abrasive (quartz sand) having a specific gravity of 1.12 in water to the aluminum plate surface. The average particle size of the abrasive was 8 μm and the maximum particle size was 50 μm. The nylon brush used was made of 6.10-nylon and had a bristle length of 50 mm and a bristle diameter of 0.3 mm. This nylon brush was produced by perforating holes in a stainless steel-made cylinder having a diameter of 300 mm and densely implanting bristles in the holes. Three rotary brushes were used. The distance between two support rollers (φ200 mm) disposed below the brush was 300 mm. The brush roller was pressed to the aluminum plate until the load of the driving motor for rotating the brush became 7 kW larger than the load before the brush roller was pressed to the aluminum plate. The rotating direction of the brush was the same as the traveling direction of the aluminum plate. The rotation number of the brush was 200 rpm.

(b) Alkali Etching

An etching treatment was performed by spraying an aqueous NaOH solution (concentration: 26 mass %, aluminum ion concentration: 6.5 mass %) at a temperature of 70° C. on the obtained aluminum plate to dissolve 6 g/m² of the aluminum plate. Thereafter, the aluminum plate was washed by spraying well water.

(c) Desmutting Treatment

A desmutting treatment was performed by spraying an aqueous solution having a nitric acid concentration of 1 mass % (containing 0.5 mass % of aluminum ion) at a temperature of 30° C., and then the aluminum plate was water-washed by spraying. For the aqueous nitric acid solution used for the desmutting, the waste solution in the step of performing electrochemical surface-roughening by using AC in an aqueous nitric acid solution was used.

(d) Electrochemical Surface-Roughening Treatment

An electrochemical surface-roughening treatment was continuously performed by using AC voltage of 60 Hz. At this time, the electrolytic solution was an aqueous solution containing 10.5 g/liter of nitric acid (containing 5 g/liter of aluminum ion) at a temperature of 50° C. The electrochemical surface-roughening treatment was performed by using trapezoidal wave AC passed such that the time TP necessary for the current value to reach the peak from 0 was 0.8 msec and the duty ratio was 1:1, and disposing a carbon electrode as the counter electrode. The auxiliary anode was ferrite. The electrolytic cell used was a radial cell type. The current density was 30 A/dm² in terms of the peak value of current, the total quantity of electricity at the anode time of aluminum plate was 220 C/dm², and 5% of the current flowing from the power source was split to the auxiliary anode. Thereafter, the aluminum plate was washed by spraying well water.

(e) Alkali Etching Treatment

The aluminum plate was etched at 32° C. by spraying an etching solution having a sodium hydroxide concentration of 26 mass % and an aluminum ion concentration of 6.5 mass %, as a result, 0.20 g/m² of the aluminum plate was dissolved, the smut component mainly comprising aluminum hydroxide produced at the electrochemical surface-roughening performed by using AC in the previous stage was removed, and the edge portion of the produced pit was dissolved to smoothen the edge portion. Thereafter, the aluminum plate was washed by spraying well water. The etched amount was 3.5 g/m².

(f) Desmutting Treatment

A desmutting treatment was performed by spraying an aqueous solution having a nitric acid concentration of 15 mass % (containing 4.5 mass % of aluminum ion) at a temperature of 30° C., and then the aluminum plate was washed by spraying well water. For the aqueous nitric acid solution used for the desmutting, the waste solution in the step of performing electrochemical surface-roughening by using AC in an aqueous nitric acid solution was used.

(g) Electrochemical Surface-Roughening Treatment

An electrochemical surface-roughening treatment was continuously performed by using AC voltage of 60 Hz. At this time, the electrolytic solution was an aqueous solution containing 7.5 g/liter of hydrochloric acid (containing 5 g/liter of aluminum ion) at a temperature of 35° C. The electrochemical surface-roughening treatment was performed by using an AC power source having a rectangular waveform and disposing a carbon electrode as the counter electrode. The auxiliary anode was ferrite. The electrolytic cell used was a radial cell type. The current density was 25 A/dm² in terms of the peak value of current, and the total quantity of electricity at the anode time of aluminum plate was 50 C/dm². Thereafter, the aluminum plate was washed by spraying well water.

(h) Alkali Etching Treatment

The aluminum plate was etched at 32° C. by spraying an etching solution having a sodium hydroxide concentration of 26 mass % and an aluminum concentration of 6.5 mass %, as a result, 0.10 g/m² of the aluminum, plate was dissolved, the smut component mainly comprising aluminum hydroxide produced at the electrochemical surface-roughening performed by using AC in the previous stage was removed, and the edge portion of the produced pit was dissolved to smoothen the edge portion. Thereafter, the aluminum plate was washed by spraying well water.

(i) Desmutting Treatment

A desmutting treatment was performed by spraying an aqueous solution having a sulfuric acid concentration of 25 mass % (containing 0.5 mass % of aluminum ion) at a temperature of 60° C., and then the aluminum plate was washed by spraying well water.

(j) Anodization Treatment

For the electrolytic solution, sulfuric acid was used. The electrolytic solution had a sulfuric acid concentration of 170 g/liter (containing 0.5 mass % of aluminum ion) and at a temperature of 43° C. Thereafter, the aluminum plate was washed by spraying well water. The current density was about 30 A/dm². The final oxide film coverage was 2.7 g/m².

(k) Alkali Metal Silicate Treatment

An alkali metal silicate treatment (silicate treatment) was performed by dipping the resulting aluminum plate in a treating tank containing an aqueous 1 mass % No. 3 sodium silicate solution at a temperature of 30° C. for 10 seconds. Thereafter, the aluminum plate was washed by spraying well water to produce an aluminum support. At this time, the silicate add-in amount was 3.6 mg/m².

(Formation of Photosensitive-Thermosensitive Layer)

On the obtained support, Coating Solution (5) for photosensitive-thermosensitive layer having the following composition was bar-coated and dried at 80° C. for 60 seconds to form a photosensitive-thermosensitive layer. The coated amount was 1.0 g/m².

Composition of Coating Solution (5) for Photosensitive-thermosensitive Layer:

| Composition of Coating Solution (5) for | | |
|---|---|---|
| Photosensitive-Thermosensitive Layer: | | |
| Infrared Absorbent (D-1) shown below | 2 | parts by mass |
| Polymerization Initiator (1) | 10 | parts by mass |
| Dipentaerythritol hexaacrylate (NK Ester A-DPH, | 55 | parts by mass |
| produced by Shin-Nakamura Chemical Co., Ltd. | | |
| Binder Polymer (B-1) shown below | 37 | parts by mass |
| Leuco Crystal Violet (produced by Tokyo Kasei | 10 | parts by mass |
| Kogyo Co., Ltd.) | | |
| Fluorine-Containing Surfactant (1) | 6 | parts by mass |
| Methyl ethyl ketone | 900 | parts by mass |

Infrared Absorbent (D-1):

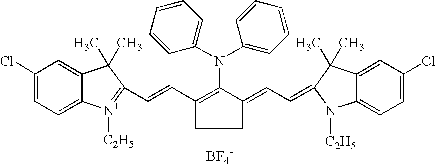

Binder Polymer (B-1): Weight Average Molecular Weight: 65,000

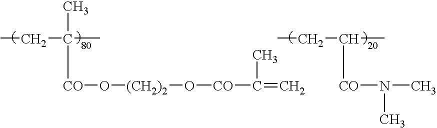

(Evaluation of Lithographic Printing Plate Precursor)

On the obtained lithographic printing plate precursor, a test pattern was image-exposed by an image setter (Trendsetter 3244VX, manufactured by Creo) at a beam intensity of 10.2 W and a drum rotation speed of 150 rpm. The contrast between unexposed region and exposed region, that is, clear viewing of image (visibility), was evaluated. The results are shown in Table 4. In Table 4, ΔL of 4.0 or more was shown as mostly good, 6.0 or more was as good, and 8.0 or more was as very good.

Without passing through development processing, this plate was loaded on a cylinder of a printing press (SPRINT S26, manufactured by Komori Corp.). Thereafter, printing was performed by supplying a commercially available fountain stock solution (IF-102, produced by Fuji Photo Film Co., Ltd.) and a 4 mass % diluting solution as the fountain solution, then supplying black ink (Values-G (black) produced by Dai-Nippon Ink & Chemicals, Inc.), and further supplying paper. The number of sheets required until a good printed matter could be obtained (on-press developability) and the number of sheets on which an image could be printed without causing staining or thinning (press life) were evaluated. The results are shown in Table 4.

### Example 28

Using a 0.3 mm-thick aluminum plate according to JIS-A-1050, the steps (a) to (f), (j) and (k) in Example 27 were performed in this order (in other words, in the same manner except for omitting the steps (g), (h) and (i)) to produce a support.

A lithographic printing plate precursor was produced and evaluated in the same manner as in Example 27 except for using the support prepared above. The results are shown in Table 4.

### Example 29

Using a 0.3 mm-thick aluminum plate according to JIS-A-1050, the steps (b) to (f), (j) and (k) in Example 27 were performed in this order (in other words, in the same manner except for omitting the steps (a), (g), (h) and (i)) to produce a support.

A lithographic printing plate precursor was produced and evaluated in the same manner as in Example 27 except for using the support prepared above. The results are shown in Table 4.

### Example 30

Using a 0.3 mm-thick aluminum plate according to JIS-A-1050, a support was produced through the same treatments except for performing the steps (b), (c) and (g) to (k) in Example 27 in this order (in other words, by omitting the steps (a), (d), (e) and (f)) and changing the total quantity of electricity in the step (g) to 450 C/dm².

A lithographic printing plate precursor was produced and evaluated in the same manner as in Example 27 except for using the support prepared above. The results are shown in Table 4.

### Example 31

Using a 0.3 mm-thick aluminum plate according to JIS-A-1050, a support was produced through the same treatments except for performing the steps (b), (c) and (g) to (i) in Example 27 in this order (in other words, by omitting the steps (a), (d), (e), (f) and (k)), changing the total quantity of electricity in the step (g) to 450 C/dm², and performing the following step (l) after the step (j).

(1) Undercoating Treatment

The undercoating solution shown below was coated on the aluminum support by using a wire bar to a coated amount of about 0.05 g/m² in terms of phosphorus and then dried at 100° C. for 1 minute.

Composition of Undercoating Solution:

| | | |
|---|---|---|
| Acid phosphoxy polyoxyethylene glycol | 2 | parts by mass |
| monomethacrylate (Phosmer, produced by | | |
| Uni-Chemical Co., Ltd.) | | |
| Methanol | 800 | parts by mass |
| Water | 50 | parts by mass |

A lithographic printing plate precursor was produced and evaluated in the same manner as in Example 27 except for using the support prepared above. The results are shown in Table 4.

TABLE 4

| Lithographic | | | |
|---|---|---|---|
| Printing Plate | | On-Press | |
| Precursor | Visibility | Developability | Press Life |
| Example 27 | good | 80 sheets | 7,000 sheets |
| Example 28 | good | 70 sheets | 7,000 sheets |
| Example 29 | good | 70 sheets | 6,000 sheets |
| Example 30 | good | 60 sheets | 9,000 sheets |
| Example 31 | good | 70 sheets | 7,000 sheets |

As seen from the results above, the lithographic printing plate precursor of the present invention has excellent visibility, on-press developability and press life.

### Example 32

On the photosensitive-thermosensitive layer formed in Example 30, Coating Solution (1) for water-soluble protective layer having the following composition was coated by a wire bar to give a dry coated amount of 0.5 g/m² and then dried at 125° C. for 75 seconds to produce a lithographic printing plate precursor. The produced lithographic printing plate precursor was evaluated in the same manner as in Example 27. The results are shown in Table 5.

Composition of Coating Solution (1) for Water-Soluble Protective Layer:

| | | |
|---|---|---|
| Polyvinyl alcohol (saponification degree: | 95 | parts by mass |
| 98 mol %, polymerization degree: 500) | | |
| Polyvinylpyrrolidone/vinyl acetate copolymer | 4 | parts by mass |
| (Luvitec VA 64W, produced by BASF) | | |
| Nonionic surfactant (EMALEX 710, produced | 1 | part by mass |
| by Nihon Emulsion Co., Ltd.) | | |
| Water | 3,000 | parts by mass |

### Example 33

A lithographic printing plate precursor was produced in the same manner as in Example 30 except for using Leuco Malachite Green (produced by Tokyo Kasei Kogyo Co., Ltd.) in place of Leuco Crystal Violet. The produced lithographic printing plate precursor was evaluated in the same manner as in Example 27. The results are shown in Table 5.

### Example 34

On the support produced in Example 30, Coating Solution for Photosensitive-Thermosensitive Layer (6) having the following Composition was coated by a wire bar and dried at 80° C. for 60 seconds to a coated amount of 0.8 g/m². The produced lithographic printing plate precursor was evaluated in the same manner as in Example 27. The results are shown in Table 5.

Composition of Coating Solution for Photosensitive-Thermosensitive Layer (6):

TABLE 5

| Composition of Coating Solution for | | |
|---|---|---|
| Photosensitive-Thermosensitive Layer (6): | | |
| Infrared Absorbent (D-2) shown below | 7 | parts by mass |
| Initiator (I-2) shown below | 15 | parts by mass |
| Isocyanuric acid EO-modified triacrylate (NK | 55 | parts by mass |
| Ester M-315, produced by Shin-Nakamura | | |
| Chemical Co., Ltd.) | | |
| Binder Polymer (B-2) shown below | 27 | parts by mass |
| Compound (R-1) capable of generating a color | 10 | parts by mass |
| change under the action of radical, shown below | | |
| Sodium dodecylbenzenesulfonate (Neopelex | 1 | part by mass |
| G-25, produced by Kao Corp.) | | |
| Methyl ethyl ketone | 900 | parts by mass |

| Lithographic Printing | | On-Press | |
|---|---|---|---|
| Plate Precursor | Visibility | Developability | Press Life |
| Example 32 | good | 80 sheets | 15,000 sheets |
| Example 33 | mostly good | 60 sheets | 7,000 sheets |
| Example 34 | good | 70 sheets | 6,000 sheets |

Infrared Absorbent (D-2):

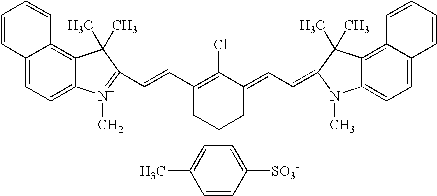

Initiator (I-2) (solubility in water: 40 or more):

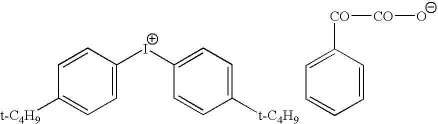

Binder Polymer (B-2):

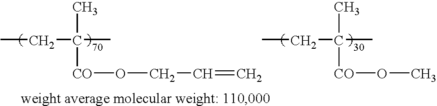

Compound (R-1) capable of generating a color change
under the action of radical:

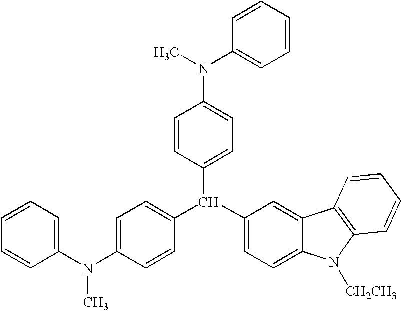

### Example 35

(Preparation of Microcapsule Liquid Dispersion (4))

In 16.5 parts by mass of ethyl acetate, 10 parts by mass of trimethylolpropane and xylene diisocyanate adduct (1:3 by mol) (Takenate D-110N, produced by Mitsui Takeda Chemicals, Inc., containing 25 mass % of ethyl acetate), 1.8 parts by mass of Leuco Malachite Green, 0.6 parts by mass of Infrared Absorbent (1) shown above, 2.2 parts by mass of radical initiator (Triazine Compound (1)), 1.5 parts by mass of tricresyl phosphate and 0.1 part by mass of anionic surfactant (Pionin A-41C, produced by Takemoto Yushi Co., Ltd.) were dissolved to obtain an oil phase. Separately, 37.5 mass by part of an aqueous 4 mass % polyvinyl alcohol (PVA-205, produced by Kuraray Co., Ltd.) solution was prepared and used as an aqueous phase. The oil phase and the aqueous phase were mixed and emulsified under water cooling in a homogenizer at 12,000 rpm for 10 minutes. Thereafter, 24.5 parts by mass of water was added to the resulting emulsified product and the mixture was stirred at room temperature for 30 minutes and further stirred at 40° C. for 3 hours. To this liquid dispersion, pure water was added to a solid content concentration of 15 mass % to prepare Microcapsule Liquid Dispersion (4). The average particle size of microcapsules was 0.30 μm.

(Formation of Photosensitive-Thermosensitive Layer)

On the support produced in Example 30, Coating Solution (7) for photosensitive-thermosensitive layer having the following Composition was coated by a wire bar and dried at 80° C. for 60 seconds to form a photosensitive-thermosensitive layer. The coated amount was 1.0 g/m².

Composition of Coating Solution (7) for Photosensitive-Thermosensitive Layer:

| | | |
|---|---|---|
| Infrared Absorbent (D-1) | 2 | parts by mass |
| Polymerization Initiator (1) | 10 | parts by mass |
| Dipentaerythritol hexaacrylate | 55 | parts by mass |
| (NK Ester A-DPH, produced by Shin- | | |
| Nakamura Chemical Co., Ltd.) | | |
| Binder Polymer (B-1) shown above | 37 | parts by mass |
| Fluorine-Containing Surfactant (I) | 1 | part by mass |
| Methyl ethyl ketone | 900 | parts by mass |

On the photosensitive-thermosensitive layer (7), Coating Solution (2) for water-soluble protective layer having the following composition was coated by a wire bar to give a dry coated amount of 1.5 g/m² and then dried at 100° C. for 90 seconds to produce a lithographic printing plate precursor. The produced lithographic printing plate precursor was evaluated in the same manner as in Example 27. The results are shown in Table 6.

Composition of Coating Solution (2) for Water-Soluble Protective Layer:

| | | |
|---|---|---|
| Polyvinyl alcohol (saponification degree: | 95 | parts by mass |
| 98 mol %, polymerization degree: 500) | | |
| Polyvinylpyrrolidone/vinyl acetate copolymer | 4 | parts by mass |
| (Luvitec VA 64W, produced by BASF) | | |
| Nonionic surfactant (EMALEX 710, produced by | 1 | part by mass |
| Nihon Emulsion Co., Ltd.) | | |
| Microcapsule Liquid Dispersion (4) | 1,000 | parts by mass |
| Water | 2,150 | parts by mass |

### Example 36

A lithographic printing plate precursor was produced in the same manner as in Example 35 except for using bis(4-dibutylaminophenyl)phenylmethane in place of Leuco Malachite Green. The produced lithographic printing plate precursor was evaluated in the same manner as in Example 27. The results are shown in Table 6.

### Example 37

A lithographic printing plate precursor was produced in the same manner as in Example 35 except for using tris(4-diethylamino-o-tolyl)methane in place of Leuco Malachite Green. The produced lithographic printing plate precursor was evaluated in the same manner as in Example 27. The results are shown in Table 6.

### Example 38

A lithographic printing plate precursor was produced in the same manner as in Example 35 except for using (I-3) shown below in place of Radical Initiator (I-2). The produced lithographic printing plate precursor was evaluated in the same manner as in Example 27. The results are shown in Table 6.

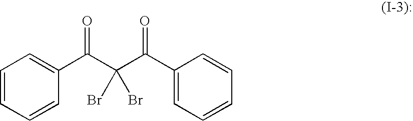

A lithographic printing plate precursor was produced in the same manner as in Example 35 except for using (I-4) shown below in place of Radical Initiator (I-2). The produced lithographic printing plate precursor was evaluated in the same manner as in Example 27. The results are shown in Table 6.

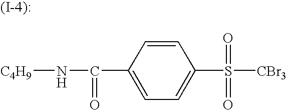

TABLE 6

| Lithographic | | | |
|---|---|---|---|
| Printing Plate | | On-Press | |
| Precursor | Visibility | Developability | Press Life |
| Example 35 | good | 50 sheets | 14,000 sheets |
| Example 36 | good | 40 sheets | 15,000 sheets |
| Example 37 | good | 50 sheets | 12,000 sheets |
| Example 38 | Very good | 50 sheets | 15,000 sheets |
| Example 39 | Very good | 40 sheets | 15,000 sheets |

### Example 40

(Formation of Photosensitive-Thermosensitive Layer)

On the support produced in Example 30, Coating Solution (8) for photosensitive-thermosensitive layer having the following Composition was coated by a wire bar and dried at 80° C. for 60 seconds to form a photosensitive-thermosensitive layer. The coated amount was 1.0 g/m². The produced lithographic printing plate precursor was evaluated in the same manner as in Example 27. The results are shown in Table 7.

Composition of Coating Solution (8) for Photosensitive-Thermosensitive Layer:

| | | |
|---|---|---|
| Polymerization Initiator (1) | 10 | parts by mass |
| Dipentaerythritol hexaacrylate | 40 | parts by mass |
| (NK Ester A-DPH, produced | | |
| by Shin-Nakamura Chemical Co., Ltd.) | | |
| Binder Polymer (B-1) shown above | 16 | parts by mass |
| Microcapsule Liquid Dispersion (4) | 300 | parts by mass |
| Fluorine-Containing Surfactant (I) | 1 | part by mass |
| Methyl ethyl ketone | 100 | parts by mass |
| 1-Methoxy-2-propanol | 850 | parts by mass |
| Water | 200 | parts by mass |

TABLE 7

| Lithographic | | | |
|---|---|---|---|
| Printing Plate | | On-Press | |
| Precursor | Visibility | Developability | Press Life |
| Example 40 | good | 30 sheets | 10,000 sheets |

### Example 41

On the support produced in Example 30, Coating Solution (9) for photosensitive-thermosensitive layer having the following Composition was coated by a wire bar and dried at 100° C. for 60 seconds to form a photosensitive-thermosensitive layer. The coated amount was 1.2 g/m2. The produced lithographic printing plate precursor was evaluated in the same manner as in Example 27. The results are shown in Table 8. Here, Coating Solution (9) for photosensitive-thermosensitive layer was obtained by mixing and stirring the following Photosensitive Solution (A) and Microcapsule Solution (B) immediately before coating.

Photosensitive Solution (A):

| Photosensitive Solution (A): | | |
|---|---|---|
| Binder Polymer (P) | 15 | parts by mass |
| Radical Generator (Q) | 15 | parts by mass |
| Infrared Absorbent (R) | 3 | parts by mass |
| Leuco Malachite Green (produced by Tokyo | 8 | parts by mass |
| Kasei Kogyo Co., Ltd.) | | |
| Polymerizable monomer (ARONIX M-215, | 35 | parts by mass |
| produced by Toagosei Co., Ltd.) | | |
| Fluorine-Containing Suifactant (1) | 40 | parts by mass |
| Methyl ethyl ketone | 99 | parts by mass |
| 1-Methoxy-2-propanol | 781 | parts by mass |
| Microcapsule Solution (B): | | |
| Microcapsule Liquid Dispersion (B′) synthesized | 240 | parts by mass |
| below | | |
| Water | 220 | parts by mass |

Binder Polymer (P):

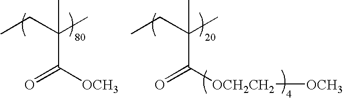

Radical Generator (Q):

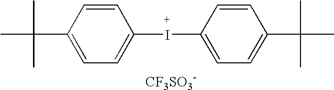

Infrared Absorbent (R):

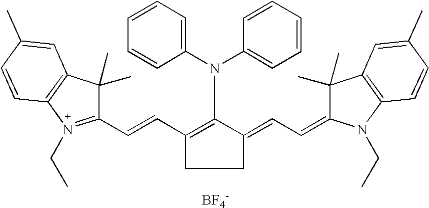

Synthesis of Microcapsule Liquid Dispersion (B′):

As the oil phase component, 10.0 g of trimethylolpropane and xylene diisocyanate adduct (Takenate D-110N, produced by Mitsui Takeda Chemicals, Inc., a 75 mass % ethyl acetate solution), 6.00 g of polymerizable monomer ARONIX M-215 (produced by Toagosei Co., Ltd.) and 0.12 g of Pionin A-41C (produced by Takemoto Yushi Co., Ltd.) were dissolved in 16.67 g of ethyl acetate. As the aqueous phase component, 37.5 g of an aqueous 4 mass % PVA-205 solution was prepared. The oil phase component and the aqueous phase component were mixed and emulsified in a homogenizer at 12,000 rpm for 10 minutes. The resulting emulsified product was added to 25 g of distilled water and the mixture was stirred at room temperature for 30 minutes and then stirred at 40° C. for 2 hours. The thus-obtained microcapsule solution was diluted with distilled water to a solid content concentration of 15 mass %, thereby obtaining Microcapsule Liquid Dispersion (B′). The average particle size was 0.23 μm.

TABLE 8

| Lithographic | | | |
|---|---|---|---|
| Printing Plate | | On-Press | |
| Precursor | Visibility | Developability | Press Life |
| Example 41 | ΔL ≧ 8 | 25 sheets | 12,000 sheets |

As seen from the results above, the lithographic printing plate precursor of the present invention has good visibility, on-press developability and press life.

This application is based on Japanese patent applications JP 2004-15723, filed on Jan. 23, 2004, JP 2004-15766, filed on Jan. 23, 2004 and JP 2004-86566, filed on Mar. 24, 2004, the entire content of which is hereby incorporated by reference, the same as if set forth at length.

1. A lithographic printing plate precursor comprising a support and a photosensitive-thermosensitive layer capable of recording an image by infrared laser exposure, the lithographic printing plate precursor being capable of performing a printing by loading on a printing press without passing through a development processing step after recording an image, or by recording an image after loading on a printing press, wherein said photosensitive-thermosensitive layer comprises (1) an infrared absorbent and (2) a discoloring agent or discoloration system capable of generating a color change upon exposure.

2. The lithographic printing plate precursor as claimed in claim 1, wherein (2) said discoloration system capable of generating a color change upon exposure comprises (3) a radical initiator and (4) a compound capable of generating a color change under the action of a radical.

3. The lithographic printing plate precursor as claimed in claim 1, wherein the lightness difference ΔL between exposed area and unexposed area after image-recording is 4.0 or more.

4. The lithographic printing plate precursor as claimed in claim 1, wherein said photosensitive-thermosensitive layer further comprises (5) a radical polymerizable compound and (6) a radical polymerization initiator.

5. The lithographic printing plate precursor as claimed in claim 1, wherein at least one component of the components contained in said photosensitive-thermosensitive layer is encapsulated in a microcapsule.

6. The lithographic printing plate precursor as claimed in claim 4, wherein (2) said discoloring agent or discoloration system capable of generating a color change upon exposure is encapsulated in a microcapsule and isolated from (5) said radical polymerizable compound.

7. A lithographic printing plate precursor comprising a support and a photosensitive-thermosensitive layer capable of recording an image by infrared laser exposure, the lithographic printing plate precursor being capable of performing a printing by loading on a printing press without passing through a development processing step after recording an image, or by recording an image after loading on a printing press, wherein a layer different from the photosensitive-thermosensitive layer comprises (1) an infrared absorbent, (3) a radical initiator and (4) a compound capable of generating a color change under the action of a radical.

8. The lithographic printing plate precursor as claimed in claim 2, wherein said radical initiator is a compound represented by the following formula (I): 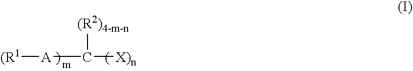
wherein X represents a halogen atom, A represents a divalent linking group selected from the group consisting of —CO—, —SO—, —SO₂—, —PO— and —PO₂—, R¹ and R² each independently represents a hydrogen atom or a monovalent hydrocarbon group having from 1 to 20 carbon atoms, and m and n each represents an integer of 1 to 3, provided that m+n is from 2 to 4.

9. The lithographic printing plate precursor as claimed in claim 7, wherein said radical initiator is a compound represented by the following formula (I): 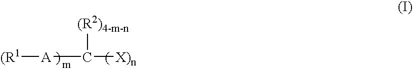
wherein X represents a halogen atom, A represents a divalent linking group selected from the group consisting of —CO—, —SO—, —SO₂—, —PO— and —PO₂—, R¹ and R² each independently represents a hydrogen atom or a monovalent hydrocarbon group having from 1 to 20 carbon atoms, and m and n each represents an integer of 1 to 3, provided that m+n is from 2 to 4.

10. The lithographic printing plate precursor as claimed in claim 1, wherein the surface of said support comprises a hydrophilic film having a thermal conductivity of 0.05 to 0.5 W/mK in the film thickness direction.

11. The lithographic printing plate precursor as claimed in claim 7, wherein the surface of said support comprises a hydrophilic film having a thermal conductivity of 0.05 to 0.5 W/mK in the film thickness direction.

12. The lithographic printing plate precursor as claimed in claim 1, wherein the surface of said support is hydrophilic and said photosensitive-thermosensitive layer is removable by a printing ink and/or a fountain solution.

13. The lithographic printing plate precursor as claimed in claim 7, wherein the surface of said support is hydrophilic and said photosensitive-thermosensitive layer is removable by a printing ink and/or a fountain solution.

14. A lithographic printing method comprising:
loading the lithographic printing plate precursor claimed in claim 1 on a printing press and then imagewise exposing the lithographic printing plate precursor with an infrared laser, or
imagewise exposing the lithographic printing plate precursor claimed in claim 1 with an infrared laser and then loading the lithographic printing plate precursor on a printing press;
supplying a printing ink and a fountain solution to said lithographic printing plate precursor; and
removing the infrared laser unexposed portion of the photosensitive-thermosensitive layer to perform a printing.

15. A lithographic printing method comprising:
loading the lithographic printing plate precursor claimed in claim 7 on a printing press and then imagewise exposing the lithographic printing plate precursor with an infrared laser, or
imagewise exposing the lithographic printing plate precursor claimed in claim 7 with an infrared laser and then loading the lithographic printing plate precursor on a printing press;
supplying a printing ink and a fountain solution to said lithographic printing plate precursor; and
removing the infrared laser unexposed portion of the photosensitive-thermosensitive layer to perform a printing.
